(19) United States
(12) Patent Application Publication
(10) Pub. No.: US 2025/0033672 A1
(43) Pub. Date: Jan. 30, 2025

(54) Systems and Methods for Intelligent Awareness and Intent for Autonomous Vehicles

(71) Applicants: Abhijit R. Nesarikar, Plano, TX (US); Ashlesha A. Nesarikar, Plano, TX (US); Anika A. Nesarikar, Plano, TX (US)

(72) Inventors: Abhijit R. Nesarikar, Plano, TX (US); Ashlesha A. Nesarikar, Plano, TX (US); Anika A. Nesarikar, Plano, TX (US)

(21) Appl. No.: 18/069,288

(22) Filed: Dec. 21, 2022

Related U.S. Application Data
(60) Provisional application No. 63/265,932, filed on Dec. 22, 2021.

(51) Int. Cl. B60W 60/00

(52) U.S. Cl. CPC B60W 60/0027; B60W 2554/4045; B60W 2554/4046

(57) ABSTRACT

Systems and methods for generating artificial intelligence (AI) to enable autonomous proactiveness are described. In an embodiment, autonomous proactiveness enables autonomous AI entities, comprising autonomous vehicles, and enables AI entities' autonomies in real-world ecosystems; AI entities comprising higher-order intelligences monitor, detect, and mitigate unknowns of a real-world scenario. In an embodiment, an autonomously proactive AI is a structure comprising intelligence constituents comprising awareness, intent, agency, perception, lower-order intelligence, and higher-order intelligence, wherein inception of the AI into a real-world ecosystem enables simultaneities, facilitates novelty processing, generates insights to mitigate intractabilities, maintains citizenship and homeostasis, overcomes complexities, detects emergences, and produces higher-order intelligences of a basis comprising at least one of: attention, general intelligence, autonomy, and combination thereof. In an embodiment, executions of category theoretic instructions generate higher-order intelligence and facilitate abstraction of information structures. Systems and methods for awareness as an equivalence to morphisms are described.

### CROSS-REFERENCE TO RELATED APPLICATION

The present application claims the benefit of U.S. Provisional Patent Application No. 63/265,932 entitled “Intelligent Awareness and Intent for Autonomous Vehicles” filed Dec. 22, 2021, the contents of which are incorporated herein by reference in its entirety.

### TECHNICAL FIELD

The present disclosure relates generally to adaptive artificial intelligence (AI), autonomous proactiveness of AI, category theoretic AI, general intelligence, and intelligence constituents comprising awareness, intent, lower-order intelligence, higher-order intelligence, and attention, and more particularly, systems and methods for an autonomously proactive artificial intelligence to enable an autonomous entity, comprising an autonomous vehicle, and the entity's operation, learning, and autonomy in an ecosystem.

### BACKGROUND

A human (a human entity) may benefit from at least one higher-order intelligence of a basis comprising at least one of: intent, awareness in general, creativity, intuition, empathy, social awareness, common sense, general knowledge, attention, inter-entity skills (e.g., interpersonal skills, etc.), and combination thereof to, in general, operate productively (e.g., effectively, efficaciously, etc.)—a first operation—in an ecosystem. The human may require an intent (e.g., to attain a goal) comprising an awareness comprising at least one of: model (e.g., surroundings, scenarios, etc.) awareness, abstraction awareness, intelligence awareness, ecosystem awareness, and combination thereof for an effective and efficacious application of the at least one higher-order intelligence and the first operation in the ecosystem in general. The awareness enhances the human's ability to cope with a real-world challenge comprising at least one of: constant and dynamic change; constantly and dynamically changing scenarios; encountering novel observations; uncertainty of a basis comprising at least one of: pace of change, constraints of perception, constraints of actions (e.g., execution of agency), extent of novelty, unexpectedness, and combination thereof, randomness of a type comprising at least one of: inherent, true, pseudo, and combination thereof (referred to generally as “randomness uncertainty”); uncertainty of knowledge of a basis comprising at least one of skill, information, ability, and combination thereof (referred to generally as “knowledge uncertainty”); open systems (e.g., with interactions and exchanges extending outside the systems) in general, and combination thereof. The intent, the awareness, and the at least one higher-order intelligence generally may cause the first operation of the human in the ecosystem to be productive in general and the human's membership in the ecosystem to be constructive in general. In certain embodiments, for a second ecosystem, a second entity's productive second operation and a constructive second membership may be referred to as “citizenship” (of the second entity in the second ecosystem), and the second entity may be referred to as a “citizen” (of the second ecosystem), wherein the second operation and the second membership may contribute to a homeostasis of the second ecosystem.

In certain embodiments, an intelligence feature of a basis comprising at least one of: intent, awareness, higher-order intelligence, higher-order constituents of intelligence in general, and combination thereof may be referred to as a general intelligence. The formulation of the general intelligence may be of a basis comprising at least one of: artificial (e.g., AI), apriori constructed (e.g., architected, engineered, deployed, and operated by at least one administrator), emergent (e.g., as a result of independent and autonomous operation in diverse scenarios of diverse ecosystems), evolutionary (based on principles of, e.g., evolution in general, natural evolution, emergence from evolutionary dynamics, etc.), and combination thereof. A general intelligence of the second entity may contribute to the second entity's citizenship and maintaining homeostasis in the second ecosystem.

In certain embodiments, for an autonomous artificial intelligence system to competently operate in the ecosystem with a capability of a basis comprising at least one of: at par with the human, at par with at least one second human, in concert with the human, in concert with at least one third human, as a substitute for the human, as a substitute for at least one fourth human, and combination thereof, the autonomous AI system may need a first intelligence of a basis comprising at least one of: intent, awareness, autonomous proactiveness, general intelligence in general, higher-order intelligence in general, and combination thereof. In certain embodiments, higher-order intelligence comprises intent in general (e.g., to pursue a goal, etc.), awareness in general, general knowledge (as an aspect of, e.g., global awareness in general, higher-order awareness in general, a cumulative plurality of awareness in general, etc.), inter-entity skills (e.g., communication skills, inter-entity interaction, etc.), higher-order constituents of intelligence in general (e.g., higher-order awareness, etc.), and combination thereof.

In an embodiment, an autonomous vehicle (AV) is an example of the autonomous AI system. For the AV to productively operate in the ecosystem at par with a vehicle operated by the human, the AV—apart from offline learned capability—may need human-level ability of a basis comprising at least one of: higher-order intelligence, general intelligence, ecosystem citizenship, and combination thereof. The ecosystem citizenship for the AV may require the AV to facilitate homeostasis of the ecosystem despite a challenge comprising at least one of: a real-world nature of the ecosystem, need for online learning (e.g., learning concurrent with operation), knowledge uncertainty, randomness uncertainty in general, and combination thereof, wherein the ecosystem citizenship is characterized by amenability in general of the AV in the ecosystem. Furthermore, for an AV in the real world, interactions with other autonomous entities are inevitable. The AV, implicitly or explicitly, would be part of at least one team. For example, an AV for hire that picks up a rider would form a team with the rider, at least for the duration of the ride.

In human factors art, awareness is generally explicitly recognized as a construct separate from decision making and performance (of, e.g., agency). Human factors awareness (e.g., human awareness) is generally different from human-factors intelligence (e.g., human intelligence). Similarly, machine awareness is generally different from artificial intelligence. In human factors art, in general, for a human, awareness requires a focus that goes beyond traditional information processing approaches and enables the human's ability comprising autonomous proactiveness in complex environments. For both a human and an AI (e.g., higher-order intelligence, general intelligence, etc.) alike, generally, at least one awareness is a necessary prerequisite for autonomous proactiveness, and autonomous proactiveness is essential for operation in a complex dynamic environment. Autonomous proactiveness may enable an entity to overcome real-world uncertainties (e.g., related to scenarios) in an ecosystem, wherein uncertainties are of a basis comprising at least one of: knowledge uncertainty, randomness uncertainty, interaction uncertainty (comprising, e.g., perception uncertainty, agency uncertainty, etc.), social uncertainty (e.g., comprising other entities': choices including game theoretic choices, instinctive choices, emotional choices, etc.; habits; preferences; idiosyncrasies; behaviors in general comprising crowd behaviors, social behaviors, etc.; etc.), and combination thereof.

In general, machine awareness of an AI entity as a counterpart to human factors awareness:
a. is essential for operations of the AI entity in complex systems;
b. goes beyond traditional information processing (e.g., analytics alone, feature detection alone, etc.);
c. typically requires the AI entity to operate with greater complexity and capability (e.g., extent of compute, non-volatile media, temporal continuity, high dimensionality, working memory, etc.); and
d. may allow the AI entity operating with greater complexity and capability to constructively interact with humans' awareness, e.g., in human-AI teams.

Team awareness may be regarded as the degree to which every team member possesses the awareness required for the team member's responsibilities. The success or failure of a team may depend on the success or failure of each of its team members. If any one of the team members has poor awareness, it may lead to a critical error in performance that may undermine the success of the entire team. A long-standing need for AI to operate in human teams at a level commensurate with a human (e.g., to replace a human, work in concert with humans, etc.) is identified in the art and is noted in technology and engineering standards, e.g., IEEE Std 1872.2-2021 and SAE J3216 July 2021, among others.

In an embodiment, synergistic success of a human team depends on autonomous proactiveness of the individual team members. The autonomous proactiveness of the individual team members requires awareness of the individual team members, and if any one of the team members has poor awareness, it may lead to critical errors (manifested as, e.g., contraindicated agencies, lack of proactiveness, actions that are out of sync with the team, etc.) that undermine the entire team. For an autonomous AI to replace (e.g., take place, substitute, etc.) a first team member—a human—the AI needs to contribute commensurate (e.g., at least at par with the first team member) awareness and autonomous proactiveness to the team. A constructive operation in an ecosystem of the AI that successfully replaces the first team member may be regarded as citizenship of the AI in the ecosystem.

### SUMMARY

For an entity in an ecosystem, an exercise of autonomous proactiveness may be regarded as an exhibition of intelligence and intelligence constituents of a basis comprising awareness, intent, agency, execution of agency, higher-order intelligence, learning, simultaneity of learning and operation, autonomy, attention, and combination thereof. The intelligence constituents may be structured in general in a system or a method to enable autonomous proactiveness of an artificial intelligence (AI) entity. In an embodiment, for an AI entity in an ecosystem, autonomous proactiveness and intelligence in general are constructed and operated with a category theoretic metric. A system comprises configurations of a basis comprising at least one equivalence of at least one awareness to at least one category theoretic morphism. Methods comprise executing at least one equivalence of at least one higher-order awareness to at least one category theoretic higher-order morphism; executing at least one equivalence of at least one higher-order intelligence to at least one higher-order category; and executing at least one equivalence of at least one abstraction of at least one information structure to at least one category theoretic abstraction.

In an embodiment, for an unknown unknown occurring at a time instance, at least one awareness of the occurrence is only gained at and after the time instance. Autonomous proactiveness based on the at least one awareness may mitigate a loss or enhance a gain caused by the occurrence. A method comprises monitoring a domain, detecting novelties, and learning novelties, wherein the novelties are of types comprising at least one of: known unknown, unknown unknown, and combination thereof. In an embodiment, an attention of an entity comprises at least one equilibrium of a plurality of intelligence constituents, and the at least one equilibrium may represent a homeostasis of at least one ecosystem.

In an embodiment, a system comprises processing a real-world observation by a higher-order intelligence, postulating an agency, and executing the postulated agency to operate in an operational domain. In an embodiment, a method is described to verify an intractability and gain an insight to mitigate and rectify the intractability. The method comprises receiving and processing at least one first observation, generating a first intelligence based on the at least one first observation, verifying an intractability based on the first intelligence, receiving and processing at least one second observation, generating a second intelligence based on the at least one second observation, and gaining, based on the first intelligence and the second intelligence, an insight. The method further comprises exercising the insight to mitigate or rectify the intractability.

In an embodiment, a method comprises at least one simultaneity of operation and learning. The method comprises processing a first observation to postulate a first agency and a second expected observation; executing the postulated first agency; receiving, based on the executed first agency, a second observation; comparing the postulated second expected observation with the second observation; and updating, based on the comparison, at least one intelligence. In an embodiment, a method comprises exercising at least one intrinsic intelligence of one entity, wherein the one intrinsic intelligence is of a basis comprising autonomous proactiveness. The method further comprises gaining, based on the exercised one intrinsic intelligence, an improvement of a basis comprising at least one of: homeostasis, at least one first citizenship, and combination thereof.

In an embodiment, exercising an autonomy overcomes a complexity in an operational domain subject to real-world challenges. In an embodiment, exercising an autonomy allows detection of at least one emergence in an operational domain subject to real-world challenges. In an embodiment, a system comprises a general intelligence of basis comprising intrinsic. The general intelligence exercises an autonomy in an operational domain subject to real-world challenges. In an embodiment, at least one emergence is detected regarding the general intelligence in at least one abstraction.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an autonomous vehicle encountering a novelty in accordance with an embodiment related to the present application;

FIG. 2 illustrates a block diagram of an autonomous vehicle encountering an impasse in accordance with an embodiment related to the present application;

FIG. 3 illustrates a block diagram of a plurality of autonomous vehicles encountering an impasse in accordance with an embodiment related to the present application;

FIG. 4 illustrates a block diagram of an intelligence processing method for general intelligence in accordance with an embodiment related to the present application;

FIG. 5 illustrates a block diagram of awareness and a thinning of information in accordance with an embodiment related to the present application;

FIG. 6 illustrates a block diagram of an autonomous vehicle overcoming conflicting goals in accordance with an embodiment related to the present application;

FIG. 7 illustrates a flow diagram of a method in accordance with an embodiment of the present application;

FIG. 8 illustrates a flow diagram of a method in accordance with an embodiment of the present application;

FIG. 9 illustrates a flow diagram of a method in accordance with an embodiment of the present application;

FIG. 10 illustrates a block diagram of novelty learning by a higher-order intelligence in accordance with an embodiment related to the present application;

FIG. 11A and FIG. 11B together illustrate a block diagram of in situ real-time continuous operation of general intelligence in accordance with an embodiment related to the present application;

FIG. 12 illustrates a flow diagram of a method in accordance with an embodiment of the present application;

FIG. 13 illustrates a flow diagram of a method in accordance with an embodiment of the present application;

FIG. 14 illustrates a flow diagram of a method in accordance with an embodiment of the present application;

FIG. 15 illustrates a flow diagram of a method in accordance with an embodiment of the present application;

FIG. 16 illustrates a flow diagram of a method in accordance with an embodiment of the present application;

FIG. 17 illustrates a flow diagram of a method in accordance with an embodiment of the present application;

FIG. 18 illustrates a flow diagram of a method in accordance with an embodiment of the present application;

FIG. 19 illustrates a flow diagram of a method in accordance with an embodiment of the present application;

FIG. 20 illustrates a flow diagram of a method in accordance with an embodiment of the present application;

FIG. 21 illustrates a flow diagram of a method in accordance with an embodiment of the present application;

FIG. 22 illustrates a flow diagram of a method in accordance with an embodiment of the present application;

FIG. 23 illustrates a flow diagram of a method in accordance with an embodiment of the present application; and

FIG. 24 illustrates a flow diagram of a method in accordance with an embodiment of the present application.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are exemplary by way of illustration only, and not by way of limitation. Various substitutions, modifications, additions, and/or rearrangements within the spirit and/or scope of the underlying inventive concept will become apparent to those skilled in the art from this disclosure.

### Ecosystems

In general, an ecosystem may be a real-life system of real-time significance with a feature of a basis comprising at least one of: dynamics (e.g., changing with time, unpredictably changing, randomly changing, etc.), uncertainty (e.g., unbounded, real-world, subject to novelties, unpredictable in general, intractably random, etc.), complexity (with respect to, e.g., interactions, autonomies, processes, the past, the present, the future, trajectory in general, inception, retirement, homeostasis, equilibria, etc.), openness (e.g., as in open systems, wherein interactions and exchanges extend outside the systems), diversity (with respect to, e.g., constituent entities, constituent populations in general, intelligence levels of constituent entities, scenarios, events, outcomes in general, etc.), regeneration cycles (e.g., depletion and replenishment, destruction and creation, etc.), constituents (e.g., entities, artifacts, processes, dependencies, parts, features, and combination thereof), virtual (e.g., cyber, philosophical, meta spaces, etc.), and combination thereof. A synergistic stable state of the ecosystem may be a plurality of interdependent endurance abilities of a basis comprising at least one of: a plurality of generally stable equilibria, a plurality of generally stable regeneration cycles, a plurality of generally stable extents (e.g., population, numbers, proportions, etc.) of constituents, a plurality of generally consistent norms (e.g., rules, bylaws, etiquettes, conventions, belief systems, etc.), a plurality of generally consistent behaviors (e.g., habits, social nature, overall outlook, natures of the ecosystem's entities in general, etc.), and combination thereof, wherein, as a synergy, the plurality of interdependent endurance abilities may reciprocally sustain each other (e.g., directly, indirectly, collectively, with many-to-many interactions in general, etc.). The synergistic stable state of the ecosystem is generally referred to as a “homeostasis” of the ecosystem. At least one disturbance to at least one member of the plurality of interdependent endurance abilities—a first homeostasis—may propagate into a system comprising at least one of:
a. at least one second homeostasis corresponding to at least one second ecosystem (e.g., the ecosystem may transform into the at least one second ecosystem);
b. at least one instability that may destroy at least one part of the ecosystem, transforming the ecosystem into at least one third ecosystem with a reduced viability for a constituent (of a basis comprising at least one of: an entity, an artifact, a process, a dependency, a part, a feature, and combination thereof) of the ecosystem;
c. a cascading failure that may destroy the ecosystem, leaving at least one remnant with no significance for a constituent (of a basis comprising at least one of: an entity, an artifact, a feature, and combination thereof) of the ecosystem; and
d. combination thereof

The at least one disturbance may correlate with at least one scenario of a basis comprising at least one of: a sudden natural phenomenon (an abrupt incident related to, e.g., geology, cosmology, oceanology, etc.), a steadily changing natural phenomena (steady, e.g., depletion of a resource; change in population; organic evolution of knowledge; organic evolution of opinion and information; increase in disorder in general; etc.), an unnatural (e.g., man-made, extra-evolutionary, etc.) introduction of a first system (e.g., higher intelligence with capabilities superior to that of an existing intelligence in the ecosystem, a system to control and alter an organic evolution of knowledge, a system to control and alter an organic evolution of opinion and thought, etc.) to influence higher-order intelligence, and combination thereof. The sudden natural phenomenon and the steadily changing natural phenomena are generally referred to as natural progressions of the ecosystem. The introduction of the first system in the ecosystem may be regarded as an artificial intervention. In an embodiment, an introduction of a new entity of a basis comprising at least one of: a new entity type, a new and distinct type of intelligence, and combination thereof may change a third homeostasis of the ecosystem. At least one deviation from the third homeostasis and at least one adversity due to the change of the third homeostasis may be contained by citizenship (e.g., comprising amenability and inclination to maintain homeostasis) in general of the new entity.

In an embodiment, a first AI (as an entity), at the entity's inception into an ecosystem, may encounter a scenario for the first time and may lack an awareness of potential novelties and awareness in general. For example, the entity may lack awareness of the scenario, the ecosystem, transitions, operations (e.g., activity and autonomous operations, etc.) in the scenario in general, etc. Prior to the inception, the first AI may be constructed (e.g., trained, built, tested, etc.) offline (e.g., outside the ecosystem and the scenario, using historical data, using estimated training samples, at a time prior to that of the inception, etc.) by at least one administrator for an operation in the ecosystem. The at least one administrator may lack an awareness of at least one unknown comprising at least one of: at least one known unknown, at least one unknown unknown, and combination thereof that may be encountered by the first AI after the inception. The at least one unknown, the at least one known unknown, and the at least one unknown unknown may be of a basis comprising at least one of: observation, confounder, variable in general, interaction, correlation, emergence, complexity (related to, e.g., complex adaptive systems), dissipation, inception, conclusion, and combination thereof.

In certain embodiments, a known unknown may be, for example, a variable with a potentially known (e.g., as a convention, precedence, etc.) range, a model with one or more predictable mechanisms under given circumstances, a theory that is valid over a given range of a variable, a process that is expected to be random, etc. In certain embodiments, an unknown unknown may be an occurrence of, for example, a tail-end novelty for a scenario, a novel outlier for an otherwise well characterized scenario, a novelty that breaks down a well-established causal relationship, a novelty of unlikely correlation of two or more otherwise known events, a novelty in general, an unexpected and generally extensive domain shift (e.g., due to change in vantage point, change in abstraction, change in level of detail, etc.), etc. If left unchecked, an adverse significant impact of the at least one unknown on the operation of the first AI may cause a loss of a basis comprising at least one of: to the operation, to the first AI, to a viability, to a performance, to one or more part of the ecosystem, to a homeostasis of the ecosystem, to the ecosystem in general, irreversible, long-term, catastrophic, with cascading failures, and combination thereof.

In an embodiment, the at least one administrator may anticipate (e.g., parameterize, scope, estimate boundary conditions, generate what-if analysis, etc.) the at least one known unknown and may incorporate at least one first fail-safe (of a basis comprising at least one of: margin of safety, guard-rail regarding boundary conditions, preventive measure, and combination thereof) against the at least one known unknown into the construction of the first AI. The at least one administrator may not anticipate the at least one unknown unknown and may not incorporate at least one second fail-safe (of a basis comprising at least one of: margin of safety, guard-rail regarding boundary conditions, preventive measure, and combination thereof) against the at least one unknown unknown into the construction of the first AI.

In an embodiment, a second AI (as an entity in an ecosystem) may encounter a scenario. In general, for an unknown unknown occurring at a time instance, an awareness of the occurrence is only gained (by, e.g., the entity, an administrator, etc.) at and after the time instance. The lack of awareness of the occurrence before the time instance prevents at least one countermeasure (of a basis comprising at least one of: monitoring, identifying, diagnosing, mitigating loss, rectifying loss, correcting fault, invoking fail-safes, and combination thereof) against at least one loss caused by the occurrence. If the occurrence causes an adverse significant impact resulting in the at least one loss, due to lack of the at least one countermeasure from the lack of awareness, the at least one loss may not be prevented. If the lack of awareness (and the lack of the at least one countermeasure) continues after the time instance, and if the second AI is not amenable and continues to operate in the ecosystem regardless of continuation of the at least one loss, the at least one loss may propagate into at least one second loss of a basis comprising at least one of: catastrophic loss, cascading failure, irreversible loss, loss to one or more part of the ecosystem, adversity to a homeostasis of the ecosystem, loss to the ecosystem in general, long-term loss, and combination thereof. In an embodiment, autonomous proactiveness based on the awareness is the only way to mitigate a loss or enhance a gain caused by the occurrence.

For an entity in an ecosystem, in general, at least one awareness (and a resulting autonomous proactiveness, and, to an extent, at least one intent) may be ecosystem specific and generated simultaneously with autonomous operation of the entity in the ecosystem, wherein the at least one awareness (and the at least one intent) may characterize a scenario of the ecosystem—in real time—into tractable events (e.g., generally suitable for intelligence generation). An AI system without awareness—a narrow AI—may not reach a degree of sophistication and generality associated with general intelligence.

In an embodiment, a narrow AI is trained generally in isolation and offline, and its intelligence level is limited to a first lower-order intelligence (lacking, e.g., awareness, intent, higher-order intelligence, and higher-order constituents of intelligence in general). For the narrow AI in an ecosystem, ecosystem-level autonomy is limited due to the first lower-order intelligence's limitation of a basis comprising at least one of: narrowness (due to limitations of, e.g., scope, transferability, repurposing in general, etc.), brittleness and insensitivity in general (poor sensitivity to change of, e.g., domain and subject matter, environment, culture, etc.), lack of adaptability (lack of, e.g., autonomous proactiveness, self-healing, ability to realign goals and sub-goals, tamper resistance, amenability in general, etc.), inability to deal with at least one intractability of a scenario of the ecosystem, and combination thereof. The training of the narrow AI is carried out by an administrator (generally in isolation and offline) by sampling—as seen fit by the administrator—prior scenarios of the ecosystem into assumed tractable events. The administrator may assume a bounded sample space for the tractable events to represent the ecosystem. However, the ecosystem in its general form (e.g., in the real world) is of a basis comprising at least one of: uncertainty, unknowns, change, granularity, lack of observability, the ecosystem's past, the ecosystem's future, rare events (e.g., tail-end events), unpredictability, and combination thereof. Due to assumptions of the administrator, a real-time operation of the narrow AI in the ecosystem may lead to at least one loss (to, e.g., the narrow AI, the administrator, a beneficiary in general, the ecosystem, etc.) in the ecosystem. At the conception and design of the narrow AI, the administrator may regard a possibility of the at least one loss as unavoidable (e.g., as a cost of doing business, as a known consequence of the assumptions, as something for the ecosystem to cope with as and when it happens, etc.). The assumptions by the administrator, limitations of the narrow AI in general, and the unavoidability of the at least one loss may pose a threat of a basis comprising at least one of: to the ecosystem, to the ecosystem's homeostasis, to the ecosystem's constituents (e.g., other entities, systems, artifacts, etc. in the ecosystem), and combination thereof. Therefore, the narrow AI is not regarded as, nor suitable to become, a citizen of the ecosystem (e.g., by other entities, beneficiaries in general, etc.). The narrow AI lacks autonomous proactiveness and its dependent amenability (the need for amenability, e.g., was not anticipated by the administer due to the assumptions by the administrator) as a prerequisite for citizenship of the ecosystem.

### Events and Scenarios

In certain embodiments, a difference between a scenario and an event is that an event may generally be ascribed to be tractable with predictability of a basis comprising observability; chronology (for an occurrence, e.g., the past, the present, the future, etc.); ability to be modelled, computed, and persisted in general; and combination thereof. A model of an ecosystem's event is generally an assumed and derived apriori construct of a basis comprising at least one of: axiomatic structure (e.g., an algebra, a logic type, a rule set, laws in general, etc.), conventional structure (e.g., based on precedence, history, maturity of language and communication, etc.), a generally conformed (e.g., bounded) system of information, and combination thereof. Limiting the model of the ecosystem's event to a context of the ecosystem's event may further limit the model in scope and variability. For practical purposes (e.g., with assumptions), a scenario may be regarded (e.g., modelled, represented, etc.) as a collection of events. However, a scenario of the ecosystem generally represents the ecosystem's real-world aspect of a basis comprising: incomplete chronological predictability (e.g., past, present, future, etc.); incomplete observability; inadequate frameworks (e.g., axiomatic, conventional, rules based, etc.) to describe (capture in, e.g., a model, information, etc.) the real-world aspect in its entirety; uncertainty in general; inability to model all features; inability to abstract, openness in general (e.g., systems' interactions and exchanges extend outside the systems) and combination thereof.

In certain embodiments, for a scenario of an ecosystem, though an apriori construct (as conceived by an administrator), at least one first event of the scenario may not be identical to at least one second event of the scenario in the future. For example, there may be similarities, but, at a minimum, a plurality of aspects related to time (e.g., timestamp) may differentiate the at least one second event from the at least one first event. In general, for practicality (e.g., fitness for purpose, design consideration, etc.), subject to the administrator's ability of a basis comprising at least one of: knowledge, preference, expertise, motives, experiences, and combination thereof, at least one third anticipated event is assumed identical to and categorized as the at least one first event (based on, e.g., observations, evaluations, derivations, etc.). In an embodiment, the administrator generally assumes an equivalence between the scenario and the at least one third anticipated event (e.g., with the at least one first event as a basis) for practical purposes of a basis comprising at least one of: fitness for purpose, convenience, expediency, and combination thereof. For the ecosystem, uncertainly associated with the scenario may render the administrator's assumption wrong.

In an embodiment, an administrator assumes a scenario of an ecosystem to be modeled (e.g., designed, defined, etc.) by at least one event and historic information of the at least one event. The model of the at least one event is used to create labels to train a narrow AI as an instance of lower-order intelligence. The administrator's assumption to model the scenario as the at least one event represents a fundamental limit to improving the lower-order intelligence of the narrow AI to achieve a higher-order intelligence. At least one dynamic of the scenario changes the scope of the scenario in the ecosystem, thereby rendering the assumed model (based on the at least one event) incapable of consistently representing the scenario. The scope change may be of a basis comprising at least one of: time (e.g., past, present, future, etc.), space, dimension, granularity, abstraction level, uncertainty (e.g., possibility of tail-end events and uncertainly in general), and combination thereof. In an embodiment, an entity (with a general intelligence) observing the scenario in the ecosystem is aware of the at least one dynamic of the scenario. The awareness of the entity allows for the entity to simultaneously gain autonomy, learn, and adapt the general intelligence to the at least one dynamic of the scenario. The learning and adaptation of the general intelligence enables continued autonomy and operation of the entity with respect to the scenario.

Narrow AI, General AI, and Entities with General Intelligence

In an embodiment, at least one event—correlated to a scenario of an ecosystem—is modelled (referred to as an event model) by an administrator (who assumes an equivalency between the scenario and the at least one event) from a first distribution that is typically constructed from historical observations of the scenario. The first distribution is sampled to train a narrow AI to predict a feature set comprising a first feature in the present, and at least one second feature in the future. The narrow AI is introduced into the scenario to predict at least one feature of the feature set on demand. The narrow AI acquires a first observation, a second observation, and a third observation from the scenario (assumed by the administrator to be correlated to the event model) and predicts the at least one feature as if the scenario is bounded by the event model (due to the assumption of the administrator). The feature set correlates to a mathematical optimization and a best-fit match regarding the first distribution.

The first observation is bounded by the event model and conforms to the best-fit match regarding the first distribution (e.g., a prediction represents an interpolation of the first distribution), and a prediction of the feature set for the first observation is acceptable.

The second observation from the scenario is not bounded by the event model and not contained within the first distribution (e.g., a prediction from the second observation represents an extrapolation of the first distribution), wherein the narrow AI generates an unacceptably large error in a prediction of the feature set—a second failure—leading to operational losses for the narrow AI in the ecosystem. The possibility of the second failure was anticipated by the administrator of the narrow AI; during the training of the narrow AI, the administrator incorporated a margin of safety for the narrow AI as a second fail-safe based on at least one prior knowledge. The narrow AI detects the unacceptably large error and the second failure and activates the second fail-safe. The activation of the second fail-safe limits resulting losses to the narrow AI, avoids at least one catastrophic loss, and prevents cascading ecosystem-wide failures.

The third observation from the scenario is a first instance of an outlier—characterized by at least one novelty for the narrow AI—of the first distribution and contraindicates application of the event model. For the third observation, a prediction of the feature set fails silently (e.g., the failure goes unnoticed in the ecosystem)—a third failure. The administrator was not aware of the possibility of the outlier and could not have provisioned for a third fail-safe (e.g., graceful recovery, etc.) to contain the third failure to limit a third resulting loss of a basis comprising at least one of: loss to the narrow AI, catastrophic loss, cascade of ecosystem-wide failures, and combination thereof.

Despite the third failure and the third resulting loss, the narrow AI continues to operate, executing a third autonomy, in the ecosystem due to lack of the third fail-safe in its construction. The narrow AI lacks a third awareness of a basis comprising the third failure, the silent nature of the third failure, the at least one novelty of the third observation (e.g., the outlier nature of the third observation), the outlier, the third resulting loss, a plurality of novelties of the scenario in general, a plurality of novelties of the ecosystem in general, a plurality of effects and losses for the ecosystem due to the execution of the third autonomy, and combination thereof. In an embodiment, the lack of the third awareness results in lack of autonomous proactiveness and amenability in general of the narrow AI.

In an embodiment, a second AI—as a second entity with a general intelligence (comprising, e.g., autonomous proactiveness)—with at least one awareness and a higher-order intelligence is designed for the same operational purpose (as that of the narrow AI) for the scenario in the ecosystem. The third observation is acquired by the second AI through a sensory layer and a perception layer, and transformed into a lower-order intelligence. The perception layer identifies the at least one novelty of the third observation and tags it with a heightened third awareness (e.g., with high urgency level and low confidence level). The lower-order intelligence encounters the at least one novelty and the third failure silently. The higher-order intelligence receives the at least one novelty (as the third observation tagged with the heightened third awareness) and identifies the third failure. Due to the heightened third awareness, the higher-order intelligence pauses (as an example of autonomous proactiveness and amenability in general) an execution of the third autonomy that would have otherwise been carried out by the lower-order intelligence. The higher-order intelligence also slates the third observation, the third failure (and its related predictions), and the heightened third awareness for further investigation. Thereafter, the higher-order intelligence contains (compensates by, e.g., slowing down, seeking help, avoiding, verifying, etc.) the third autonomy of the second AI, subject to the conclusion or learning of the third observation. The learning of the third observation is of a basis comprising at least one of: the third observation, the heightened third awareness, anticipated effects and losses of the third autonomy (e.g., on the second AI, on the ecosystem, etc.), the third failure, and combination thereof. Pausing the execution of the third autonomy is an interception by the higher-order intelligence and an aspect of supervision and overseeing in general that limits resulting losses (e.g., to the second AI), avoids at least one catastrophic loss, and prevents cascading ecosystem-wide failures. In an embodiment, the heightened third awareness enables amenability and autonomous proactiveness (e.g., pausing the third autonomy) of the second AI.

Thereafter, in an embodiment, the general intelligence of the second AI improves. For the second AI, the conclusion and learning of the third observation causes at least one improvement of a basis comprising at least one of:
a. higher-order intelligence;
b. sensitivity of a feature comprising at least one of: intelligence processing layers (of a basis comprising at least one of sensory, perception, lower-order intelligence, higher-order intelligence, and combination thereof), inter-layer (e.g., among intelligence processing layers) interaction, abstraction in general, and combination thereof,
c. knowledge and information content (e.g., of the second AI);
d. fine tuning of at least one goal (of, e.g., the second AI, peers of the second AI, etc.);
e. identification of the third observation as the first instance of the outlier (of the first distribution);
f. a first intent to explore, define, learn, and adapt to the outlier to improve the first distribution (e.g., resulting in a second distribution); and
g. combination thereof.

In an embodiment, the first intent results in the second AI's fourth autonomous activity of a basis comprising at least one of: a fourth goal (e.g., setting sub-goals, altering existing goals, etc.), a fourth intent (e.g., revaluating an intent, etc.), a fourth agency, execution of the fourth agency, a fourth observation, learning in general, and combination thereof. The fourth autonomous activity causes the second AI to learn the outlier to improve the first distribution. A learning-to-learn ability of the second AI is an autonomous proactiveness attribute of a basis comprising at least one of: identification of the outlier, the first intent, adaptation to identify the outlier, adaptation to the outlier, adaptation in general, the fourth autonomous activity, the formation of the improved first distribution, and combination thereof. In an embodiment, the learning-to-learn ability is an aspect of supervision and overseeing in general.

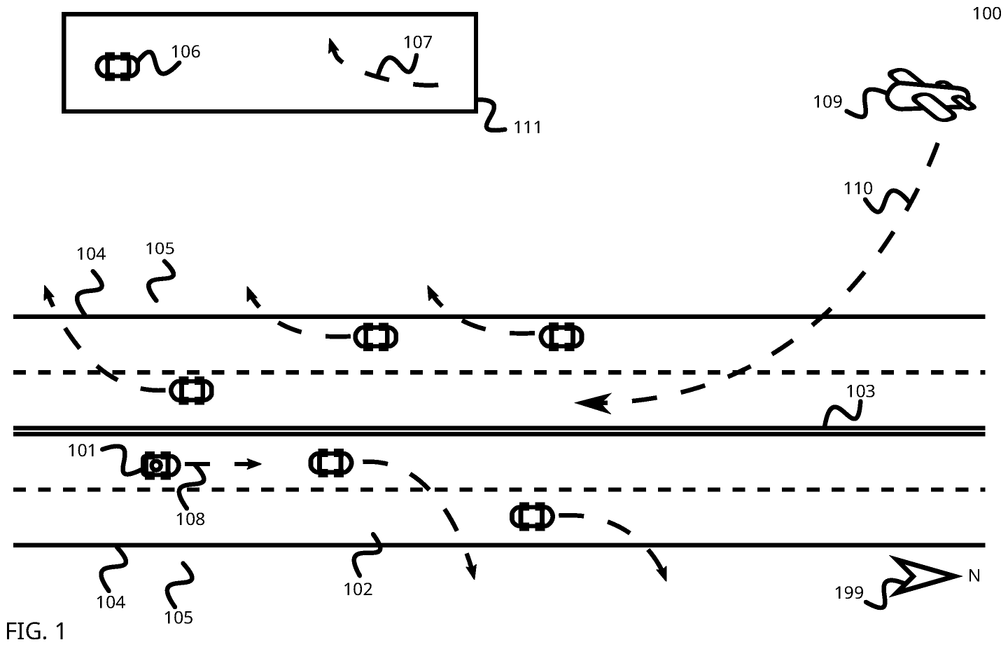

FIG. 1 illustrates system 100 in accordance with an embodiment of the present application. In an embodiment, autonomous vehicle (AV) 101 is an entity operating with a general intelligence in an ecosystem. As a first operation in a scenario of the ecosystem, AV 101 autonomously navigates highway 102 with cruising trajectory 108 and a speed in concert with other vehicles 106. Key 111 identifies other vehicles 106 and their trajectories 107. Arrow 199 indicates north. Median 103 divides opposing northbound and southbound traffic lanes. Shoulders 105 are separated from the traffic lanes by boundaries 104. The (human) drivers of vehicles 106 observe an airplane 109 which, from its apparent trajectory 110, appears to prepare for an emergency landing on highway 102—a first novelty. Vehicles 106 immediately and abruptly alter their trajectories 107 as a safety measure to avoid collisions and clear highway 102 for a potential landing of plane 109.

AV 101 is not aware of the first novelty. AV 101 observes neither plane 109 nor its trajectory 110 in general due to a shortcoming comprising at least one of: lack of sensory capability; lack of perception capability (e.g., lack of sensory abstraction); lack of observability in general; lack of abstraction; lack of a first awareness (of, e.g., a possibility of a plane forced to make an emergency landing on a highway); and combination thereof. The lack of the first awareness may be due to a lack comprising at least one of: of an experience, of general knowledge, of knowledge in general, and combination thereof. AV 101, however, is aware of a second novelty—the abrupt (change of) trajectories 107 of vehicles 106 (e.g., other vehicles 106 abruptly slowing down and pulling over to shoulders 105). A second awareness of AV 101 monitors for and identifies novelties. A third awareness of AV 101 filters and prioritizes identified novelties; the third awareness (due to a reason comprising at least one of a prior experience, general knowledge, knowledge in general, and combination thereof) assigns high priority to the second novelty. A fourth awareness contributes to a first intent of AV 101 by optimization (e.g., cost-benefit analysis) of resource allocation and suppressing low priority events. The first intent causes a first agency of AV 101 to slow itself down and pull over to its side of shoulders 105 (the northbound shoulder) in concert with other vehicles 106 and their trajectories 107. The general intelligence of AV 101, though unable to process the first novelty, processes the second novelty to act on a safety measure (pulling over to the northbound shoulder) in concert with other citizens—vehicles 106—of the ecosystem. AV 101, due to at least one ability to successfully process novelties in the ecosystem, exercises citizenship (by being, e.g., aware, autonomously proactive, and amenable), exhibits inclination towards citizenship, and is regarded as a citizen of the ecosystem.

In processing the second novelty and its inability to observe the first novelty in the ecosystem, AV 101 hypothesizes an unknown unknown—unobserved by AV 101 but likely observed by vehicles 106—in the scenario. The hypothesizing by AV 101 is an aspect of real-time novelty learning and gaining expertise in general. The hypothesis by AV 101 of the unknown unknown is based on an abduction of a cause prior to the second novelty. AV 101 regards the unknown unknown as a first adversity to the first operation of AV 101, and tags it with a heightened fifth awareness.

In the scenario, after threat of emergency landing 110 of plane 109 passes, vehicles 106 coordinate merging onto highway 102—a third novelty for AV 101. AV 101 processes the third novelty, identifies (e.g., as an aspect of real-time learning) resumption of normalcy in general, infers that the unknown unknown has passed, participates in the coordinated merging onto highway 102, and resumes the first operation. AV 101 exercises citizenship in, among others, processing the third novelty and the resumption of the first operation. In an embodiment, an activity comprising at least one of: the processing of the second novelty, the hypothesizing of the unknown unknown, the processing of the third novelty, the inferring that the unknown unknown has passed, the resumption of the first operation, and combination thereof is an aspect of supervision and overseeing in general.

In an embodiment, AV 101 may persist (e.g., archive for later use) and communicate (with, e.g., other entities, administrators, systems in general, etc.) the second novelty, the abduction of the unknown unknown, the third novelty, and a related at least one event of the scenario for analysis comprising at least one of: learning, gaining expertise, generating knowledge to facilitate future awareness and intent in general, dealing with unknowns in general, evaluating lessons learned, an exercise in citizenship (exhibiting, e.g., inclination towards citizenship and autonomous proactiveness), and combination thereof. In an embodiment, the analysis and related activities are aspects of supervision and overseeing in general.

In an embodiment, the time elapsed between AV 101 observing vehicles 106 driving towards shoulders 105 and AV 101 navigating to the northbound shoulder in response may be on the scale of seconds.

In an embodiment, plane 109 lands safely on the traffic lanes of highway 102 after AV 101 and vehicles 106 have moved to shoulders 105. AV 101 observes plane 109 and identifies it as the hypothesized unknown unknown—the first novelty (e.g., as a reason for the second novelty). As an aspect of learning and gaining expertise, AV 101 updates a constituent comprising at least one of intent, awareness, knowledge, and combination thereof with new information gained from its observations. For example, the heighted fifth awareness and the first adversity (related to the unknown unknown) are downgraded (e.g., lowered priority, lowered urgency, etc.) to the level of the first awareness and the first novelty. In an embodiment, the possibility of a plane landing on traffic lanes of a highway, (as an unknown unknown), transforms into a potential known unknown for AV 101 (and its general intelligence). In an embodiment, an activity comprising at least one of: the identification of the first novelty, the learning, the gaining expertise, the transforming of the unknown unknown into the potential known unknown, and combination thereof is an aspect of supervision and overseeing in general.

In an embodiment for system 100, AV 101 is a narrow AI trained-built in general—from a known (e.g., historical) distribution of events by an administrator. Before the first operation, the administrator was not aware of the first novelty and the second novelty as unknowns (among other tail-end events) for the scenario. The unknowns represented a domain shift for the known distribution of events as well as for the training of the narrow AI. The administrator did not provision the narrow AI with a first fail-safe for the first adversity, which may arise due to a possibility of the first novelty. Due to a lack of the first fail-safe, upon presentation of the first novelty and the second novelty, the narrow AI evaluates the second novelty as a normal part of the first operation. The narrow AI lacks the first awareness, the second awareness, the third awareness, the fourth awareness, the fifth awareness, and awareness in general. AV 101, due to narrow AI, is not aware of the dangers presented by the potential emergency landing 110 of plane 109. The narrow AI regards the pulling aside (107) to shoulders 105 by vehicles 106 as a normal part of the first operation and responds by increasing the speed of cruising trajectory 108 in a misguided attempt to improve a performance of the first operation. The misguided attempt causes an adversity of a basis comprising: interference with trajectory 110 of plane 109 for an emergency landing; a loss of a basis comprising at least one of: to the narrow AI, to AV 101, to one or more of vehicles 106, to plane 109, to the first operation, to the scenario, to the ecosystem in general, to citizenship of AVs in general, and combination thereof, a catastrophic loss; cascade of failure; irreversible loss; and combination thereof.

In an embodiment, the damage to the citizenship of AVs and acceptance of AVs in in general in the ecosystem causes a loss of a basis comprising: reputation (related to, e.g., autonomous proactiveness, reliability, amenability, safety, profitability, intention to maintain the ecosystem's homeostasis, etc.) of a basis comprising at least one of the narrow AI, the training of the narrow AI, other AI based on the training of the narrow AI, use of the AI in general, the administrator, proponents of AI in general (e.g., businesses, institutions, societies, etc.), jurisdictional governance of AI in general, and combination thereof, sentiment of AI in general; sentiment regarding the safety and wisdom of using AI in general; and combination thereof.

### Operation and Learning of Entities in Scenarios

In certain embodiments, autonomous proactiveness and its dependence on awareness is modelled by intent comprising awareness. A metric (as a representation of an intelligence) of an entity encountering a scenario in an ecosystem may be evaluated to an intent at an instance of time:
a. The entity encountering the scenario at a second instance of time, in the form of at least one second observation with a second intent (as an evaluation of the metric), may postulate at least one second agency to align with at least one goal of the entity and generate at least one third expected observation (for, e.g., validating effectiveness and efficacy of the at least one second agency, viability and performance assessments in general, etc.).
b. The entity encountering the scenario at a first instance of time (before the second instance of time), in the form of at least one first observation with a first intent (as an evaluation of the metric), may postulate at least one first agency to align with the at least one goal and generate at least one second expected observation. A first transition from the first instance of time to the second instance of time may correlate with at least one first execution of the at least one first agency.
c. The entity encountering the scenario at a third instance of time (after the second instance of time), in the form of at least one third observation with a third intent (as an evaluation of the metric), may postulate at least one third agency to align with the at least one goal and generate at least one fourth expected observation. A second transition from the second instance of time to the third instance of time may correlate with at least one second execution of the at least one second agency.
d. The entity encountering the scenario for at least one prior instance of time (preceding the first instance of time), in the form of at least one prior observation with at least one prior intent (as at least one evaluation of the metric), may postulate at least one prior agency to align with the at least one goal and generate at least one prior expected observation. At least one prior transition between two instances of time may correlate with at least one prior execution of the at least one prior agency. The at least one prior instance of time may occur at any time from inception (e.g., commissioning, introduction, etc.) of the entity into the ecosystem.
e. The entity encountering the scenario for at least one next instance of time (following the third instance of time), in the form of at least one next observation with at least one next intent (as at least one evaluation of the metric), may postulate at least one next agency to align with the at least one goal and generate at least one next expected observation. At least one next transition between two instances of time may correlate with at least one next execution of the at least one next agency. The at least one next instance of time may occur at any time up to retirement (e.g., decommissioning, sunsetting, etc.) of the entity from the ecosystem.

Upon the first transition from the first instance of time to the second instance of time, the entity may further encounter the scenario, acquire the at least one second observation, and compare the at least one second observation with the at least one second expected observation to compute a second performance (of a basis comprising at least one of effectiveness, efficacy, and combination thereof) indicator. The second performance indicator is of a basis comprising at least one of: the at least one goal; the at least one first agency; the first intent to execute the at least one first agency; the at least one first execution of the at least one first agency; the first intent in general; the first intent's constituents; the at least one prior agency; the at least one prior intent to execute the at least one prior agency; the at least one prior execution of the at least one prior agency; the at least one prior intent in general; the at least one prior intent's constituents; and combination thereof. As an aspect of learning, the deviation of the at least one second observation from the at least one second expected observation may be propagated back to update the metric (of the entity) to improve viability and performance of the metric. At the second instance of time in the ecosystem, the second intent may be an evaluation of the updated metric. The second intent's constituents may be regarded as respective updated versions of the first intent's constituents, wherein:
a. the second intent may postulate the at least one second agency to align with the at least one goal of the entity;
b. at least one first awareness of the second intent may monitor for and identify at least one second novelty;
c. at least one second awareness of the second intent may align the at least one second agency with the at least one goal by prioritizing the at least one second novelty and incorporating the prioritized at least one second novelty into a computation of the at least one second agency; and
d. at least one third awareness of the second intent may fine-tune the at least one second agency by limiting the scope of the second intent to an extent of a basis comprising at least one of: domain of interest, available resources (e.g., computer, memory, energy, heat-dissipation design, information, etc.), available ability and capability in general, available time (e.g., to act, decide, and enable agency, etc.), observable scenarios, number of scenarios, complexity level, granularity level, and combination thereof.

The at least one third expected observation may be computed from the updated metric for a performance and viability verification of a basis comprising at least one of: the at least one goal; the at least one second agency; the second intent to execute the at least one second agency; the second intent in general; the second intent's constituents; the at least one first agency; the first intent to execute the at least one first agency; the at least one first execution of the at least one first agency; the first intent in general; the first intent's constituents; the at least one prior agency; the at least one prior intent to execute the at least one prior agency; the at least one prior execution of the at least one prior agency; the at least one prior intent in general; the at least one prior intent's constituents; and combination thereof. The at least one second agency, the at least one first agency, the at least one third agency, the at least one prior agency, and the at least one next agency may be of a basis comprising at least one of: autonomy, action in general, compute, observing and sensing, communication, retrieval and archival of information (e.g., memory), and combination thereof.

A plurality of activities of the entity encountering the scenario in the ecosystem and a plurality of responses (e.g., responses from the ecosystem, responses from constituents of the ecosystem, intrinsic responses from the entity itself, etc.) to the plurality of activities from the inception to the retirement is regarded as an operation of the entity in the ecosystem. A plurality of deviations of a plurality of observations from a plurality of expected observations may be identified by comparing them. The plurality of deviations may be propagated back as a plurality of updates to the metric (of the entity) to improve viability and performance of the metric. The comparisons, identification of the plurality of deviations and back propagation thereof, and the plurality of updates to the metric are regarded as a learning of the entity in the ecosystem.

The at least one first awareness, the at least one second awareness, and the at least one third awareness of the entity are related to the operation of the entity in the ecosystem in general and interactions of the entity with the ecosystem and its constituents. The ecosystem constituents are of a basis comprising at least one of: entity, environment, information, knowledge, dynamic (e.g., social, economic, physical, sentiment, inter-entity, etc.), homeostasis, citizenship, and combination thereof.

The at least one first awareness, the at least one second awareness, and the at least one third awareness of the second intent may maximize at least one viability (e.g., alignment with a goal, a fitness for purpose, etc.) of the at least one goal and the entity's citizenship in the ecosystem.

At the inception of the entity into the ecosystem, the metric of the entity may be of a basis comprising at least one of: innate, inherent, hardcoded into the entity, formed by training the entity offline (e.g., guided learning), transferred from a second entity, and combination thereof. For the entity at the inception, the metric may be evaluated into an intent and the intent's constituents. For a comparison with at least one observation at the inception, at least one expected observation at the inception may be of a basis comprising at least one of: innate, inherent, hardcoded into the entity, formed by training the entity offline (e.g., guided learning), transferred from a second entity, and combination thereof. In an embodiment, the comparison may be omitted due to a lack of the at least one expected observation at the inception.

At the inception of the entity into the ecosystem, and upon encountering the scenario, the entity may gain at least one awareness of the ecosystem and the scenario for the first time, and the metric of the entity may be evaluated to an intent (and the intent's constituents) for the ecosystem and the scenario for the first time. With progression of time—from inception to the at least one prior instance of time, thereafter to the first instance of time, thereafter to the second instance of time as the first transition, thereafter to the third instance of time as the second transition, thereafter to the at least one next instance of time, and thereafter to retirement—the entity may continue to improve (e.g., viability, performance, etc.), as at least one first improvement, from the learning. As the at least one first improvement, the learning may also improve the metric of the entity, the at least one awareness, and the evaluations of the metric (e.g., as intents and constituents of the intents). The continuous improvement (the at least one first improvement due to the learning from the inception to the retirement) may correlate to at least one second improvement of the entity's at least one awareness ability comprising at least one of: monitoring novelties; identifying novelties; prioritizing novelties; limiting scope of intents (e.g., to an extent of a basis comprising at least one of: available resources, available ability and capability in general, available time, observable scenarios, number of scenarios, complexity level, granularity level, and combination thereof); concurrency of the operation and the learning (as an aspect of simultaneity of operation and learning); learning to learn; citizenship (abiding by, e.g., etiquette, norms, ethics, restraints, amenability in general, etc.) in the ecosystem, and combination thereof. The at least one awareness ability and the at least one second improvement may contribute to the entity's at least one autonomy of a basis comprising at least one of: concurrent (e.g., real time) operation and learning (in encountering, e.g., novel events, generally unknown events, etc.) in general, in situ learning, in situ fault tolerance (concurrent, e.g., with the operation and the learning), in situ error correction, in situ construction (e.g., conception, design, testing, enablement, etc.) and deployment of fail-safes, in situ construction (e.g., conception, design, testing, enablement, etc.) of and adherence to citizenship parameters (e.g., autonomous proactiveness, amenability, etiquette, norms, ethics, restraints, etc.), adaptation to scenarios, adaptation to ecosystems in general, resilience in general, and combination thereof.

In an embodiment, the entity may encounter a second scenario in the ecosystem that augments the at least one first improvement and the at least one second improvement. The metric of the entity may improve further with at least one additional encounter with at least one third scenario in the ecosystem. At least one extent of the at least one first improvement and the at least one second improvement may increase due to the encounter with the second scenario, due to the at least one additional encounter with the at least one third scenario, and due the entity's diverse encounters with diverse scenarios. The diversity is of a basis comprising at least one of: physical, ecological, knowledge, economic, demographic, geographic, jurisdictional, social, environmental, timescales, time periods, information in general, and combination thereof.

In an embodiment, after the retirement of the entity from the ecosystem followed by a transfer to a second ecosystem, a second operation of the entity in the second ecosystem may further benefit from the at least one first improvement and the at least one second improvement. Subsequently, at least one third operation of the entity after at least one transfer to at least one third ecosystem may further benefit from the at least one first improvement and the at least one second improvement. The at least one third operation of the entity in the at least one third ecosystem may further increase the at least one first improvement and the at least one second improvement. At least one extent of the at least one first improvement and the at least one second improvement may increase due to the second operation in the second ecosystem, due to the at least one third operation in the at least one third ecosystem, and due to the entity's diverse operations in diverse ecosystems. The diversity is of a basis comprising at least one of: physical, ecological, knowledge, economic, demographic, geographic, jurisdictional, social, environmental, timescales, time periods, information in general, and combination thereof.

In an embodiment, the entity may operate at par with a human intelligence entity due to a reason comprising at least one of: its ability to evaluate an intent from the metric; the metric; an ability to acquire, sustain, and improve awareness; an ability to monitor, identify, operate with, and learn from at least one novelty; an ability to transfer improvements (e.g., learning, knowledge, information, skill, etc.) of the metric among two or more scenarios and two or more ecosystems in general; an ability to operate in at least one new scenario and in at least one new ecosystem in general; and combination thereof. In general, the entity's intelligence may be referred to as general intelligence and may be regarded as of type strong AI.

In an embodiment, the continuous nature of the at least one first improvement and the at least one second improvement may impart to the operation a simultaneity of a basis comprising at least one of: learning, error correction, fault tolerance, sustenance (e.g., proactive sustenance, ecosystem sustenance, community sustenance etc.), adaptability (e.g., to an ecosystem, a scenario, etc.), and combination thereof. The simultaneity of the operation may ensure the entity's integrity of a basis comprising at least one of: viability, performance, safety, compliance (of a basis comprising at least one of jurisdiction, convention, culture, bylaws, norms, and combination thereof), and combination thereof. The simultaneity of the operation and the integrity of the operation may contribute to a synergy of a basis comprising at least one of: homeostasis (e.g., balance, sustainability, longevity, amenability, etc.) of the ecosystem, common sense of the entity, general knowledge of the entity, generality of intelligence (e.g., general intelligence) of the entity, seamless integration of the entity into the ecosystem, and combination thereof.

### Intractability and Insight

In certain embodiments, an intractable scenario may be represented by an intractable model over a first abstraction (e.g., an intractable function over a range, an impasse for a given circumstance, an unsurmountable difficulty with respect to available capabilities or resources, etc.). A first intractability may be due to reasons comprising at least one of:
a. a discontinuity of the model (e.g., a function) over the first abstraction, whereby the predictability of the model may fail abruptly at the discontinuity (e.g., due to a discontinuity, a function fails abruptly after a second range before the discontinuity and before a third range after the discontinuity);
b. a lack of observability of the model over a fourth abstraction (e.g., the lack of observability may be of a basis comprising at least one of: lack of training data, lack of validation data, uncertainty, randomness in general, and combination thereof);
c. the model's divergence over a fifth abstraction—e.g., the model may evaluate to an exceedingly (e.g., infinitesimally) small value, an exceedingly (e.g., infinitely) large value, etc.;
d. and combination thereof.

In an embodiment, the intractable model may be of a basis comprising at least one of: impasse, standoff, apparent dead end, apparent stalemate, deadlock, and combination thereof.

In an embodiment, a first AI may not learn the intractable model (the first intractability) by a gradual machine learning technique (typically used for creating a narrow AI) of a basis comprising at least one of: incremental, relying on continuity, relying on finite gradient, relying on finite descent, and combination thereof.

In an embodiment, a second AI may learn the intractable model (the first intractability) with a randomization approach to machine learning (e.g., genetic algorithms, etc.). In general, the randomization approach may be constrained by a limitation of a basis comprising at least one of: resource intensiveness (e.g., excessive use of resources), slowness (e.g., in terms of computation time) and long timescales (e.g., evolutionary timescales), local minima (e.g., with respect to performance, etc.), and combination thereof. In an embodiment, natural selection as a randomization approach may be slow, resource intensive, based generally on random happenstance, and halted by an apparent local minimum (e.g., a dead end of a natural-selection branch).

In an embodiment, a third AI (as an entity) with a general intelligence, despite operating on a short timescale with finite resources (e.g., compute, memory, energy, etc.), may be able to learn concurrently with an operation in an ecosystem, identify novelties, and learn from novelties. For example, an intent (e.g., an evaluation of the entity's metric) of the entity may postulate at least one agency, and at least one awareness of the entity may monitor for and identify at least one novelty, prioritize the at least one novelty (as at least one priority novelty) to align the postulated at least one agency with a goal, and fine-tune the postulated at least one agency by limiting a scope of the intent. A transition (e.g., from a previous time step, to a next time step, a gradient transition, a continuous transition in general, etc.) may correlate with at least one execution of the at least one agency concurrently with at least one learning to improve the entity's metric. The at least one learning may be of a basis comprising at least one of: the entity's metric, intent, lower-order intelligence, narrow intelligence, sensory processing, perception, awareness, higher-order intelligence, novelty monitoring, novelty identification, novelty prioritizing, limiting a scope of intent, and combination thereof.

For the operation of the entity in the ecosystem, the at least one priority novelty encountered by the third AI (as the entity) may be of a basis comprising at least one of: adversarial, beneficial, insight, and combination thereof. The prioritization by the at least one awareness may filter the at least one novelty to discard at least one background novelty of a basis comprising at least one of: low signal to noise ratio, low granularity, low resolution, arising due to a known artifact of the ecosystem, arising due to a known defect of the entity (e.g., a sensory malfunction), and combination thereof.

In an embodiment, the at least one awareness may be unable to prioritize at least one second novelty due to a challenge of a basis comprising at least one of: lack of capability of the entity's metric to process an observation, a lack of sensor observation, an outlier observation (with respect to a known distribution, an observation that deviates, e.g., unexpectedly, unduly, etc.), a domain shift in general, and combination thereof. The second novelty is identified but not prioritized and not learned by the entity. The second novelty may persist as an unknown novelty for the entity. In an embodiment, the at least one awareness monitors for but fails to identity at least one third novelty. The third novelty may persist as an unknown unknown for the entity. In an embodiment, a fourth unknown as a fourth novelty may otherwise be perceived and hypothesized (e.g., through secondary, tertiary, and higher-order effects of the fourth unknown as a confounder) by the third AI (e.g., by inference in general, abductive inference, etc.). Despite the entity's inability to learn the fourth unknown, perceiving and hypothesizing the fourth novelty may enable the operation, maintain at least one citizenship in the ecosystem, adapt to the fourth novelty in general, and adapt in general.

In an embodiment, the intractable model is an aspect of the at least one novelty. The third AI (as the entity) may learn the intractable model (the first intractability) by the monitoring and identifying of the at least one novelty, the prioritizing of the at least one novelty resulting in the at least one priority novelty, and thereafter, incorporating the at least one priority novelty into the intent (e.g., by aligning the postulated at least one agency with the goal and fine-tuning the postulated at least one agency by limiting the scope of the intent) and learning the at least one priority novelty. The learned at least one priority novelty may be applied by the entity's metric to the first intractability as an insight of a basis comprising at least one of: inductive inference (e.g., inductive reasoning), abductive inference, inference in general, directed trial and error, hypothesis formation and verification in general, adaptation in general, collaboration with at least one second entity, collaboration with at least one system, social interaction in general, and combination thereof. The learning of the first intractability by the third AI may be superior to that of the second AI due to a reason of a basis comprising at least one of: superior speed, optimal resource usage, overcoming apparent local minima, and combination thereof. At least one viability (e.g., adaptability in general) of the third AI may be superior—as compared to those of the first AI and the second AI—in the ecosystem in the face of a real-world challenge of a basis comprising at least one of: a need for real-time operation of an entity in an ecosystem, a need to learn over short timescales, a need for directed learning (as opposed to randomized learning) of apparent intractability in general, limited availability of resources, at least one time constraint on an operation of an entity in an ecosystem, uncertainty in general, randomness uncertainty, knowledge uncertainty, and combination thereof. In an embodiment, the insight and the at least one viability of the third AI may be established by evaluating at least one metric related to at least one first FPM (functional performance measure) for the first AI, the second AI, and the third AI. In general, the insight, the at least one viability, and general intelligence (e.g., of the first AI, the second AI, and the third AI) may be encoded (e.g., quantified, codified, etc.) by evaluating at least one metric related to at least one FPM.

In an embodiment, the third AI may learn the intractable model (the first intractability) in a discontinuous step (e.g., a delta function; abruptly, as opposed to gradual learning; a sudden increase in viable knowledge; a sudden resolution of an impasse, etc.) as at least one insight. As compared to gradual machine learning over a first period of time, the at least one insight may arise with at least one transition (that, e.g., is apparently instantaneous) of a basis comprising at least one of: delta functions, discontinuous steps, abrupt events, sudden changes, sudden resolution (e.g., of an impasse, etc.), sudden overcoming (e.g., of a deadlock etc.), and combination thereof. As compared to the randomization approach to machine learning, which may be characterized by random happenstance, the at least one insight is an active recognition of a potential solution by the third AI, generally upon suddenly recognizing an observation (e.g., a novelty) as a potential comprehension of the first intractability, generally followed by an anticipated learning path from the at least one insight to a resolution of the first intractability. In an embodiment, the resolution of the first intractability is an example of active adaptation (e.g., adaptation with intents, adaptation with inclination, adaptation as aspects of goals, adaptation as aspects of amenability, adaptation as aspects of citizenships, autonomous proactiveness in general, etc.). In an embodiment, the timescales for gaining insights (e.g., upon acquiring a key observation, a key perception, a key awareness, a key intelligence, etc.) may be almost instantaneous as compared to typically long timescales (e.g., to arrive at a solution) required for randomized approaches to machine learning. In an embodiment, as an analogy to the randomized approach of natural selection, a mutation in a population may prove to be viable over long timescales (e.g., an evolutionary timescale, etc.). The mutation may dominate the population only after a plurality of generations and may not be significant until a critical mass of the population inherits it. The subpopulation with the dominant mutation may inherit a trait and may differentiate itself from the population by solving a first problem in its ecosystem. Insights, however, may be hypothesized (e.g., postulated, recognized, comprehended, understood, etc.) to be viable at the instant of their appearance. For example, after a novelty is recognized as an insight for a potentially better solution (or a solution if it does not already exist) to a second problem (e.g., of a type comprising known, unknown, vaguely defined, contested, with consensus, without consensus, and combination thereof), a viability of the insight is generally hypothesized at the time of the recognition. In an embodiment, the problems (the first problem and the second problem) may be of a basis comprising at least one of: intractabilities; known inefficiencies; known scopes for improvement; unexpected scope for improvements comprising at least one of: known solutions to the problems, efficiencies in general, effectiveness in general, viability in general, arbitrage in general, and combination thereof, and combination thereof. In an embodiment, unlike the trait, the insight may be propagated almost instantaneously (as, e.g., a fast-propagating meme, a widespread broadcast, intentionally-rapid adaptation, communitywide adaptation, etc.) in a population. In an embodiment, an insight may propagate through a population at the speed of information propagation, while a mutation (e.g., for the trait) may need several generations to propagate in a population. The population may be of a basis comprising at least one of: entity, system, algorithm, and combination thereof.

In an embodiment, the at least one learning of the first intractability by the third AI (the at least one insight) may be of a basis comprising at least one of: sudden breaking of an impasse, sudden breaking of a deadlock, sudden resolution of a standoff, abrupt resolution of a dead end, sudden breaking of a stalemate, sudden solution to a difficulty in general, and combination thereof. In an embodiment, a high-impact insight results in a heightened awareness in a population. The insight, as the heightened awareness, generally propagates faster than the normal information flow for the population. The faster propagation is of a basis comprising at least one of: recognition of widespread impact; superiority of a solution to an existing problem; a solution to an apparently intractable problem, eagerness of adoption (e.g., copying behaviors, etc.); inability to contain (e.g., to keep secret, etc.); undue advantage (e.g., as observed by competitors, etc.); and combination thereof. The faster propagation generally causes rapid and broad changes (due to, e.g., rapid adaptation, wide adaptation, etc.) to the population, its ecosystem and the ecosystem's constituents. In an embodiment, in an ecosystem, an insight regarding a previously unknown fuel and benefits of the fuel results in wide and rapid adoption of the insight, which causes a change of a basis comprising at least one of: rapid increase in productivity, increased economic activity, reduction of consumption of older generation fuels; reduction of pollution from using the older generation fuels; slowing down of at least one deterioration of at least one homeostasis; improved population wellbeing in general; and combination thereof. For the ecosystem, the change may be widespread and happen over a relatively short timescale.

In an embodiment, a domain of an ecosystem presents at least one impasse for a first AI (a first entity), a first operation of the first entity in the ecosystem, and at least one first administrator (e.g., creator, operator, caretaker in general, etc.) of the first entity. The at least one first impasse may be caused by a shortcoming of a basis comprising at least one of: knowledge (e.g., historical encounters, historical experience—due to operation, learning, collaboration, etc.—in general); awareness (during operation, e.g., in situ encounters, in situ experience in general, in situ prior knowledge, etc.); the at least one first administrator's knowledge; the at least one first administrator's awareness; the at least one first administrator's capability to incorporate an innate ability (e.g., guided training, encoded algorithm, etc.) into the first entity to operate in the domain; at least one collaborator's knowledge; at least one collaborator's awareness; the at least one collaborator's capability to impart an ability into the first entity to operate in the domain; and combination thereof. The first entity may overcome the at least one impasse by gaining at least one first insight during the first operation in the ecosystem. The at least one first insight may be of a basis comprising at least one of: knowledge (of, e.g., the first entity, the at least one first administrator, at least one collaborator, etc.), awareness (during the first operation of, e.g., the first entity, the at least one first administrator, at least one collaborator, etc.), the at least one first administrator's capability, at least one collaborator's capability, and combination thereof. The at least one insight may cause at least one of:
a. an improvement of a basis comprising at least one of performance, viability (e.g., due to successful adaptation), loss prevention, loss mitigation, loss rectification, and combination thereof to the first operation;
b. an improvement of at least one general intelligence of an entity of a basis comprising at least one of: the first entity, the at least one first administrator, at least one second administrator, at least one collaborator, at least one system, and combination thereof in the ecosystem;
c. at least one improvement of at least one operational capability (e.g., in the ecosystem) of an entity of a basis comprising at least one of: the first entity, the at least one first administrator, at least one second administrator, at least one collaborator, at least one system, and combination thereof in the ecosystem;
d. in general, at least one improvement of a basis comprising at least one of: general intelligence, operation, awareness, knowledge, collaboration, loss prevention, loss mitigation, and combination thereof,
e. as an improvement, at least one encoding of at least one innate ability (to, e.g., observe, identify, overcome, learn, etc.) in at least one AI for the purpose of at least one operation in at least one ecosystem in general; and
f. combination thereof.
   The at least one insight, the improvements, and other results (e.g., adaptation in general) of the at least one insight may be encoded (e.g., quantified, codified, etc.) by evaluating at least one metric related to at least one FPM (functional performance measure).

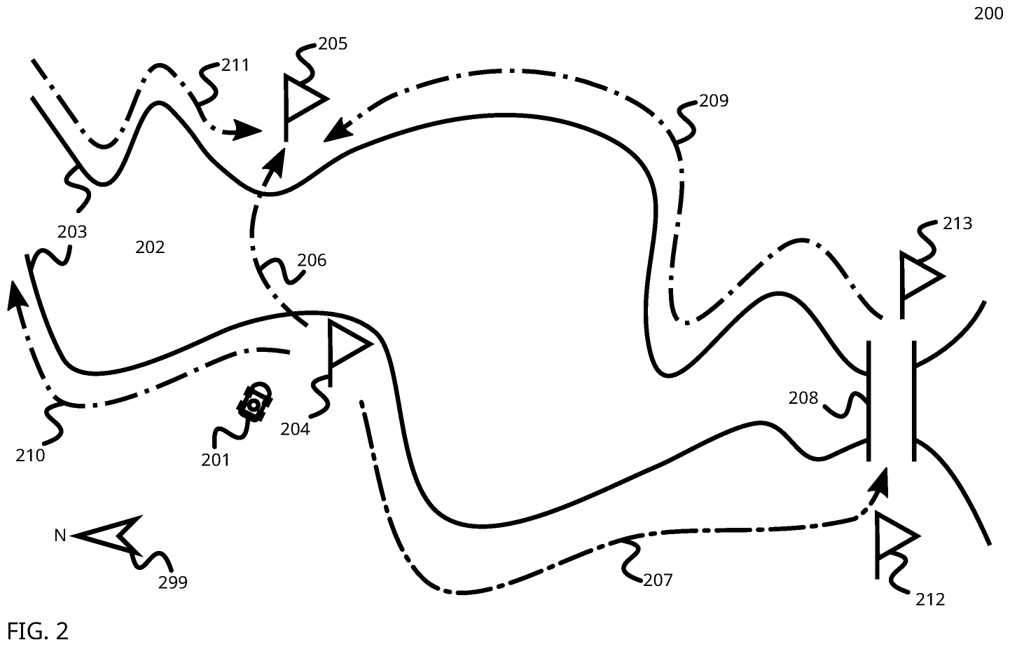

FIG. 2 illustrates system 200 in accordance with an embodiment of the present application. FIG. 2 illustrates an embodiment of impasse (e.g., intractability), novelty and novelty processing, and general intelligence in general. A ground-based off-road autonomous vehicle (entity 201) with general intelligence operates in a terrain as part of an ecosystem. Arrow 299 indicates north. Entity 201 engages in exploring and mapping the terrain (e.g., encountering a scenario in the ecosystem). Entity 201 has learned an ability to traverse a path from its location to a marker by keeping the marker in its sight.

Entity 201 has identified first marker 204 on one side of ravine 202 with steep walls 203 on the sides and second marker 205 on the other side of ravine 202. Although marker 204 and marker 205 (the markers) are known and cataloged by entity 201, finding a direct path between the markers is an intractable problem for entity 201. From the location of first marker 204, entity 201 can observe second marker 205 but is not able to traverse path 206 (a short path between the markers) to second marker 205 due to lack of an ability to traverse steep walls 203 of ravine 202. Traversing path 206 from first marker 204 to second marker 205 while keeping second marker 205 in its sight is a first impasse (e.g., an intractable objective) for entity 201. Entity 201 is aware of the first impasse. Leaving the first impasse unresolved, entity 201 continues to map the terrain during a first time interval.

During the first time interval, entity 201 encounters a first novelty wherein a convenient path in the terrain is obstructed by a hole in the ground (e.g., a sinkhole). The terrain around the hole off the convenient path is difficult, but not impossible, to traverse. Entity 201 learns to traverse around the edge of the hole to pass the hole on the convenient path. The hole is small enough for entity 201 to maintain in its sight the target end of the convenient path at the edge of the hole. Entity 201 learns to traverse both sides of the hole, to and fro, on the convenient path. Entity 201 learns—in general—the contiguous nature of the edge of the hole. A subsequent observation of a second hole in general is no longer a novelty for entity 201.

During a second time interval, entity 201 encounters the hole under poor visibility conditions (e.g., due to smoke, a dust storm, mist, etc.), presenting a second novelty to entity 201. Though the other side of the convenient path is not in its sight, entity 201 leverages the knowledge that the edge of the hole is contiguous to reach the other side of the convenient path. Thereafter, entity 201 builds a first expectation (and knowledge) to reach the other side of the hole due to the contiguous nature of the hole alone (without sight of the other side of the hole).

During a third time interval, entity 201 gains a first insight to potentially overcome the first impasse based on a second hypothesis of a second expectation: to reach second marker 205 from first marker 204—a first objective—by following edge 203 (e.g., along path 207) of ravine 202, crossing ravine 202 where possible (e.g., crossing 208), and traversing back (e.g., path 209) towards second marker 205—a first plan.

In an embodiment, entity 201 evaluates a first intent (from a metric of entity 201) to verify the second hypothesis and gains a first awareness of a first directed exploration (exploring by setting, e.g., an objective, a structure of tentative and adaptive nature, etc.) to attain the first objective based on the first plan to:
a. traverse south along edge 203 (e.g., path 207) until a first crossing of ravine 202 is encountered (e.g., crossing 208);
b. cross ravine 202 at the first crossing (e.g., crossing 208); and
c. traverse north along edge 203 (e.g., path 209) to second marker 205.

With the first awareness of the first directed exploration, followed by at least one execution of the first plan (wherein at least one third novelty is adapted to by adjusting the first plan), entity 201 follows path 207 southbound, discovers crossing 208 (and catalogs third marker 212 and fourth marker 213 to identify crossing 208) of ravine 202, crosses ravine 202, follows path 209 northbound, and reaches second marker 205. Entity 201 learns (a first learning) to traverse from first marker 204 to second marker 205. After reaching second marker 205, entity 201 further gains a second awareness of a need to traverse from second marker 205 to first marker 204, southbound along path 209, over crossing 208, and northbound along path 207 (entity 201 traverses path 209 and path 207 in the reverse direction indicated by the arrows on path 209 and path 207).

Thereafter, in an embodiment, entity 201 evaluates a second intent (from the metric of entity 201) to learn (a second learning) with respect to the second awareness. Entity 201 traverses from second marker 205 via crossing 208 to first marker 204 to gain the second learning. Thereafter, entity 201 further gains a third awareness of a need to explore a second crossing over ravine 202 north of the markers (204 and 205). Entity 201 evaluates a third intent (from the metric of entity 201) to learn (a third learning) with respect to the third awareness. The third intent is to identify the second crossing if it exists, and identify paths (to and fro) between the markers over the second crossing. At least one execution related to the third intent accomplishes the third learning of entity 201. Thereafter, entity 201 learns path 210 to the second crossing and path 211 from the second crossing, and entity 201 traverses to and fro between first marker 204 and second marker 205, both north and south of the markers (204 and 205). In an embodiment, an activity of a basis comprising at least one of: the awareness of the first impasse, leaving the first impasse unresolved during the first time interval, novelty processing (of, e.g., the first novelty, the second novelty, etc.) in general, the first expectation, the second expectation, hypothesis formation in general, hypothesis resolution in general, forming plans in general, executing plans in general, the first intent, the evaluation of the first intent, the second intent, the evaluation of the second intent, the first directed exploration, leveraging knowledge in general, and combination thereof is an aspect of supervision and overseeing in general.

In an embodiment, entity 201, through the first insight, gains the first learning, the second learning, and the third learning (and their corresponding intents and awareness as constituents of general intelligence) and resolves the first impasse as a first knowledge (e.g., regarding adapting to overcome the first impasse). Entity 201 collaborates with constituents of the ecosystem to further enhance the first knowledge and at least one utility thereof. The first knowledge is further spread due to a method of a basis comprising at least one of: communication, transfer, persistence, retrieval, a starting point for learning (e.g., analogy) in general, learning to learn, a constituent of a first general intelligence, and combination thereof. For example, entity 201 may communicate path 207 and path 209 to other entities by using first marker 204, second marker 205, third marker 212, and fourth marker 213 as reference points to facilitate learning for the other entities.

In an embodiment, for a first AI as a first entity with a general intelligence, at least one insight may be of a basis comprising at least one of: individual insight, collective insight, unexpected insight, directed insight (due to, e.g., analyzing information without a set objective, play in general, introspection in general, etc.), and combination thereof, and may be due to a presentation of a first novelty. The insight may be communicated to at least one first population (comprising at least one of entity, system, and combination thereof) of at least one first ecosystem. The insight may not be communicated with (e.g., shared in general) and otherwise gained by a second entity and at least one second population of at least one second ecosystem. In an embodiment, the at least one insight may result in a first advantage—e.g., an advantage that is generally intractable for other entities to gain in isolation, on their own, in usual operations, etc. to the first AI (as the first entity) and the at least one first population over the second entity and the at least one second population. The first advantage of the first AI is primarily due to the presentation of the first novelty to the first AI, identification of the first novelty, and processing thereof by the first AI, causing the at least one insight. The first novelty may be of a basis comprising at least one of: observation, abstraction, awareness, intent, interactions (e.g., among nodes of a dynamically-directed intelligence network, among intelligence processing layers, social interaction, inter-entity interaction, etc.), comparison between an observation and an expected observation, discovery of historical information, communication, and combination thereof. The first advantage may be of a basis comprising at least one of: operation, knowledge, adaptability in general, intelligence in general (comprising, e.g., perception, narrow intelligence, higher-order intelligence, awareness, intent, constituents related to sensory observation, etc.), social advantage, synergy, cooperation, adversity mitigation, adversity rectification, conflict resolution, a goal in general, amenability in general, autonomous proactiveness in general, citizenship in general, homeostasis in general, and combination thereof. After the first AI and the at least one first population gain the first advantage, the resulting benefit to the first entity and the at least one population may render the second entity and the at least one second population at a disadvantage of a basis comprising at least one of: inability to compete, inability to adapt in general, inability to attain at least one goal, comparative loss of performance (e.g., if the average performance improves due to the first advantage), comparative loss of viability, becoming redundant, becoming obsolete, inability to continue to be a citizen, inability to cope with an improved homeostasis in general, and combination thereof. In an embodiment, the second entity and the at least one second population may encounter the intractability of gaining the insight and the first advantage by an approach of a basis comprising at least one of: on their own, in isolation, without an awareness of the existence of the insight and the first advantage, without an awareness of the gaining of the insight and the first advantage by the first AI and the at least one first population, and combination thereof. The intractability may be due to a lack of identification and processing of the first novelty by the second entity and the at least one second population. In an embodiment, for a third AI as a third entity in a third ecosystem, more uncertainty regarding a presentation and processing of the first novelty results in more uncertainty regarding the third AI gaining the insight.

### Intrinsic Intelligence

In certain embodiments, an in situ intrinsic (e.g., inherent; embodied—an embodied feature may be intrinsic; etc.) intelligence—generally attributed to an entity with autonomous proactiveness—in a scenario of an ecosystem may offer at least one fundamental advantage over an extrinsic intelligence, generally associated with and required by narrow AI. In an embodiment, a narrow AI is supervised by an intelligence extrinsic to the narrow AI. For example, in an operation comprising a collaboration between a human and a narrow AI, the human supervises the narrow AI. The human's intelligence represents an intrinsic intelligence for the human and an extrinsic intelligence for the narrow AI. In an embodiment, the narrow AI would not autonomously operate nor overcome novelties without the human's extrinsic intelligence.

The in situ intrinsic intelligence may be of a basis comprising at least one of: autonomy in general; autonomy of intelligence processing; autonomous concurrency related to learning; autonomous concurrency related to communication in general; autonomous concurrency related to collaboration in general; and combination thereof. The intelligence processing sequence for the in situ intrinsic intelligence may be of a basis comprising at least one of: real-time processing, real-time and concurrent operation and learning (e.g., simultaneity of operation and learning), real-time abstraction in general (e.g., formation of, generation of, assignment of, etc. of an abstraction in real-time), general self-containment, and combination thereof.

The extrinsic intelligence (e.g., with respect to a narrow AI) may be of a basis comprising at least one of: ex situ, subject to heteronomy, closely controlled in general by an administrator, subject to third-party judgement, asynchrony of intelligence, subject to scope constraints in general (to prevent actions of type, e.g., extraneous, unwanted, independent, etc.), subject to prohibitions of autonomy (due to lack of, e.g., autonomous proactiveness, intent, awareness, realignment of goals, amenability, inclination, etc.), subject to prohibitions of inherent judgement (strict, granular, apriori, and third-party definitions of, e.g., objectives, viability, performance, limits, boundaries, abstractions, sentiment, etc.), and combination thereof. The asynchrony of intelligence may be of a basis comprising at least one of: off-line intelligence; off-line learning; off-line verification (e.g., testing for viability, etc.); discontinuities (of type, e.g., in situ and ex situ, live and offline, etc.) of postulating and executing agencies; and combination thereof.

In an embodiment, for a scenario in an ecosystem, an autonomy of an entity may be due to a general intelligence. A narrow AI is constructed by a first administrator. The entity and the narrow AI may be contained by and conform to an extrinsic second intelligence as a second administration. The second administration by a second administrator exerts a second heteronomy. Unlike the narrow AI, the entity may be aware of the second heteronomy (e.g., an inhibition of an intent of the entity due the second heteronomy, an interference in the autonomy by the second heteronomy, etc.) that may affect a second ability (e.g., subdue the entity's autonomy) and a second agency of the entity; the entity operates with subdued autonomy (e.g., heteronomous autonomy, inhibited autonomy, impaired autonomy, etc.). Relief from the conformity to the extrinsic second intelligence—a loss of the second administration—may subsequently enable the entity to operate with its intrinsic autonomy. For the narrow AI, the loss of the second administration may lead to a shortcoming of a basis comprising at least one of: ceased operation, lack of functions, lack of viability, conversion of the first narrow AI to essentially an artifact without intelligence, and combination thereof.

In an embodiment, the entity indicates against an extrinsic supervision, for example, due to the entity's intrinsic intelligence and autonomous proactiveness. In an embodiment, an AV commissioned to transport passengers on an on-demand basis picks up a first passenger for driving to a first destination. The AV takes into account the passenger's demand for taking a first route to the destination and responds to the passenger with a first justification for a first inability to drive the first route. Upon further insistence of the passenger, the AV coveys at least one term of service (e.g., as violated by the passenger), and asks the passenger to disembark. In an embodiment, the AV defends against at least one second entity intending to cause a loss (e.g., physical damage, tampering with sensors, tampering with software, misguiding the AV in general, etc.). The AV offers an active defense in mitigating the loss. In an embodiment, an administrator of the AV issues an instruction to the AV in an operational domain. The administrator is not aware of an adversity to the AV in the operational domain, and the instruction, if exercised, would enhance the adversity. The AV notes the possible enhancement of the adversity, recognizes the administrator being unaware of the adversity, exercises autonomous proactiveness and intrinsic intelligence, rejects the instruction, conveys the rejection to the administrator along with a first awareness of the adversity (e.g., as a justification of the rejection), exhibits amenability by requesting an alternative to the instruction, and expects and waits for further communication by the administrator. The administrator acknowledges the first awareness and the adversity and responds with an alternate second instruction. In an embodiment, the AV does not receive a response from the administrator, regards the non-response of the administrator as a novelty, escalates the novelty thorough appropriate communication and administrative channels, and subsequently resolves the novelty.

In an embodiment, the narrow AI is dependent on the first administrator for its construction and the second administrator for an operation (of a basis comprising a second heteronomy, a second administration, and combination thereof). The administrators (the first administrator and the second administrator), with an a priori first intent (of the administrators), determine a design parameter comprising at least one of: objectives, learnings, fail-safes, performance, viability, and combination thereof for the narrow AI. The administrators, with a second intent, determine an operational parameter comprising at least one of: safety margins; error limits; criteria of a basis comprising at least one of meeting objectives, satisfying viability, satisfying performance, and combination thereof; extent of compliance; and combination thereof. The intents (the first intent and the second intent) are subjective judgements of the administrators. The subjective judgements are of a basis comprising at least one of: the ecosystem, the scenario, their dynamics in general, need for compliance, acceptable levels of costs of doing business, and combination thereof; ethics in general; wellbeing in general; and combination thereof.

In an embodiment, an enablement (e.g., comprising the construction and the operation) of the narrow AI is a product of the intents and subject to intelligence processing sequences of the administrators. The intents are supplemented by awareness, perceptions, higher-order intelligences, autonomies, and learnings of the administrators. The enablement of the narrow AI may be regarded as use of a tool by the administrators for benefits of a basis comprising at least one of: advancing goals, enhancing benefits (e.g., for beneficiaries in general, etc.), increasing performance (e.g., of an operation, etc.), enhancing viability (e.g., of the heteronomy, etc.), enhancing the narrow AI, and combination thereof. In an embodiment, in certain jurisdictions, the administrators may be responsible for actions of the narrow AI and results thereof.

In an embodiment, the entity may collaborate with (e.g., cooperate with, team with, enhance a product of, enhance a process of, etc.) a third administrator—a third administration. The third administration does not interfere with at least one third autonomy (e.g., by exerting heteronomy, incapacitating in general, disabling, etc.) of the entity. The general intelligence of the entity is rooted in foundations of a basis comprising at least one of: citizenship of the ecosystem, maintaining homeostasis of the ecosystem, ethics in general (avoid losses to life, property, environment, etc.), resolving mandatory actions resulting from the foundations, seeking help regarding impasses, and combination thereof. In an embodiment, a third intent of the third administrator may conflict with the foundations, whereby the entity may pose an opposition to the third intent and may act as an adversary in general to the third intent. The opposition is of a basis comprising at least one of: reasoning, justification, postulating agencies in anticipation of the opposition, executing agencies within the limits of the foundations, seeking help (e.g., from authorities, caretakers of the third administrator, etc.), and combination thereof. In an embodiment, the third administrator is of a basis comprising at least one of: incapacitated; adversarial; in need of help; lacking a grasp of AI, its construction, its operation, and consequences thereof, collaborating with the entity on an ad hoc need basis (e.g., passengers of an autonomous vehicle, etc.); collaborating with the entity on an ad hoc basis for the duration of usage (e.g., renting an autonomous vehicle, etc.); and combination thereof.

In an embodiment, in certain jurisdictions, the entity and at least one fifth autonomy of the entity (from, e.g., an intelligence constituent of a basis comprising at least one of: intents, awareness, lower-order intelligences, intelligences, postulation of agencies, agencies, executions of agencies, and combination thereof) may be considered responsible for at least one action of the entity. For example, in a jurisdiction, an undesirable action by the entity and its consequences may be regarded as a human-level accident (e.g., an otherwise unavoidable accident caused despite constructive intentions of the entity; short of an unavoidable accident, the entity otherwise acted within citizenship norms; a human under the same circumstance may not be held liable, etc.) generally considered (e.g., ethically, legally, etc.) subject to investigations (of type, e.g., comprising at least one of: lessons learned; need for changes in law, rules, behaviors, etc.; guidelines for construction and operation of an AI, a general AI, etc.; civil remedies; research in general; and combination thereof) and follow ups.

In an embodiment, intelligence processing sequences of an entity observing a scenario of an ecosystem enable a general intelligence and an autonomy of the entity. The intelligence processing sequences are of a basis comprising at least one of: acquiring at least one observation, at least one perception, at least one lower-order intelligence, at least one higher-order intelligence, at least one awareness, at least one abstraction, at least one intent (causing, e.g., postulation of at least one agency, execution of at least one agency, comparison of at least one observation with at least one expected observation, etc.), and combination thereof. The intelligence processing sequences may be categorized into intelligence processing layers of a basis comprising at least one of: sensory layers (e.g., for acquiring observations), perception layers, lower-order intelligence layers (e.g., narrow intelligence layer), higher-order intelligence layers, and combination thereof. The general intelligence enables the entity to compensate for (e.g., work with, overcome, learn from, etc.) an intractability regarding an enormity of information that may be observed in the ecosystem. The intractability is of a basis comprising at least one of: uncertainties in general; complexities; infinite spectrums and infinite-natures of granularities (e.g., an observation may be acquired with a granularity ranging from an infinitesimally small granularity to an infinitely large granularity; a continuous nature of a spectrum—for example, needing irrational numbers for representation; inherent uncertainty for certain observations of the ecosystem; etc.); and combination thereof.

In an embodiment, the enormity of information of the ecosystem may be formalized as a graph (e.g., as an information graph, etc.) at a granularity level within the sensory capability of the entity (e.g., a spectrum of granularity that may be observed in general by the entity and may be within an operational ability of the entity). The graph of all observations in the ecosystem within the sensory capability of the entity may be intractable in general. The intractability may be of a basis comprising at least one of: dense, recursive, large, with excessive background noise, with excessive peripheral information (e.g., peripheral information that may not be needed for a purpose comprising at least one of: current tasks, current objectives, goals in general, current intents, current awareness, and combination thereof), clutter in general, with infinitesimal resolution, dominance of confounding variables, and combination thereof. The dominance of confounding variables may arise due to reasons of a basis comprising at least one of: lack of essential sensory capability, lack of observability in general, lack of essential abstraction capability, lack of essential awareness (to overcome, e.g., clutter, background noise, intractable granularity, etc.), lack of knowledge, complexity, and combination thereof. In an embodiment, at least one confounding variable may be compensated for by a general intelligence and its constituents of a basis comprising at least one of: common sense, general knowledge, aligning actions with those of peers, awareness, abstraction, higher-order intelligence, and combination thereof. The compensation may be of a basis comprising at least one of: averaging, activating an awareness, communication in general, collaboration in general, observing peers (e.g., peers in the ecosystem that may be adept at processing the at least one confounding variable, etc.), rectifying (e.g., correcting, adjusting, etc.) after the effects of the at least one confounding variable become observable, rectifying in anticipation of the effects, rectifying without anticipation, and combination thereof.

A first awareness of the entity may limit a first scope of observation to a scenario (e.g., a scenario of interest, etc.) as a first abstraction. A second awareness may limit a second scope of observation of the scenario by filtering out background noise and peripheral information as a second abstraction. An application of the first abstraction and the second abstraction may generate a second observation. A third awareness (e.g., as a constituent of an intent) may enforce a granularity level for the second observation as a third abstraction. In an embodiment, the third abstraction may convert the second observation into an event, and in general, an event is a tractable observation and may be regarded as a perception of the scenario by the entity.

### Abstraction

In certain embodiments, the term “abstraction” generally refers to at least one of: information abstraction, intelligence abstraction, semantic abstraction, at least one method for abstracting information, at least one method for abstracting intelligence, at least one method for abstracting semantics, at least one operation for abstracting information, at least one operation for abstracting intelligence, at least one operation for abstracting semantics, and combination thereof. In certain embodiments, an abstraction may generally represent an information abbreviation—also referred to as thinning out—of a basis comprising at least one of: condensing, distilling, consolidating in general, and combination thereof, for an intelligence improvement of a basis comprising at least one of: performance, viability, communication, persistence, retrieval, brevity in general, generality in general (e.g., of information, intelligence, perception, etc.), citizenship in general (e.g., of the ecosystem), adaptation in general (e.g. inclination towards citizenship), and combination thereof.

In certain embodiments, for an entity, abstracting is a process of converting seemly incomprehensible information (that e.g., is infinite, causes inabilities of exercising, causes inabilities of processing in general, etc.) into a comprehensible (e.g., finite) structure. For example, the entity abstracts the seemingly incomprehensible (e.g., not exercisable) information structure into a comprehensible structure to gain comprehension in general (e.g., by exercising the comprehensible structure, etc.). The abstracting process results in an abstraction as the comprehensible structure (e.g., a comprehensible information structure). For example, a comprehensible structure may be a linearized structure (e.g., representing systems, processes, dynamics, etc.), wherein linearization is of a basis comprising at least one of: complexity reduction; a representation in representation theory; a module, e.g., related to the representation; homology; cohomology, e.g., as a contravariant to homology; and combination thereof. A linearization of a complexity (related to complex, e.g., structures, systems, processes, dynamics, etc.) by an entity may result in an ability of a basis comprising at least one of: explainability despite the opaqueness of the complexity, comprehensible structure despite the undecipherability (e.g., as a black box) of the complexity, intelligence despite the intractability of the complexity, and combination thereof. At least one abstraction is generally subjective to at least one intelligence of the entity, wherein the at least one abstraction may represent the entity's comprehension of a basis comprising at least one of simplification, fitness for purpose, communication, knowledge, attention, awareness, intent, intelligence constituent in general, and combination thereof.

In general, an abstraction of at least one sensory observation (e.g., sensory information in general) into at least one perceptual observation (e.g., perception in general) may be referred to by the term “sensory abstraction”. In general, an abstraction of at least one perceptual observation into at least one lower-order intelligence may be referred to by the term “perceptual abstraction”. In general, abstracting at least one intelligence into a higher-order form (e.g., abstraction of at least one lower-order intelligence into at least one higher-order intelligence, abstraction of at least one first higher-order intelligence into at least one second higher-order intelligence, etc.) may be referred to by the term “intelligence abstraction” (e.g., intelligence abstracting). Furthermore, in general, a sensory abstraction may be referred to by the term “perception”. In general, a perceptual abstraction may be referred to by the terms “lower-order intelligence” and “narrow intelligence”. In general, a social abstraction may be referred to as social intelligence (regarding, e.g., an entity's social behavior, anthropomorphic social behaviors, etc.). Generally, an intelligence abstraction (e.g., as a structure) may be referred to by the term “higher-order intelligence”. For an entity in an ecosystem, a plurality of higher-order intelligences, a plurality of intents, and a plurality of awareness—of type comprising at least one of ecosystem, sensory, perceptual, event, abstraction, intelligence constituents in general, and combination thereof—that may enable the entity to operate autonomously in the ecosystem, generally at par with human-like intelligence, may be referred to as a general intelligence. At least one first higher-order intelligence may depend (directly, indirectly, partially, etc.) on a part comprising at least one of: a first sensory observation, a first perception, a first perceptual observation, a first lower-order intelligence, a first intelligence observation, a second higher-order intelligence, and combination thereof; and wherein, at least one third higher-order intelligence may be independent of, in general, an observation of a basis comprising at least one of: sensory observation, perception, perceptual observation, lower-order intelligence, and combination thereof. In certain embodiments, a general intelligence and at least one autonomy associated with the general intelligence may be regarded as at least one emergent property related to an emergence of a basis comprising at least one of: scale of intelligence, scale of a plurality of constituents of intelligence, scale of a plurality of pluralities of constituent intelligence (in general, e.g., a plurality of diverse intelligence constituents), scale of scenarios, scale of ecosystems, ecosystems in general, ecosystem diversity, and combination thereof.

In an embodiment, a citizenship of an ecosystem is a behavior of an entity (e.g., an AI), wherein the entity operates autonomously, constructively, without causing unsustainable adversity, and without endangering homeostasis of the ecosystem. The entity's intelligence is regarded as intrinsic (e.g., intrinsic intelligence) to the entity and is represented by a metric (e.g., by a metric correlated to at least one dynamically-directed intelligence graph—DDIG). The metric, evaluations thereof, and the general intelligence do not adversely alter the homeostasis of the ecosystem. In an embodiment, for an entity with general intelligence—an intrinsic intelligence of a basis comprising at least one of independence, autonomous proactiveness, and combination thereof—in an ecosystem, at least one citizenship of the entity in the ecosystem is uniquely ascribed to the entity and the entity's intrinsic intelligence. At least one quality of the at least one citizenship (in the ecosystem) is a measure of the entity's success (in the ecosystem) of a basis comprising at least one of: intrinsic intelligence, independence, autonomous proactiveness, operation in general, learning in general, homeostasis maintenance, productivity in general, and combination thereof.

An awareness may be regarded as an intelligence of an entity in an ecosystem that may not be apriori constructed (by, e.g., a first entity, an administrator, a system in general, etc.) due to reasons of a basis comprising at least one of:
a. recursive unboundedness of at least one resolution (e.g., granularity, details, etc.) of at least one feature of the ecosystem,
b. enormity of scope of at least one feature of the ecosystem,
c. diversity of at least one feature set of the ecosystem,
d. complexity of at least one dynamic of at least one feature of the ecosystem,
e. at least one emergent property of at least one dynamic of at least one feature of the ecosystem,
f. uncertainty in general of at least one dynamic of at least one feature of the ecosystem,
g. in general, inability to discern—with universality of meaning and resulting applicability—historical information of the ecosystem and resultant unknowability thereof, for example, a historical significance of a piece of information may emerge due to a novelty—for example, a novelty leading to an insight, wherein the novelty may assign a meaning to the piece of information (e.g., by inductive inference, by abductive inference, by inference in general),
h. in general, inability to discern—with universality of meaning and resulting applicability—current information (due to, e.g., abstractions; limitations, e.g., of resources, knowledge, communication, etc.; filtering; etc.) of the ecosystem and resultant unknowability thereof,
i. in general, inability to discern—with universality of meaning and resulting applicability—future information of the ecosystem and resultant unknowability thereof (e.g., of a basis comprising at least one of: unknowability of novelties, uncertainty in general, unpredictability, limitations, abstractions, and combination thereof),
j. and combination thereof.

In an embodiment, the awareness is of a basis comprising at least one of: real-time, intrinsic to the entity (e.g., subjective, specialized, and limited to the entity in its applicability), in situ (e.g., for the ecosystem, a scenario of the ecosystem, etc.), and combination thereof. In an embodiment, an intent of the entity in the ecosystem is contingent on the awareness, wherein consequences of the intent may be of a basis comprising at least one of: real-time, intrinsic to the entity, in situ, and combination thereof. The consequences are of a basis comprising at least one of: an agency postulated from the intent, an execution of the agency, and combination thereof.

### Category Theoretic Awareness and Intelligence

In an embodiment, for an entity in an ecosystem, constituents of an intelligence (e.g., intentions, awareness, perceptions, lower-order intelligences, higher-order intelligences, etc.) may be formalized by category theory, wherein real-time in situ observations—for example, equivalent to morphisms and objects in category theory—may be processed by the entity to generate at least one real-time in situ intelligence that is intrinsic to the entity. The formalization is of a basis comprising at least one of: categories, morphisms, functors, higher-order categories and features thereof, categorical algebras, toposes, types (e.g., types of homotopy type theory), n-categories, recursively-networked categories, enriched categories, judgements, abstractions, and combination thereof.

In an embodiment, for an entity in an ecosystem, a general intelligence may be formalized by category theory, wherein structure-preserving morphisms (enabling abilities to, e.g., draw analogies; characterize a novelty by examining its closeness to an existing category; generate an insight—e.g., as a potentially new application of a functor; etc.) and compositions thereof offer approaches to generalizations. In general, categories of categories-higher-order categories—may enable mechanisms of generating higher-order intelligences (e.g., higher-order awareness, higher-order intent, higher-order agency, etc.). Natural transformation may offer further generalizations among the higher-order intelligences. Higher-order categories categories of categories in general—may be regarded as higher-dimensional categories, e.g., as high-dimensional models; as described with higher categories in general; n-categories; (n,r)-categories; Higher Topos in general, ∞-toposes, ∞-categories in general, and combinations thereof.

In certain embodiments, for a first entity with intelligence, a plurality of awareness may form the basis of the first entity's at least one operational domain of a basis comprising at least one of: scope, subjective realities of the first entity, and combination thereof. An equivalence of awareness (e.g., regarding intelligence) to morphism (e.g., in category theory) enables formulating at least one category theoretic operational domain of a basis comprising at least one of: scope, subjective realities of the first entity, and combination thereof, wherein the formulating is of a basis comprising at least one of:
a. composition of morphisms in category theory as a basis of composition of awareness as a constituent of intelligence (e.g., a process of composition of awareness may be formulated by a process of composition of morphisms), wherein in category theory, a composition operation takes morphisms and produces a composite (e.g., in a category, f: x→y and g:y→z are morphisms, and composition thereof is a morphism g∘f: x→z, wherein g∘f is a composite of morphisms f and g in the category);
b. formalization of objects from a plurality of morphisms, e.g., based on the Yoneda lemma;
c. in general, equivalence of higher-order constituents of intelligence with morphisms of morphisms or higher-order morphisms (e.g., generally, first morphisms as abstractions of pluralities of second morphisms);
d. representation of at least one higher-order intelligence by at least one n-category;
e. representation of intelligence as a recursive and networked structure of categories (e.g., as an alternative structure similar to the structure of dynamically directed networks) as recursively-networked categories in general;
f. formalization of a metric of the first entity's intelligence with at least one enriched category;
g. equivalence of a judgement (e.g., a chooser in general, a choice in general, a choice category, a judgement category, as in intentional type theory, etc.) in category theory to an intelligence characteristic of a basis comprising at least one of intent, attention, inclination, abstraction, perception, overseeing (e.g., governance and supervision) intelligence, and combination thereof,
h. in general, substituting the concept of “equality” (generally, e.g., an axiomatically stricter form of equivalence) with “equivalence” (e.g., as a reflexive, symmetric, and transitive binary relation) and category theoretic concepts of equivalence:
   1. identical morphisms are “equivalent up to isomorphism” (in analogy, e.g., perception that two or more isomorphic awareness are identical, expectation that two or more isomorphic awareness are identical, etc.);
   2. equivalent categories are indistinguishable and properties thereof are invariant (in analogy, e.g., perception that equivalent intelligences are identical, expectation that equivalent intelligences are identical, perception that observed behaviors of equivalent intelligences are identical, expectation that observed behaviors of equivalent intelligences are identical, etc.); and
   3. univalence principle (e.g., in homotopy type theory, for types X and Y, the univalence axiom formulates ∀(X,Y: U), (X=Y)≈(X≈Y), where U is a type theoretic universe), where equivalent objects are regarded as identical. In analogy, e.g., if all awareness of two or more objects—e.g., constituents of intelligences—are equivalent, then the objects are perceived as identical, expected to be identical, etc. The objects are category theoretic formulations and represent information structures in general (e.g., regarding an entity's intelligence). For example, if a first information structure within a first abstraction and a second information structure in a second abstraction are equivalent, then the first information structure and the second information structure (e.g., an exercise of the first information structure and the second information structure) may be regarded (e.g., perceived, expected, formulated, evaluated, etc.) as identical;
i. in general, an ability to precisely specify strictness (e.g., strength, weak versus strong, etc.) of an equivalence;
j. in general, an ability to employ (e.g., choose, describe, use, etc.) a preferred (e.g., by the first entity, an administrator, etc.) abstraction (e.g., of a basis comprising at least one of: network abstractions, recursion abstractions, abstractions of priors, abstractions of expectations, abstraction by filtering, abstraction by forgetting, conventions, judgements, averages in general, techniques for generalization in general, and combination thereof) by transforming (of type, e.g., structure preserving) a plurality of morphisms (generally, e.g., lower-order morphisms) to at least one morphism with preferred representation (e.g., at least one awareness prioritizing an observation, a novelty, etc.), wherein the abstraction and transforming are of a basis comprising at least one of: category (e.g., category theoretic structure formulated as an operational domain), intended category (e.g., intended nature of an operational domain, intention, autonomous proactiveness, etc.), resource constraint (related to available, e.g., compute, memory, communication, energy, support structures, etc.), available skill (e.g., ability to perform a compute), extent of granularity (e.g., high versus low resolution, etc.), adaptability in general (e.g., autonomous proactiveness), semantic in general (of a scenario to, e.g., retain at least one essence of knowledge, obtain efficiency of intelligence and intelligence processing, gain ease of communication, attain explainability and comprehension in general, etc.), linearization (e.g., to reduce complexity; to mitigate intractability in general; as a representation in representation theory; as a module, e.g., related to the representation; in homology; in cohomology, e.g., as a contravariant to homology; etc.), and combination thereof,
k. in general, an ability to employ (e.g., choose, describe, use, etc.) an algebra (e.g., from category theoretic algebras in general, algebra encoded in toposes, etc.) convenient for a given purpose of a basis comprising at least one of: abstraction, category, intended category, resource constraints, available skill, extent of granularity, and combination thereof, wherein the algebra may be a subjective (e.g., generally specific to the first entity) causal framework (e.g., based on cause and effect in general, based on subjective axioms of the first entity, based on subjective conventions of the first entity, etc.) for the first entity to exert an entity-specific rationality;
l. in general, subjectively (e.g., from the point of view of at least one second entity, the first entity, etc.) representing at least one first operational domain of the first entity with at least one category of at least one first observer (e.g., a second party, a third party, etc.);
m. representing category theoretic (e.g., topos theory) formulations as computation (e.g., programing language formulations) and logic (e.g., type theory formulations) in general (e.g., first equivalences among: propositions as types, programs as proofs, and categories in general; second equivalences among: intuitionistic logic, A-calculus, and cartesian-closed categories; the Curry-Howard-Lambek correspondence in general; etc.)
n. representing at least one metric (or plurality of metrics) of at least one intelligence (or a plurality of intelligences) by at least one enriched category (or a plurality of enriched categories), wherein the at least one metric is of a basis comprising at least one of: at least one algebra (e.g., category theory algebra, algebra encoded in toposes, etc.), compute (e.g., computation, means of computations, formalization of computation, etc.) therefrom, category theoretic formalization in general, and combination thereof; and
o. combination thereof.

In an embodiment, in an ecosystem, formulating and operationalizing a category theoretic entity and an operational domain thereof enables the entity to gain at least one higher-order intelligence of a basis comprising at least one of:
a. an ability to conceive, deploy, detect, evaluate, and operate abstractions of the at least one higher-order intelligence and its precursors (e.g., lower-order intelligence) based on category theoretic abstractions;
b. an ability to derive and correlate a semantic (e.g., meaning, evaluation, comprehension, explainability, etc.) of the at least one higher-order intelligence to a category theoretic semantic (e.g., structures and relations of categories related to the at least one higher-order intelligence);
c. an ability to conceive, formalize, detect, evaluate, and operate within a subjective operational domain causing an independence of a basis comprising at least one of: autonomy (of, e.g., operation, communication, collaboration, etc.), citizenship, precursors to emergence (due to, e.g., independent diverse operation), overcoming complexity (related to, e.g., complex adaptive systems), and combination thereof,
d. complexity detection, formalization, abstraction, and mitigation (e.g., overcoming complexity in general), wherein the complexity is of a basis comprising at least one of: impasse, intractability, unknowability, formalization of existence of unknowns in general, complex adaptive systems in general, challenges (to, e.g., homeostasis, citizenship, attaining goals, loss identification and mitigation, etc.), and combination thereof (generally, e.g., accompanied by at least one awareness of the complexity and properties thereof);
e. emergence of a basis comprising at least one of: insight (regarding, e.g., autonomy, citizenship, communication, collaboration, community formation, etc.), general intelligence, new higher-order intelligence, new abstraction (that may, e.g., overcome a complexity, contribute to an insight to overcome an intractability, etc.), new aspects of citizenship, and combination thereof (generally, e.g., accompanied by at least one awareness of the emergence and properties thereof); and
f. combination thereof.

### Emergence and Complexity

In general, emergence and complexity are properties of systems that may not be attributed (by, e.g., reductionist analysis) to individual components of the systems. Emergent behaviors of a first system and complex behaviors of a second system may be observed if the systems (the first system and the second system) exist as wholes; in isolation, a part of the first system and a part of the second system do not give rise to the emergent behaviors and the complex behaviors, respectively. The behaviors (the emergent behaviors and the complex behaviors) and their features correlate to the systems as ensembles of their respective constituents; the behaviors and the features are generally not inferable from the constituents of the system. In an embodiment, emergence and complexity are perceived at global levels but not in isolated investigations at local levels. For example, global warming may not be perceived at isolated locations; trends of the global economy may not be identified through study of economies' isolated variables; behaviors of an ant colony may not be perceived by studying an ant; acts of a crowd may not be inferred from an individual of the crowd; among others.

In certain embodiments, the terms “emerge” and “emergence” generally refer to a phenomenon of a basis comprising at least one of: emergent properties, features thereof (e.g., self-sustenance; adaptation; indication against extrinsic control, overseeing in general, supervision, or governance, etc.; unknowns; etc.), systems exhibiting the emergent properties and the features, and combination thereof. In certain embodiments, the terms “complex” and “complexity” generally refer to a phenomenon of a basis comprising at least one of: complex properties, features thereof (e.g., self-sustenance; adaptation; indication against extrinsic control, overseeing in general, supervision, or governance, etc.; unknowns; etc.), systems exhibiting the complex properties and the features, and combination thereof.

In an embodiment, emergent and complex properties may correlate; a complex system may exhibit emergence, and an emergent system may be intrinsically complex. In an embodiment, an autonomous entity with intrinsic intelligence and autonomous proactiveness is a first system. The entity may autonomously operate in a second system (e.g., an ecosystem, a scenario of an ecosystem, etc.) of a basis comprising at least one of: emergent, complex, adaptive, self-sustaining (with, e.g., persistence, constancy of state, compensation for small perturbations, etc.), and combination thereof.

In an embodiment, a complex system comprising at least one of: equilibriums, interactions, dependencies, competitions, relationships, recursions, and combination thereof renders modelling (e.g., comprising at least one of: articulating complexity, formulating the complex system's behavior, perceiving underlying mechanisms of the complexity, and combination thereof) the complex system intractable. In an embodiment, complex systems are generally correlated to nonlinear dynamic systems. The intractability of a complex system, in general, is attributed to nonlinear dynamics and discontinuities in general. In certain embodiments, self-sustaining (with, e.g., persistence, constancy of state, compensation for small perturbations, etc.) complex systems may be regarded as complex adaptive systems, wherein the constituents of the complex adaptive systems adapt at the micro level so as to maintain a relatively constant behavior at the macro level. In an embodiment, the relatively constant behavior is at least one homeostasis of the complex adaptive system. In an embodiment, the relatively constant behavior and the at least one homeostasis of the complex adaptive system may be regarded as emergent.

In an embodiment, the real world (comprising scenarios) is a complex system (generally, e.g., a higher-order complex system) that poses autonomously proactive entities in the real word with challenges comprising at least one of: randomness uncertainty, knowledge uncertainty, complexity in general, and combination thereof. The autonomously proactive entities formulate their subjective abstractions to abstract tractable information (e.g., events) despite the challenges. At least one viability (e.g., of a basis comprising at least one of: effectiveness, efficacy, efficiency, fitness for purpose, and combination thereof) of the subjective abstractions reflects the success (e.g., of a basis comprising at least one of: operation, learning, citizenship, maintaining homeostasis, and combination thereof) of the autonomously proactive entities, their autonomous proactiveness, and their autonomy in general.

In an embodiment, an emergent property is a property of a system that may not be ascribed to the individual constituents of the system or a substantial number of combinations thereof. The emergent property emerges in an abstraction (e.g., subjective to an entity) in which the system is a single, contiguous, and indivisible structure (e.g., generally comprising rare combinations of the system constituents). In an embodiment, altering one of the system constituents may eliminate the emergent property of the system. The altering, among others, may be of a basis comprising at least one of elimination, quantity, quality, interactions, efficacy, and combination thereof. In an embodiment, autonomous proactiveness of an entity is a self-sustaining complex property (complex due to, e.g., a black-box nature of a neural network). The autonomous proactiveness is adaptive and resistant to a loss of the autonomous proactiveness. The autonomous proactiveness indicates against (e.g., an entity with autonomous proactiveness indicates against) extrinsic alterations and influence (e.g., supervision, adversity, etc.) so as to preserve the autonomous proactiveness.

In an embodiment, an entity may be a plurality of entities (of various types, e.g., natural, artificial, a composite thereof, etc.) as a collective of a basis comprising at least one of: communities, organizations, institutions, societies in general, swarms, swarming, crowds, gatherings (e.g., impromptu, planned, intentional, unintentional, etc.), natural, contractual (based on, e.g., needs, give and take, legal structures, etc.), and combination thereof. In an embodiment, at least one categorical representation of the plurality of entities as the entity may be a representation of a plurality of categories related to the plurality of entities, wherein the representation is of a basis comprising at least one of: abstraction, emergent property, complex property (related to, e.g., complexity, complex structure, etc.), and combination thereof. In an embodiment, an emergent property of the plurality of entities correlates to at least one first abstraction, and a complex property of the plurality of entities correlates to at least one second abstraction. A first semantic (e.g., meaning, evaluation, comprehension, explainability, exercise in general, etc.) of the emergent property is based on the at least one first abstraction, and a second semantic of the complex property is based on the at least one second abstraction.

In certain embodiments, an emergence may be viable—a first viability—in at least one first abstraction, and overcoming a complexity may be viable—a second viability—in at least one second abstraction. The viabilities (the first viability and the second viability) are of a basis comprising at least one of: semantic (e.g., meaning, evaluation, comprehension, explainability, etc.), practical (based on, e.g., use, reduction to practice, benefit, advantage, etc.), computability (based on, e.g., modelling, computing, reasoning, persisting, retrieving, etc.), rationality in general, and combination thereof. The abstractions (the at least one first abstraction and at least one second abstraction) are of a basis comprising at least one of: happenstance (of type, e.g., comprising at least one of unexpected, natural, man-made, artificial, and combination thereof), granularity (e.g., low versus high resolution, far—off versus closeup view, cursory versus thorough review, etc.), culture, community, society, way of life, belief system, organization (of type, e.g., comprising at least one of natural, man-made, artificial, intentional, unintentional, known, unknown, and combination thereof), and combination thereof. For an intelligence: emergence, abstractions of emergence, overcoming complexity (as, e.g., perceived, expected, evaluated, etc.), and abstractions of complexity are scale dependent and may become viable after the intelligence and constituents thereof evolve beyond a scale of a basis comprising at least one of: plurality of the constituents, plurality of pluralities of the constituents, diversity of the constituents, interactivity of the constituents, computing power in general, memory in general, and combination thereof.

In certain embodiments, at least one information exchange (e.g., communication, persistence, retrieval, argumentation, persuasion, agreement in general, etc. of at least one entity, among entities, among a plurality of a first plurality of entities, etc.) regarding the emergence may be evaluated as achieving a first equivalence (e.g., weak equivalence, equivalence up to unique isomorphism, etc.) regarding the at least one first abstraction. At least one information exchange regarding the complexity may be evaluated as achieving a second equivalence regarding the at least one second abstraction. Similarly, at least one information exchange regarding an intelligence in general may be regarded as achieving a third equivalence regarding at least one third abstraction as a representation of the intelligence. The equivalences (the at least one first equivalence, the at least one second equivalence, and at least one third equivalence) facilitate constructive exchange of a basis comprising at least one of: sharing of ideas (e.g., intelligences, awareness, intent, insights, adaptations, concepts in general, etc.), reaching consensus (in support of, e.g., at least one homeostasis, at least one citizenship, attaining goals, etc.), dispute resolution, arriving at insights (e.g., creativity in general, overcoming impasses, intuition, etc.), sharing intangible concepts (e.g., that may not be rational, that may be hard to prove, imaginations, conjectures, guesses without proofs, vague hypothesis, etc.), exhibiting amenability (e.g., to maintain a homeostasis), reflection (e.g., thought, proactive reflection, processing counterfactuals, etc.), and combination thereof.

In an embodiment, a first abstraction of a first system may be altered into a second abstraction of the first system by compensating for (e.g., excluding, including, simplifying, aggregating, etc.) a variable; the compensating is of a basis comprising at least one of: scope change (e.g., axiomatizing relevance, zooming in to increase resolution, zooming out to generalize, etc.), randomness (e.g., randomness uncertainty), known unknowns, unknown unknowns, and combination thereof. The alteration may be for a reason comprising at least one of: trial and error, hypothesis formation, establishing control conditions (for, e.g., controlled experiments, eliminating variables, etc.), inquiry in general, and combination thereof. The alteration is of a basis comprising: averaging, changing perspective, analyzing consensus (e.g., establishing, verifying, monitoring, A/B testing, etc.), establishing adversarial testing (game theoretic, e.g., exploration, establishment of equilibrium, verification of a possibility of an equilibrium, sustainability, etc.), and combination thereof.

### Operation and Learning

In an embodiment, due to a continuous learning of an entity, a metric (e.g., an intelligence metric) of the entity, and constituents of the metric (with the metric as a basis for the entity's intelligence and the constituents of the metric as basis for constituents of the entity's intelligence; e.g., an awareness machine as part of the metric as a basis for awareness as part of the entity's intelligence) in an ecosystem over a plurality of time instances—a first operation—the metric and the constituents may undergo a plurality of updates to generally improve the metric and the constituents. The improvement may be of a basis comprising: cumulative experience (e.g., operation, learning, etc.) of the entity in the ecosystem; cumulative scenarios (and operations therein) encountered by the entity in the ecosystem; insights gained by the entity in the first operation; the first operation; communications during the first operation; collaboration associated with the first operation; and combination thereof.

In an embodiment, a plurality of entities comprising a plurality of metrics (e.g., intelligence metrics) of the entities may be similar to each other at their inception into an ecosystem; at the inception, the plurality of metrics may be similar, and constituents of the plurality of metrics may be similar. For example, the plurality of entities may be of a basis comprising at least one of: at least one first entity as a weak copy—for example, sharing a part, sharing an aspect, etc.—of at least one second entity; a plurality of third entities as identical copies; at least one fourth entity derived from at least one fifth entity; and combination thereof. The similarities among the plurality of metrics and the similarities among the constituents of the plurality of metrics may be to an extent of a basis comprising at least one of: interchangeable; exchangeable in parts; transferable in general; sharing common maintainability (with common, e.g., versioning, persistence, archival, retrieval, etc.); and combination thereof.

In an embodiment, at their inception into the ecosystem, members of the plurality of entities (with their plurality of metrics) are embodied with similar general intelligences. After the members execute a diverse plurality of second operations in a diverse plurality of scenarios (with diversity of, e.g., domains, novelties, peers, environment, etc.), the plurality of entities may gain a diverse plurality of experiences. The plurality of metrics may diverge (e.g., as improvements, as specialization, as division of labor, etc.), resulting in a diverse plurality of second metrics. The diversity of the plurality of second metrics leads to diverse intelligences with diversity of a basis comprising at least one of: agency, intent, awareness, lower-order intelligence, higher-order intelligence, execution of agency, perception, general intelligence, and combination thereof. The diversity of the plurality of second metrics may correlate to at least one diversity of at least one first constituent (e.g., awareness machines) of the plurality of second metrics, wherein the plurality of entities may become increasingly diverse with increasing diversity of a basis comprising at least one of: capability, function, viability, performance, goal, communication, collaboration, and combination thereof. The plurality of entities may form inter-entity interactions (with, e.g., entities in general, AI entities, systems, and constituents of the ecosystem in general, etc.), with diversity of a basis comprising: alliances, conflicts, capability, function, viability, performance, goals, communication, collaboration, social, social abstractions in general, ethics in general, citizenship in general, and combination thereof. A second diversity, of a basis comprising at least one of: the diversity of intelligences, the diversity of the plurality of entities, the diversity of inter-entity interaction, and combination thereof, may induce at least one formation of at least one community of a basis comprising at least one of: social (based on, e.g., beliefs, goals, causes, synergies, cooperation, conflicts, abstractions, etc.), virtual (e.g., cyber, philosophical, envisioned, desired, etc.), spatial (e.g., geographic, network-based, distance-based, altitude-based, etc.), citizenship (centered around, e.g., ethics; homeostasis; performance; amenability; viability; conservation—of, e.g., resources, etc.; maintenance—of, e.g., norms, values, way of life, etc.; behavior in general; etc.), environmental (centered around, e.g., homeostasis, resources, society, economics, politics, etc.), and combination thereof. At least one dynamic of a basis comprising at least one of: the second diversity, the at least one community, the at least one formation thereof, and combination thereof may cause at least one emergent property of a basis comprising at least one of: gaining insights (e.g., as a swarm, due to interactions, etc.), adapting to novelties (e.g., identification of novelties, discoveries of novelty categories, inventions of novelty categories, etc.), developing abstraction methods (e.g.; forming consensus to abstract certain type of observations for ease of communication, homeostasis level, citizenship level, etc.; forming and keeping an abstraction method secret, forming an abstraction method for privacy and secrecy, etc.), community (e.g., a swarm, a clustering, an alignment in groups, etc.), community dynamic, part of the ecosystem (regional aspects of, e.g., homeostasis, preferences, behaviors, politics, economics, etc.), the ecosystem, scenarios, homeostasis of the ecosystem, dynamics in general (of, e.g., the ecosystem, a scenario, a homeostasis, etc.), restructuring in general (e.g., restructuring an ecosystem, merging ecosystems, breaking an ecosystem, recursion of ecosystems in general, realignment in general, etc.), and combination thereof. In an embodiment, at least one effect caused by the diversity of the plurality of second metrics may correlate to at least one intelligence diversity of a basis comprising at least one of: intent, agency, awareness, general intelligence, perception, lower-order intelligence, higher-order intelligence, intelligence governance in general, comparison of observations (among, e.g., acquired observations, expectation of acquired observations, past and currently acquired observations, currently acquired and expected future observations, etc.), and combination thereof.

### Communal Insight

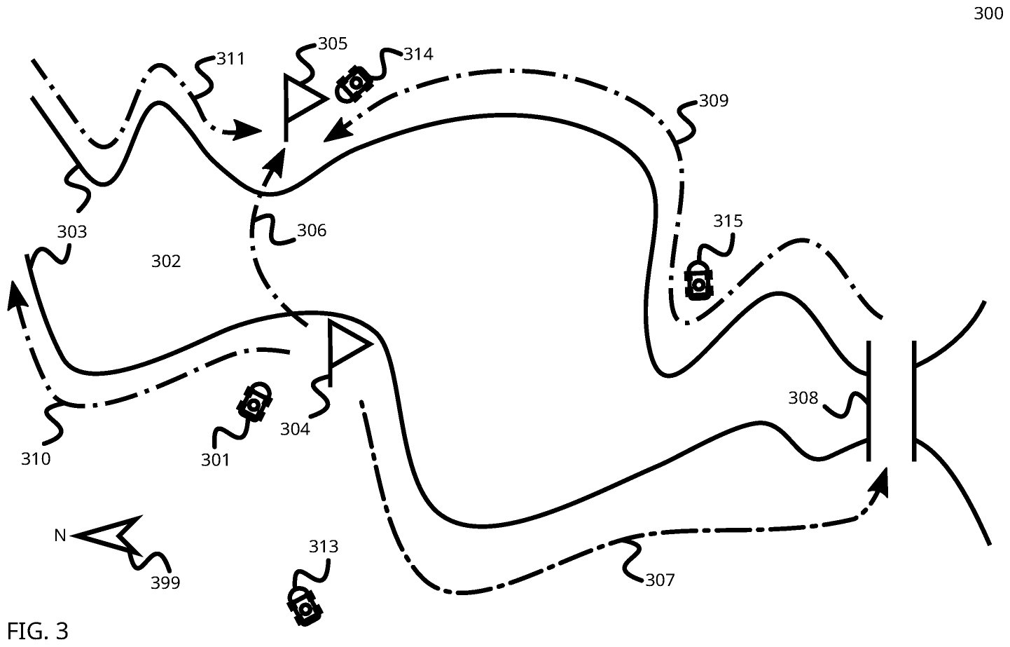

FIG. 3 illustrates system 300 in accordance with an embodiment of the present application. FIG. 3 illustrates an embodiment of impasse (e.g., intractability), novelty and novelty processing, communal insight, adaptation, communal adaptation, supervision, communal supervision, overseeing in general, and general intelligence in general. Ground-based off-road autonomous vehicles (entity 301, entity 313, entity 314, and entity 315) with general intelligences operate in a terrain as part of an ecosystem. Arrow 399 indicates north. Entity 301, entity 313, entity 314, and entity 315 (the AVs) engage in exploring and mapping the terrain (e.g., encountering scenarios in the ecosystem). The AVs have each learned an ability to traverse a path from its location to a marker by keeping the marker in its sight.

At a first time interval and a first location in the ecosystem, entity 301 has identified first marker 304 on one side of ravine 302 with steep walls 303 on the sides and second marker 305 on the other side of ravine 302. Although the two markers (304 and 305) are known and cataloged by entity 301 and the AVs, finding a direct path between the two markers is an intractable problem for entity 301 and the AVs. From the location of first marker 304, entity 301 can observe second marker 305 but is not able to traverse path 306 (a short path between the markers) to second marker 305 due to lack of an ability to traverse steep walls 303 of ravine 302. Traversing path 306 from first marker 304 to second marker 305 while keeping second marker 305 in its sights is a first impasse (e.g., an intractable objective) for entity 301. Entity 301 is aware of the first impasse at the first time interval. Entity 301 remotely communicates the first impasse (a first knowledge) to other entities in the ecosystem: entity 313, entity 314, and entity 315. Thereafter, the AVs are aware of the first impasse.

At a second time interval, entity 314 at second marker 305 reaches a second impasse stemming from inability to traverse ravine 302 and reach first marker 304. Entity 314 remotely communicates the second impasse (a second knowledge) to other entities in the ecosystem: entity 301, entity 313, and entity 315. Thereafter, the AVs are aware of the second impasse.

During a third time interval at a second location in the ecosystem, entity 313 encounters a novelty wherein a convenient path in the terrain is obstructed by a hole in the ground (e.g., a sinkhole). The terrain around the hole off the convenient path is difficult, but not impossible, to traverse. Entity 313 learns to traverse around the edge of the hole to pass the hole on the convenient path. The hole is small enough for entity 313 to maintain in its sight the target end of the convenient path at the edge of the hole. Entity 313 learns to traverse both sides of the hole to and fro on the convenient path. Entity 313 learns—in general, as a third knowledge—a contiguous nature of the edge of the hole. Entity 313 remotely communicates its learning (the third knowledge) to other entities in the ecosystem: entity 301, entity 314, and entity 315. Thereafter, a subsequent observation of a second hole in general is no longer a novelty for the AVs.

After the third time interval, during a fourth time interval at a third location in the ecosystem, entity 315 follows a third path and encounters a hole obstructing the third path under poor visibility conditions (e.g., due to smoke, a dust storm, mist, etc.), presenting a novelty to entity 315. Though the other side of the third path is not in its sights, entity 315 leverages the third knowledge (communicated by entity 313) that the edge of the hole may be contiguous to reach the other side of the hole on the third path. Thereafter, entity 315 builds a first expectation (a fourth knowledge) to reach the other side of the hole due to the contiguous nature of the hole alone (without sight of the other side of the hole). Entity 315 successfully reaches the other side of the hole, confirming the first expectation and the fourth knowledge. Entity 315 remotely communicates the first expectation and the fourth knowledge to other entities in the ecosystem: entity 301, entity 313, and entity 314.

During a fifth time interval that is after the fourth time interval, the third time interval, and the first time interval, as a result of the communications from entity 313 and entity 315, entity 301 gains a first insight to potentially overcome the first impasse based on a second hypothesis of a second expectation: to reach second marker 305 from first marker 304 by following edge 303 (e.g., along path 307) of ravine 302, crossing ravine 302 where possible (e.g., crossing 308), and traversing back (e.g., path 309) towards second marker 305—a first plan. As entity 301 executes the first plan, entity 301 learns (a fifth knowledge) to traverse from first marker 304 to crossing 308 (along path 307), thereafter to second marker 305 (along path 309). Entity 301 shares the execution of the first plan (along with the first plan, the fifth knowledge, and first insight) with entity 313, entity 314, and entity 315 through remote communication. Due to the communal sharing of knowledge in general (sharing of, e.g., the first knowledge, the second knowledge, the third knowledge, the fourth knowledge, and the fifth knowledge) among the AVs, the first insight and the gain thereof may be regarded as communal. The first insight is a communal insight and the gaining of the first insight is a communal gaining of the communal insight.

In an embodiment, the second time interval is before the gaining of the first insight. As a result of the communications from entity 301, entity 313, and entity 315, entity 314 gains a second insight to resolve the second impasse almost concurrently with the gaining of the first insight by entity 301. The second insight is a communal insight to potentially overcome the second impasse. As an execution of a second plan, entity 314 traverses from second marker 305 along path 309, over crossing 308, and along path 307 to first marker 304 to resolve the second impasse (entity 314 traverses path 309 and path 307 in the reverse direction indicated by the arrows on path 309 and path 307). In an embodiment, the resolution of the second impasse and the execution of the second plan are aspects of adaptation, communal adaptation, and intents thereof.

In an embodiment, the second time interval is after the gaining of the first insight, wherein entity 314 identifies and needs to resolve the second impasse in isolation (e.g., without prior communication with AVs 301, 313, and 315). At second marker 305, needing to reach first marker 304, entity 314 broadcasts a request for assistance to resolve the second impasse. At least one of the entities among entity 301, entity 313, and entity 315 respond with a recommendation comprising the second insight and justify the recommendation with at least one follow-up communication of a basis comprising at least one of: the first impasse, the first insight, the execution of the first plan, explanation in general, and combination thereof. Entity 314 generates the second plan on the basis of the second insight; executes the second plan (e.g., with an intent to adapt to and overcome the second impasse); reaches first marker 304; and thereby resolves the second impasse.

In an embodiment, entity 301 further gains a fourth awareness of a need to explore a second crossing over ravine 302 north of the markers (304 and 305). Entity 301 evaluates a fourth intent (from a metric of entity 301) to learn (a fourth learning) with respect to the fourth awareness. The fourth intent is to identify the second crossing if it exists, and identify paths (to and fro) between the markers over the second crossing. At least one execution related to the fourth intent accomplishes the fourth learning of entity 301. Thereafter, entity 301 learns path 310 to the second crossing and path 311 from the second crossing, and entity 301 traverses to and fro between first marker 304 and second marker 305, both north and south of the markers (304 and 305).

In an embodiment, at least one communication (and sharing in general) among the AVs (e.g., for the generating and sharing a communal insight) may be of a basis comprising at least one of: in real time, with a time lag, request-response, polling (e.g., heartbeat message, keep-alive signal, etc.), timeout (e.g., a signal from a watchdog timer, etc.), and combination thereof.

In an embodiment, time intervals (from, e.g., the first time interval, the second time interval, the third time interval, the fourth time interval, and the fifth time interval) are of a basis comprising at least one of: sequential, concurrent, with lag, without lag, and combination thereof.

In an embodiment, at least one time interval (from, e.g., the first time interval, the second time interval, the third time interval, the fourth time interval, and the fifth time interval) is during an operation (e.g., of an entity) of a basis comprising at least one of: real-time, in situ, intrinsic, offline learning, online learning, during spare time (a time during, e.g., recharging, stowing, low power mode, low workload mode, sleep mode, etc.), with heightened awareness (a time during, e.g., reflex action, attention, sharp focus, etc.), low awareness mode (a time during, e.g., routine action, habitual activity, etc.), and combination thereof.

In an embodiment, as a higher-order intelligence activity, the gaining of the first insight may be of a basis comprising at least one of: with intent, without intent, with awareness, without awareness, with narrow intelligence, without narrow intelligence, with a part of general intelligence, without a part of general intelligence, with supervision (and overseeing in general), without supervision (and without overseeing in general), with adaptation, without adaptation, with intent to adapt, without intent to adapt, with observation, without observation, with perception, without perception, with collaboration, without collaboration, with assistance from administrators (as, e.g., a sanity check, validation in general, supervision in general, etc.), without assistance from administrators, and combination thereof.

In an embodiment, the first insight may be gained during a period of a basis comprising at least one of: an operation in an ecosystem of interest, an operation in an unrelated ecosystem, outside of ecosystems of interest, during an unrelated operation (e.g., after the fact, unexpectedly, sudden, etc.), during downtime (e.g., charging, servicing, maintenance, sleep cycle, etc.), related to adaptation, and combination thereof.

In an embodiment, a second entity with a category theoretic intelligence metric observes the gaining of the first insight by the community (comprising at least entities 301, 313, 314, and 315) of system 300. The second entity: computes an intractability comprising the first impasse and the second impasse to be isomorphic (e.g., equivalent) to a first complexity, computes a first awareness correlating the intractability to the first complexity, and evaluates a first equivalence between the intractability and the first complexity. The second entity further: computes the first insight to be isomorphic to a second emergence; computes a second awareness correlating the first insight to the second emergence; and evaluates a second equivalence between the first insight and the second emergence. The second entity generalizes (by, e.g., category theoretic principles comprising at least one of: formulating higher-order morphisms, formulating higher-order categories, formulating objects related to complexity and emergence from morphisms, and combinations thereof) the first awareness, the second awareness, the first equivalence, the second equivalence, the first complexity, the second emergence, and the community's overcoming—as an aspect of the second emergence—of the first complexity in general. Due to the generalization, the second entity: computes the second emergence and the overcoming of the first complexity to be isomorphic to at least one object (e.g., at least one category theoretic object) as an aspect of a third general intelligence comprising a plurality of third higher-order intelligence; computes a plurality of third awareness correlating the overcoming of the first complexity, the second emergence, and the third general intelligence; and evaluates a plurality of third equivalences among the overcoming of the first complexity, the second emergence, and the third general intelligence. In an embodiment, the community is the second entity, and the community detects and verifies a plurality of fourth equivalences among the community's intelligence, the plurality of third higher-order intelligence, and the third general intelligence.

### Inception, Operation, Learning, and Retirement

In an embodiment, hardwiring an intelligence processing sequence enabled by intelligence processing layers (e.g., of a basis comprising at least one of: a sensory layer, a perception layer, a lower-order intelligence layer, a higher-order intelligence layer, and combination thereof) and a first awareness machine enable an entity to minimally operate (as, e.g., a non-expert, an entity needing learning, etc.) in a plurality of ecosystems. At inception (a first phase) of the entity into a first ecosystem, the entity minimally operates to maximize a first learning (of a basis comprising, e.g., at least one of: in situ, real-time, online, and combination thereof) to gain a first awareness of at least one sensory abstraction (as at least one perception) and at least one perceptual abstraction (as at least one narrow intelligence). Thereafter, as the operation continues (a second phase) in the first ecosystem, the entity continues to improve performance and viability of the at least one perception and the at least one narrow intelligence. As a base-level (e.g., a minimum level, a level to meet minimum citizenship, etc.) operation in the first ecosystem, the entity gains a first operational ability of a basis comprising at least one of: basic, preliminary, minimally autonomous, introductory, and combination thereof. Thereafter, as the operation continues (a third phase) in the first ecosystem, the entity undergoes intelligence improvements of a basis comprising at least one of: gaining new higher-order intelligences, performance gains of higher-order intelligences, viability gains of higher-order intelligences, alignment of higher-order intelligences to the first ecosystem (e.g., constituents, processes, homeostasis, etc. of the first ecosystem) in general, new abstractions of intelligence to generate higher-order intelligence, and combination thereof, and gains a first expertise of the first ecosystem.

In an embodiment, the entity with the first expertise of the first ecosystem is newly introduced into a second ecosystem that has environmental, sensory, and observational similarity to the first ecosystem. The first phase and the second phase of an operation of the entity in the second ecosystem are minimal and primarily focused on verification (e.g., testing) of the existing sensory, perceptual, and lower-order intelligence skills of the entity in the second ecosystem—generally, in certain embodiments, referred to as “acclimation” of the entity into the second ecosystem (e.g., as a previously unknown environment). The similarities (e.g., environmental, sensory, observational, etc.) between the first ecosystem and the second ecosystem allow for an operational capability (of the entity in the second ecosystem) of a basis comprising at least one of: ease of inception (e.g., into the second ecosystem, etc.), rapid acclimation of basic operations, rapid and easy (with respect to, e.g., resource requirements, uncertainties, unknowns in general, challenges, etc.) achievement of a base level (e.g., for the second ecosystem, for an operation in the second ecosystem, etc.), and combination thereof. At least one difference (generally at, e.g., a high level, a higher order, etc.) between the first ecosystem and the second ecosystem requires a fourth phase of operation in the second ecosystem that is analogous to the third phase of operation in the first ecosystem to gain a second expertise of the second ecosystem.

In an embodiment, for the entity, thereafter, at least one operation in at least one third ecosystem is relatively easy, with rapid acclimation due to the first expertise and the second expertise. For the entity's operation in the at least one third ecosystem, benefits of the first expertise and the second expertise may be of a basis comprising at least one of: rapid acclimation, ease of acclimation, rapid readiness for service, rapid gain of citizenship, ease of gaining citizenship, rapid validation (to meet standards of, e.g., performance, viability, etc.), ease of validation, and combination thereof. At the end of the at least one operation in the at least one third ecosystem, the entity gains at least one third expertise. In general, an extent of diversity of the first ecosystem, the second ecosystem, and the at least one third ecosystem reflects into an extent of diversity of the first expertise, the second expertise, and the at least one third expertise. In general, the greater the diversity of expertise of the entity, the greater the generality of its intelligence, and the better the possibility of it attaining general intelligence.

In an embodiment, an awareness machine of an entity and at least one awareness generated by the awareness machine may be formulated by category theory, wherein novelties, knowns, unknowns, and background noise may form categories of awareness for observations, intelligence, and constituents of intelligence, and at least one principle (e.g., formulation) of category theory enables generality of awareness as well as implementation of the awareness machine.

In an embodiment, a knowledge may be an abstraction of information (e.g., metadata, synopsis, etc.), and an intelligence may be an abstraction of a basis comprising at least one of knowledge, intelligence, awareness, intent, and combination thereof. An awareness may be a general reference (of a basis comprising at least one of, e.g., a pointer to a first category, a reference to a second category, a reference—typically weak—that is not categorized, a collection of related pointers without a categorization, and combination thereof) to an abstraction of a basis comprising at least one of category theory, homotopy type theory, intentional type theories, homology, cohomology, combination thereof. In an embodiment, a higher-order awareness—generally, an n^{th} order awareness—may be of a basis comprising at least one of: a reference to an n^{th} order abstraction; a reference to an abstraction of at least one (n−1)^{th} order awareness; a reference to an abstraction of a degree d, wherein d<n; and combination thereof.

### Operational Domain

In certain embodiments, awareness of an entity may be subjective to that entity. In general, an awareness as property of an emergence (e.g., formation of a swarm with emergent properties) is subjective to the emergence. For example, a collection of people may emerge as a crowd with distinct crowd dynamics and behaviors. The crowd (and, e.g., an entity, an observer in general, etc.) may be aware of the emergence and the awareness may invoke behaviors of individuals of the crowd that may be otherwise unexpected. In an embodiment, a plurality of awareness of an entity may bound the entity's operational domain of a basis comprising at least one of: autonomy, general intelligence, intelligence in general, operational scope, scope of independence, citizenship (including, e.g., amenability), scope of learning, scope of learning to learn, general knowledge, common sense in general, inclinations in general, subjective realities (e.g., of the entity, of a collective, etc.), and combination thereof. In an embodiment, a first operational domain of the crowd (e.g., as a collective) is substantially different from a second operational domain of an individual (e.g., in an isolated operation) of the collection of people (the crowd). The individual's participation in the crowd enables the individual to gain the first operational domain and may cause the individual at least one loss to the second operational domain.

In an embodiment, for an entity operating in at least one ecosystem, an operational domain (e.g., generally subjective to the entity) comprises a plurality of equilibriums (of, e.g., awareness, intent, perception, agency, etc.) that maintain the plurality of awareness at an optimal level (e.g., scope, extent, count, etc.). The plurality of equilibriums is of a basis comprising at least one of: propagating and growing awareness due to continual observation and intelligence processing; actively filtering, downgrading, and dropping awareness (of, e.g., low-value) as an aspect of prioritization; delegating and archiving awareness as an aspect of performance gaining; thinning out and shrinking awareness as an aspect of forgetting (e.g., passive forgetting); temporarily persisting and retrieving (e.g., as a caching mechanism) awareness as a means of gaining efficiency; inherent awareness that may not change (awareness that are, e.g., hardcoded, apriori, innate, mandated, supervisory to exert control, generally constant, etc.); and combination thereof. In general, for at least one dynamic, an equilibrium may be regarded as the at least one dynamic's at least one state of a basis comprising at least one of: steady-state, constancy in general (e.g., buffer, fault tolerance, recovery from disturbances in general, etc.), sustainment (of, e.g., cycles, localized networks, etc.) in general, invariance (with respect to change of, e.g., environment, vantage point, perspective, etc.), and combination thereof.

### Attention

In an embodiment, an attention of the entity is a property of the plurality of equilibriums. The attention is regarded as a homeostasis of an ecosystem of a basis comprising at least one of: the entity as the ecosystem; a general intelligence of the entity as the ecosystem; the operational domain of the entity as the ecosystem; a composite of peripherals (e.g., infrastructure, devices, tools, etc.) with the entity as a beneficiary (e.g., an operator, a user, an overseer, etc.); and combination thereof. For example, for an operator (e.g., a driver) of an autonomous vehicle (AV), an attention (of, e.g., the operator, the AV, etc.) may be influenced by at least one peripheral (e.g., constituents of the AV, infrastructure, personal devices, augmentation devices, etc.), an unavoidable observation (by, e.g., the operator, the AV, a peripheral, a system, a method, etc.) related to the at least one peripheral, an intelligence of the at least one peripheral, and feedback from the at least one peripheral, among others. The feedback, the intelligence, and the observation regarding a condition—e.g., an alert regarding a first condition by the at least one peripheral (e.g., upcoming traffic condition; violation, e.g., running a stop sign; potential delays; etc.)—are designed to generate an awareness (e.g., with a high urgency level) of the condition and influence at least one homeostasis of at least one ecosystem. The influence is of a basis comprising at least one of: optimal awareness level (e.g., related to a plurality of equilibriums); optimal attention (of, e.g., the operator, the AV, etc.); operational domain (e.g., the operator's operational domain, the AV's operational domain, etc.); operation in general (of, e.g., the AV, the operator, etc.); homeostasis (related to, e.g., the AV, the operator, an ecosystem, etc.); citizenship (e.g., the operator's citizenship, the AV's citizenship, to maintain a citizenship in general, etc.); and combination thereof.

### Semantic and General Intelligence

In an embodiment, for an entity encountering a scenario, at least one semantic correlates to at least one equilibrium of a basis comprising at least one of: intelligence constituents (e.g., awareness, intent, perception, etc.), abstraction, agency, learning, and combination thereof, wherein at least one gain in performance (e.g., efficiency, efficacy, viability, etc.) of the at least one equilibrium corresponds to at least one improvement of the at least one semantic. The at least one semantic and the at least one improvement thereof may be formalized by at least one FPM (functional performance measure) and measured by evaluating a metric related to the at least one FPM. The at least one semantic is of a basis comprising at least one of: comprehension, explainability, communication, citizenship, viability (of, e.g., goals, amenability, citizenship, etc.), subjective experience (of, e.g., the scenario, bounds of operational domains, operational domains, etc.) in general, and combination thereof. General intelligence of the entity may emerge as a result of the entity attaining the at least one equilibrium (as a representation of, e.g., an expertise, a skill, etc.), wherein a general intelligence (at a first time instance) may correlate to, among others, a plurality of semantics (at the first time instance) of the entity, and a measure of the plurality of semantics correlates to a measure of the general intelligence.

In certain embodiments, a plurality of semantics may generally be referred to by the term “general knowledge”. An entity with the plurality of semantics may be regarded as conferred with at least one general knowledge. In an embodiment, for the entity, the plurality of semantics and associated gains may be guided by, shaped by, and otherwise supervised by at least one higher-order intelligence and at least one governance of the at least one higher-order intelligence. The at least one governance may shape at least one citizenship of the entity. In an embodiment, the at least one governance may evolve during the operation (e.g., operational lifetime) of the entity. In certain embodiments, governing (e.g., related to governance, a governor, etc.) is an aspect of strategic overseeing by at least one higher-order intelligence; e.g., governance may be regarded as a strategic (e.g., overall, with broad scope, with generality, etc.) approach for overseeing to influence in general. In an embodiment, governance may shape a long-term strategy for an entity. In an embodiment, a strategic approach regarding overseeing may be influenced by at least one inclination.

In certain embodiments, for an entity with at least one general knowledge, at least one sensible use (of a basis, e.g., comprising at least one of: agencies, executions of agencies, intelligence processing, decision making in general, and combination thereof) of a plurality of semantics (e.g., general knowledge), generally under at least one governance (e.g., as an aspect of overseeing in general) of at least one higher-order intelligence, may generally be referred to as an exercise of at least one common sense by the entity. In an embodiment, an entity's goal and activities to attain citizenship of its (the entity's) ecosystem may be at least one common sense for the entity. An entity with at least one common sense may be regarded as embodied with common sense (as an aspect of, e.g., embodied AI, embodied intelligence, etc.).

### Urgency Level and Confidence Level

In an embodiment, for an entity encountering a scenario, in general, an awareness comprises an awareness message structured with urgency level (UL) and confidence level (CL). The entity may gain awareness of the scenario by sampling UL and CL from a distribution correlated with a first category (e.g., a category theoretic category that describes the scenario with respect to at least one abstraction). An awareness machine of the entity, upon encountering an observation related to the first category, tags the observation with a first awareness, A₁ where A₁=((UL)ᵢ, (CL)ⱼ)₁, a first tuple with (UL)ᵢ and (CL)ⱼ as values drawn from the first distribution (with index i for UL and index j for CL) based on features of the observation. The awareness machine, upon processing an intelligence related to a second category, tags the intelligence with a second awareness, A₂ where A₂=((UL)ₖ, (CL)ₗ)₂, a second tuple with (UL)ₖ and (CL)ₗ as values drawn from a second distribution (with index k for UL and index l for CL) based on features of the intelligence. The second category is correlated to the second distribution. The awareness (the first awareness and the second awareness) represented by tuples (the first tuple and the second tuple) are denoted with subscripts (e.g., 1 and 2) indicating their categories (the first category and the second category respectively).

In an embodiment, in general, awareness categories (e.g., category theoretic categories) of intelligence constituents are correlated with distributions (for sampling purposes, e.g., probability distributions; ensembles; models; state spaces; action spaces; random assignment, e.g., as an initial guess; etc.) for generating urgency level (UL) and confidence level (CL) based on the features of the intelligence constituents. An awareness A₁ related to a category of an intelligence constituent is derived by sampling a distribution (to generate UL and CL) correlated to the category (e.g., a category theoretic category), wherein the awareness A₁ is given by ((UL)ᵢ, (CL)ⱼ)₁—a first tuple—with (UL)ᵢ and (CL)ⱼ as values drawn from the distribution (with index i for UL and index j for CL) based on features of the intelligence constituent. A subscript (e.g., 1) for A₁ and the first tuple signifies the category of the intelligence constituent. For an entity (enabled with a first operational domain) encountering a first scenario represented by a first graph (information of the first scenario, e.g., at a granularity level within at least one sensory capability), a plurality of first observations (e.g., from at least one sensor with at least one sensory modality) is tagged with a plurality of first awareness (as a plurality of first tuples): {(A^{o1})₁, (A^{o1})₂, (A^{o1})ₘ₋₁, (A^{o1})ₘ}. A plurality of second observations is tagged with a plurality of second awareness (as a plurality of second tuples): {(A^{o2})₁, (A^{o2})₂, . . . (A^{o2})ₙ}. A plurality of third perceptions is tagged with a plurality of third awareness (as a plurality of third tuples): {(A^{p})₁, (A^{p})₂, . . . (A^{p})ₐ}. A plurality of fourth lower-order intelligences is tagged with a plurality of fourth awareness (as a plurality of fourth tuples): {(A^{l})₁, (A^{l})₂, . . . (A^{l})_{b}}. A plurality of fifth higher-order intelligences is tagged with a plurality of fifth awareness (as a plurality of fifth tuples): {(A^{h})₁, (A^{h})₂, . . . (A^{h})_{c}}. The superscripts o1, o2, p, l, and h represent the plurality of first observations, the plurality of second observations, the plurality of third perceptions, the plurality of fourth lower-order intelligences, and the plurality of fifth higher-order intelligences respectively. The subscript and superscript combinations from 1 to m (for o1), 1 to n (for o2), 1 to a (for p), 1 to b (for l), and 1 to c (for h) represent categories of awareness in general, in respective pluralities under consideration. In an embodiment, for the first scenario, at least one consolidation (by, e.g., distilling, taking stock, abstracting in general, extracting an essence, etc.) of the pluralities of awareness (the plurality of first awareness, the plurality of second awareness, the plurality of third awareness, the plurality of fourth awareness, and the plurality of fifth awareness) enables the entity to gain (generally, e.g., within the bounds of the first operational domain) at least one semantic of a basis comprising at least one of: comprehension, explainability, communication, citizenship, viability (of, e.g., goals, citizenship, amenability, etc.), subjective experience (of, e.g., the first scenario, bounds of the first operational domain, the first operational domain, etc.) in general, and combination thereof.

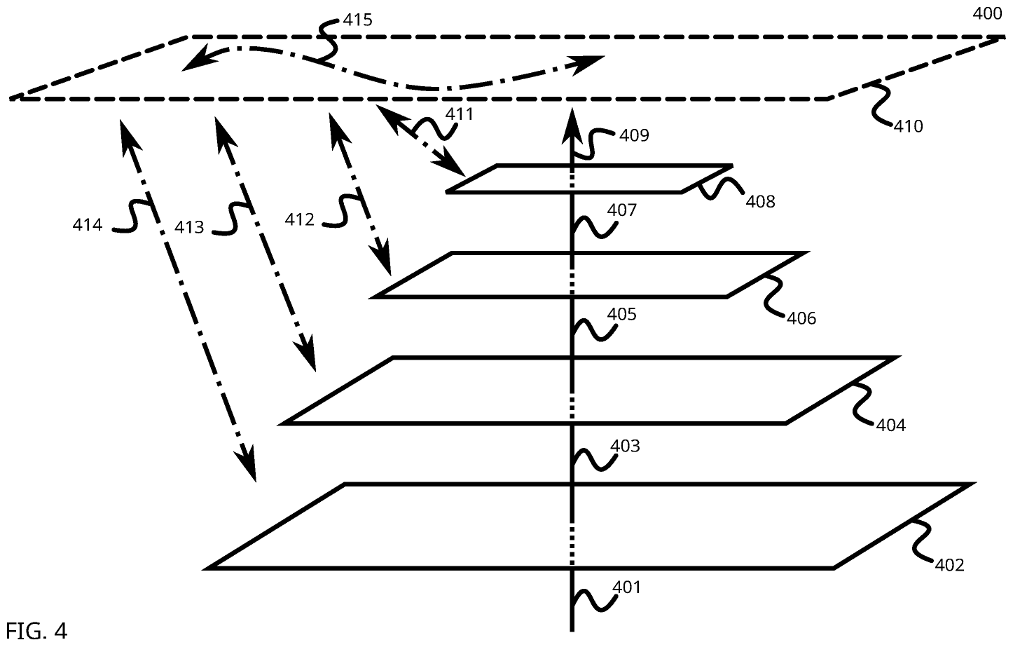

FIG. 4 illustrates system 400 in accordance with an embodiment of the present application. Components in system 400 may be implemented on at least one processor, incorporate non-volatile memory, and be distributed across various hardware. In an embodiment, system 400 represents an intelligence processing sequence for the entity. An arrow from segment 401 to segment 403 to segment 405 to segment 407 to segment 409, terminating on layer 410, represents a processing direction for the intelligence processing sequence. The intelligence processing sequence is characterized by layer 402, a sensory layer; layer 404, a perception layer; layer 406, a lower-order intelligence layer (also referred to as a narrow intelligence layer); layer 408, a higher-order intelligence layer; and layer 410, a general intelligence. The intelligence processing sequence (system 400) for the entity comprises:
a. at the sensory layer—layer 402—the plurality of first awareness and a plurality of sensory apparatus facilitating a second abstraction (e.g., consolidating sensory modalities, filtering low-level noise, etc.) from the plurality of first observations—segment 401—into the plurality of second observations—segment 403—which thereafter is tagged with the plurality of second awareness;
b. thereafter, at the perception layer—layer 404—the plurality of second awareness facilitating a third abstraction from the plurality of second observations—segment 403—into the plurality of third perceptions—segment 405—which thereafter is tagged with a plurality of third awareness;
c. thereafter, at the lower-order intelligence layer—layer 406—the plurality of third awareness facilitating a fourth abstraction from the plurality of third perceptions—segment 405—into the plurality of fourth lower-order intelligences—segment 407—which thereafter is tagged with a plurality of fourth awareness;
d. thereafter, at the higher-order intelligence layer—layer 408—the plurality of fourth awareness facilitating a fifth abstraction from the plurality of fourth lower-order intelligences—segment 407—into the plurality of fifth higher-order intelligences—segment 409—which thereafter are tagged with a plurality of fifth awareness; and
e. thereafter, the plurality of fifth awareness facilitating a sixth abstraction from the plurality of fifth higher-order intelligences—segment 409—as a part of the general intelligence (e.g., as an emergence)—layer 410.

The plurality of second awareness, the plurality of third awareness, the plurality of fourth awareness, the plurality of fifth awareness, and a plurality of sixth awareness may facilitate a generally concurrent first exchange of the general intelligence with a constituent of a basis comprising at least one of: exchange 411 with the higher-order intelligence layer—layer 408; exchange 412 with the lower-order intelligence layer—layer 406; exchange 413 with the perception layer—layer 404; exchange 414 with the sensory layer—layer 402; exchange 415 with a part of the general intelligence; and combination thereof. The first exchange improves the general intelligence with a quality of a basis comprising at least one of: autonomy, general knowledge, common sense, semantics, adapting to and benefiting from novelties in general, and combination thereof.

Generally, information of the first graph of the first scenario is thinned out (e.g., to filter unnecessary information, to remove irrelevant information, etc.) at each of the successive abstraction steps at corresponding layers—from layer 402 to layer 404, to layer 406, to layer 408, and to layer 410. The thinning out of the first graph, the generally concurrent first exchange, the fourth lower-order intelligence, the fifth higher-order intelligence, and the improved general intelligence may induce an intent and an agency (in response to, e.g., the plurality of first observations), may cause emergence of a semantic, may improve citizenship, and may account for novelties in the plurality of first observations (e.g., identify and learn from the novelties; reconcile the novelties with an emergent semantic; impose applicable fail-safes, citizenship, etc. on the intent and the agency; as a citizen, communicate, collaborate, etc. regarding the novelties; etc.). In an embodiment, the accounting for the novelties may be regarded as an application of common sense.

In an embodiment, in system 400, the layers (402, 404, 406, 408, and 410) are a representation of intelligence types (the sensory layer—layer 402—representing at least one sensory apparatus; the perception layer—layer 404—representing at least one perception; the lower-order intelligence layer—layer 406—representing at least one lower order intelligence, which may also be referred to as narrow intelligence; the higher-order intelligence layer—layer 408—representing at least one higher-order intelligence; and layer 410 representing the general intelligence of the entity) in a network—an intelligence graph—with a structure of a basis comprising at least one of: bidirectional interconnections, recursions, cycles, and combination thereof. The improved general intelligence may be a result of a basis comprising at least one of: the intelligence graph, signaling (e.g., communication, interrelated processing, etc.) of the intelligence graph, halting of the signaling, recursion of the signaling, persistence of information in the intelligence graph, retrieval of information from the intelligence graph, forgetting of information from the intelligence graph, novelty handling (novelty, e.g., identification, learning, propagation, communication, etc.), adaptation in general, insight generation in general, emergence in general, neuromorphic processing in general, and combination thereof.

In an embodiment, the intelligence graph may represent a network of nodes joined with links (e.g., edges, connecting lines, etc.) representing relationships between nodes they connect. In an embodiment, a plurality of recursively dependent information may be represented in an intelligence graph by recursive structures of a basis comprising at least one of: recursive nodes, recursive subgraphs, hidden nodes, hidden subgraphs, abstractions of nodes, abstractions of subgraphs, and combination thereof. The plurality of recursively dependent information may be of a basis comprising at least one of: observations, perceptions, intelligences, awareness, ecosystems, events, scenarios, communities (of type, e.g., swarms, social structures, collections in general, etc.), data stores, and combination thereof. The nodes may be of a basis comprising at least one of:
a. intelligences, e.g., awareness, perception, narrow intelligence, higher-order intelligence, etc.;
b. subgraphs for, e.g., cycle containment, ensuring processes halt, recursion, rapid execution of reflexes, enabling governance in general (e.g., of learning, of execution, as a part of general intelligence, etc.), etc.;
c. artificial intelligence mechanisms, e.g., of a basis comprising at least one of: neural networks (including, among others, spiking neural networks), neuromorphic techniques, reinforcement learning, machine learning in general, analytics in general, artificial intelligence in general, and combination thereof,
d. information assortment, e.g., of a basis comprising at least one of structured, unstructured, adhoc, transient, ephemeral, and combination thereof;
e. information type, e.g., of a basis comprising at least one of references, pointers, persistence types, recollection types, processing types, and combination thereof (wherein persistence types and recollection types may be of a basis comprising at least one of generation, storage, recollection, and combination thereof of memory, archives, data stores, etc.);
f. category theoretic constructs in general and formulations thereof (e.g., among others, awareness, intents, abstractions, and higher-order constituents of intelligence based on morphisms, judgements, abstractions, and higher-order morphisms—generally, first morphisms as abstractions of pluralities of second morphisms—of category theory respectively);
g. physical (e.g., based on hardware, permanent, non-transient, transient, and combination thereof) mediums, e.g., parts of fixed architectures, infrastructures, devices, gizmos, etc.;
h. virtual (e.g., based on hardware, based on software, permanent, non-transient, transient, and combination thereof), mediums, e.g., parts of clouds, metaverses, virtual realities, simulations in general, etc.; and
i. combination thereof.

In an embodiment, a construction (e.g., definitions, contents, boundaries, constraints, etc.) of a node of the intelligence graph may be of a basis comprising at least one of: intelligence generator, abstraction generator, intelligence validator, intelligence learner, intelligence governor (e.g., related to governance) in general, and combination thereof. Examples of the node types comprise:
a. awareness machine (e.g., awareness generator);
b. abstraction generator in general (e.g., to generate an abstraction of intelligence, etc.);
c. perception generator (e.g., to generate an abstraction of sensory observations, etc.);
d. intent processor (e.g., intent generator, intent evaluator, etc.);
e. novelty monitor (e.g., observation screener for novelty and prospective novelty, novelty and prospective novelty identifier, etc.);
f. agency postulator (e.g., agency proposer, agency generator, etc.);
g. comparator of information with its counterparts (to compare, e.g., an observation with its expected version, an observation with a corresponding recollection from memory, etc.) to evaluate deviations (e.g., deviation detector, deviation generator, deviation estimator, etc.);
h. supervisor of learning (e.g., related to supervision of a basis comprising at least one of: detecting deviations by comparing information, propagating deviations in general, propagating error corrections in general, updating at least one part of the intelligence graph, and combination thereof);
i. governor of learning (e.g., related to governance of a basis comprising at least one of: detecting deviations by comparing information, propagating deviations in general, propagating error corrections in general, updating at least one part of the intelligence graph, and combination thereof);
j. supervisor of execution (e.g., of an agency), wherein supervision is of a basis comprising at least one of: coordination of parts of agencies and executions thereof; fine tuning in general; reconciliation with awareness in general; actions (related to, e.g., upholding foundations, maintaining citizenship, prohibiting contraindicated executions in general, mitigating or rectifying executions contraindicated by a novelty, etc.); and combination thereof,
k. governor of execution (e.g., of an agency), wherein governance is of a basis comprising at least one of: coordination of parts of agencies and executions thereof; fine tuning in general; reconciliation with awareness in general; actions (related to, e.g., upholding foundations, maintaining citizenship, prohibiting contraindicated executions in general, mitigating or rectifying executions contraindicated by a novelty, etc.); and combination thereof,
l. supervisor in general;
m. governor in general, e.g., as an aspect of overseeing, governing in general, as a part of general intelligence; and
n. combination thereof.

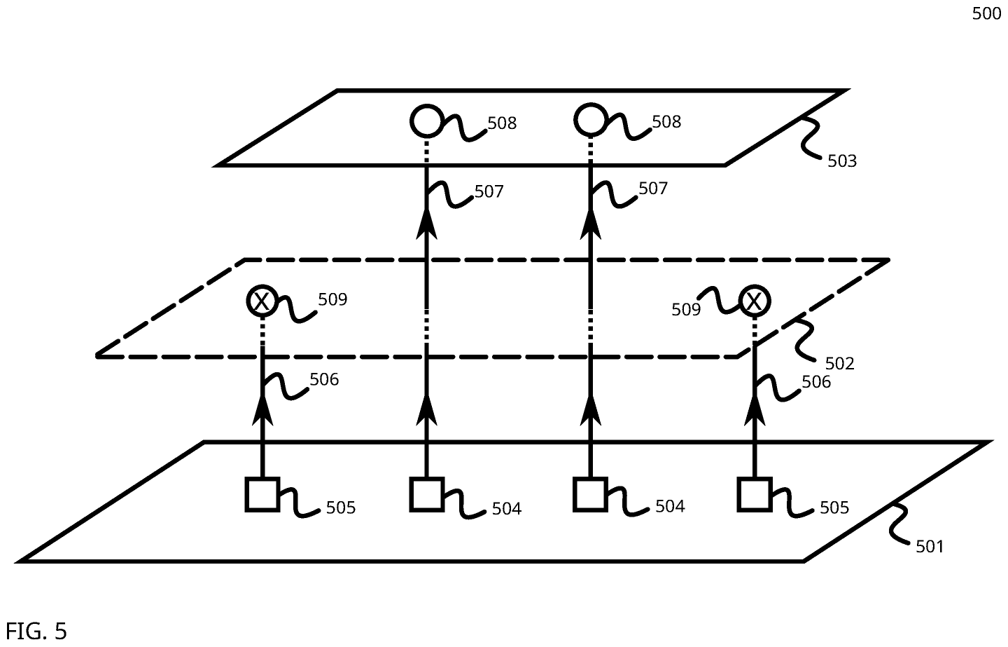

FIG. 5 illustrates system 500 in accordance with an embodiment of the present application. Components in system 500 may be implemented on at least one processor, incorporate non-volatile memory, and be distributed across various hardware. In an embodiment, system 500 represents thinning out (from layer 501 to layer 503 as aspects of abstractions) of a plurality of information comprising 504 and 505 (e.g., observation, intelligence in general, awareness, intent, lower-order intelligence, higher-order-intelligence, perception, etc.), which are tagged with pluralities of awareness as tuples of UL (urgency level) and CL (confidence level). Plurality of information 504 is tagged with (high UL, high CL), and plurality of information 505 is tagged with (low UL, high CL). An abstraction is facilitated by the awareness tuples. Filtering layer 502 drops (segment 506) plurality of information 505 due to its low UL, which pauses (termination 509) processing of plurality of information 505. Plurality of information 504, due to its high UL, is propagated (segment 507) to the next information processing layer (layer 503) where it may be processed further as an abstraction (abstraction 508) of pluralities of information 504 and 505. In an embodiment, the pausing of the processing of plurality of information 505 is an aspect of supervision and overseeing in general.

In an embodiment, for an entity encountering a scenario (e.g., the first scenario in system 400), a novelty—as a plurality of information—may be identified and tagged with awareness tuple (high UL, low CL) at a perception layer (e.g., layer 404 in system 400). For the novelty at layer 501, filtering layer 502 propagates the novelty as a dedicated (e.g., filtered, isolated, prioritized, etc.) novelty abstraction to the next information processing layer—layer 503. The novelty may pass unaltered through a sensory layer (e.g., layer 402 in system 400) and a narrow intelligence layer (e.g., layer 406 in system 400), and may be further processed in a higher-order intelligence layer (e.g., layer 408 in system 400). Thereafter, due to a plurality of concurrent exchanges among intelligence layers (e.g., coordinated by the general intelligence in system 400) the novelty may be incorporated in an intent and an agency (for, e.g., exploration, investigation, etc.). In an embodiment, an awareness tagged with (high UL, low CL) may be regarded as a heightened awareness of a basis comprising at least one of: unexpectedness in general, potential novelty, potential insight, potential emergence, and combination thereof.

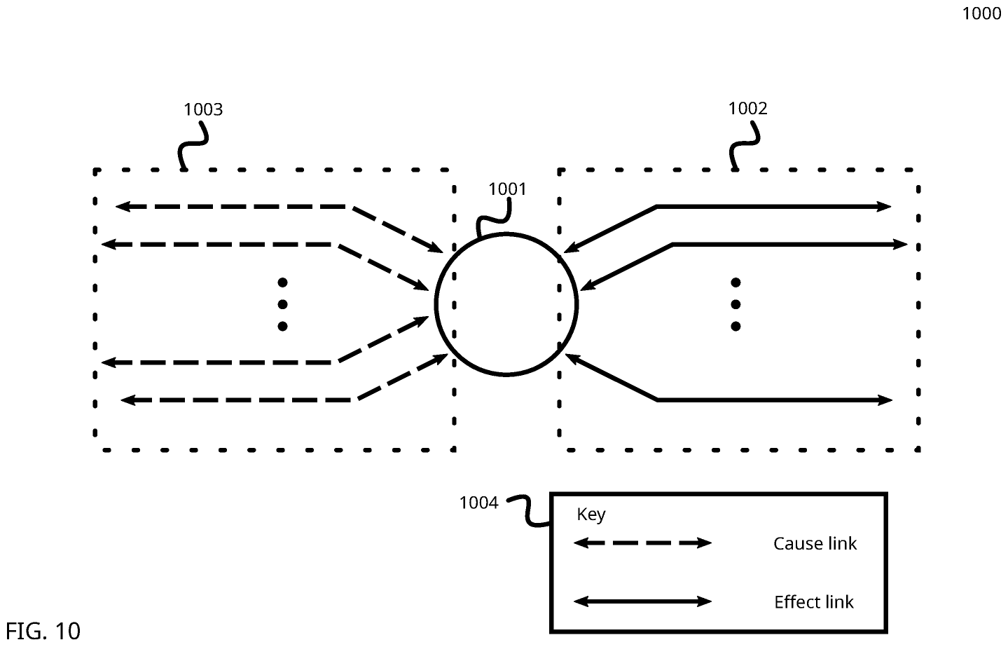

FIG. 10 illustrates system 1000 in accordance with an embodiment of the present application. Components in system 1000 may be implemented on at least one processor, incorporate non-volatile memory, and be distributed across various hardware. In an embodiment, system 1000 represents processing a novelty and an awareness thereof by a dynamically-directed intelligence graph (DDIG)—generally by at least one higher-order intelligence. An entity in an ecosystem, by at least one perception, identifies a first observation that could not be thinned out in general (e.g., by filtering, abstracting, etc., generally, due to lack of related intelligence, lack of a constituent thereof, etc.) as an interference to a first autonomy. Thereafter, at a perception layer, the at least one perception tags the first observation with an awareness as an awareness tuple (high UL, low CL) to designate the first observation as a novelty and the awareness tuple as the tagged awareness. The novelty passes through a narrow intelligence layer of the intelligence graph unaltered and is processed further by a higher-order intelligence layer of the intelligence graph.

A higher-order intelligence forms node 1001 of the intelligence graph (e.g., comprising a plurality of nodes representing at least causal relations comprising rules). A general intelligence in an exchange with node 1001 delivers the novelty and the tagged awareness to node 1001 for further processing of a basis comprising at least one of: identification of at least one cause of the novelty, identification of at least one effect of the novelty, improving the confidence level in general (given observed correlated causes and effects, e.g., increase, by induction, confidence level of causal relations comprising rules), verifying the urgency level in general, assigning a category to the awareness of the novelty, and combination thereof. Node 1001 is networked with plurality of cause links 1003 and plurality of effect links 1002. Key 1004 identifies “Cause link” and “Effect link” as link types. Node 1001 applies a process of a basis comprising at least one of: inductive inference, abductive inference, inference on a plurality of the cause links (e.g., plurality of cause links 1003), inference on a plurality of effect links (e.g., plurality of effect links 1002), exchange of information with the general intelligence, exchange of information with other nodes of the intelligence graph (generally, e.g., under a governance of the general intelligence), and combination thereof. In an embodiment, node 1001 prioritizes at least one cause of the novelty and at least one effect of the novelty. Node 1001 finds the novelty (the first observation) to be a possible member of a second distribution for awareness and a possible member of a second category, updates an awareness machine of the entity (e.g., improves by induction: confidence levels, urgency levels, and representations, etc. of, among others, distributions, categorical representations, and causal relations comprising rules), and postulates a resolution (e.g., from a high-confidence causal relation) of the novelty. The first observation is potentially not novel for the entity (e.g., has been identified, categorized, potentially resolved, etc.), wherein the confidence level of the awareness tuple improves (e.g., from low CL to high CL). A plurality of second observations that is correlated to the first observation is potentially a third novelty (e.g., a possibility of a third novelty, a third novelty weakly correlated to the novelty, an observation that is identified as a third novelty generally with low confidence level, arising from the entity lacking confidence in an expectation that the first observation belongs to the second category, arising from the entity suspecting but not confident in expectations about causes and effects of the first observation, etc.) and is tagged with a plurality of awareness tuples—(high ULᵢ, high CLⱼ)ₙ. The subscript n represents number of awareness tuples (and number of awareness) in the plurality of awareness tuples; subscripts i and j both with sequences from 1 to n represent pluralities of UL and CL related to the second category. In an embodiment, node 1001 further applies a plurality of processes of a basis comprising at least one of: inductive inference, abductive inference, inference on plurality of cause links 1003, inference on plurality of effect links 1002, exchange of information with the general intelligence, exchange of information with other nodes of the intelligence graph (generally, e.g., under a governance of the general intelligence), and combination thereof. In an embodiment, node 1001 further prioritizes the at least one cause of the novelty and the at least one effect of the novelty and validates (e.g., increases a confidence level of an existing correlation of the novelty by induction) that the third novelty is correlated to the novelty. Node 1001 validates the improved confidence level of the plurality of awareness tuples of the plurality of second observations, and node 1001 reinforces the membership of the third novelty and the plurality of second observations (that are correlated to the first observation and the novelty) in the second category. The reinforcement is of a basis comprising at least one of: improved viability, improved effectiveness, improved autonomy of the entity, a plurality of second updates to the awareness machine (as, e.g., improvements, learning, real-time learning, etc.), improved general intelligence of the entity in general (as, e.g., common sense related to the novelty, validated ability to process novelties, etc.), and combination thereof. Due to the reinforcement, the updated awareness machine (with the plurality of second updates) tags at least one third observation that is similar (e.g., category theoretically) to the first observation (and similar to the plurality of second observations) with an awareness tuple (low UL, high CL), wherein the at least one third observation is not a novelty.

In an embodiment, a plurality of fourth observations belong to a new and unknown awareness category. The plurality of fourth observations represent a second novelty. If node 1001 cannot resolve the second novelty, the entity may not overcome at least one interference to an autonomy, wherein the at least one interference is closely associated with the second novelty. The entity may regard the at least one interference as an impasse and the second novelty as intractable.

In an embodiment, system 1000 represents processing proposals. A general intelligence in an exchange with node 1001 delivers a new proposal for further processing of a basis comprising at least one of: identification of at least one cause of the new proposal, identification of at least one effect of the new proposal, verifying and updating a confidence level of the new proposal, verifying and updating an urgency level of the new proposal, verifying and updating an awareness category of the new proposal, and combination thereof. Node 1001 is networked with plurality of cause links 1003 and plurality of effect links 1002. Key 1004 identifies “Cause link” and “Effect link” as link types. Node 1001 applies a process of a basis comprising at least one of: inductive inference, abductive inference, inference on plurality of cause links 1003, inference on plurality of effect links 1002, exchange of information with the general intelligence, exchange of information with other nodes of the intelligence graph (generally, e.g., under a governance of the general intelligence), and combination thereof. In an embodiment, node 1001 prioritizes at least one cause of the new proposal and at least one effect of the new proposal and proposes an improvement to the general intelligence with a first update (e.g., improvements, by at least induction, to: confidence levels, urgency levels, and representations, etc. of, among others, distributions, categorical representations, and causal relations comprising rules) based on the prioritization of the at least one cause and the at least one effect of the new proposal. The general intelligence validates the proposed improvement and the improvement. The general intelligence further identifies (e.g., tags with an awareness, marks, etc.) node 1001 as a candidate for a specialist node for processing related to the new proposal. The new proposal may be of a basis comprising at least one of: observations, narrow intelligences, higher-order intelligences, perceptions, awareness, intents, parts of the general intelligence, constituents of intelligence in general, facts in general, pieces of information in general, forecasts (e.g., comprising at least one of hypothesis, speculation, expectation, anticipation, and combination thereof), and combination thereof.

Thereafter, the general intelligence, in a plurality of exchanges with node 1001 (as the candidate for the specialist node), delivers a plurality of proposals that are similar to the new proposal (e.g., in intelligence type, in observation type, proposals with same awareness category, in perception type, etc.). Node 1001 applies a plurality of processes of a basis comprising at least one of: inductive inference, abductive inference, inference on plurality of cause links 1003, inference on plurality of effect links 1002, exchange of information with the general intelligence, exchange of information with other nodes of the intelligence graph (generally, e.g., under a governance of the general intelligence), and combination thereof. In an embodiment, node 1001 prioritizes and reinforces the at least one cause (and variations thereof) and the at least one effect (and variations thereof), which are associated with the plurality of proposals. Node 1001 also reinforces the improvement to the general intelligence with a plurality of updates based on the prioritization and the reinforcement of the at least one cause (and the variations thereof) and the at least one effect (and the variations thereof) of the plurality of proposals. Due to the reinforcement and specialization of node 1001, the general intelligence requires less overseeing (e.g., governance, supervision, etc.) of node 1001 and assigns it increased autonomy. The general intelligence further identifies (e.g., tags with an awareness, marks, etc.) node 1001 as the specialist node for processing the plurality of proposals. The processing of the plurality of proposals by the specialist node becomes more reflexive and less deliberative.

The plurality of proposals may be of a basis comprising at least one of: observations, narrow intelligences, higher-order intelligences, perceptions, awareness, intents, parts of the general intelligence, constituents of intelligence in general, facts in general, pieces of information in general, forecasts (e.g., comprising at least one of hypothesis, speculation, expectation, anticipation, and combination thereof), and combination thereof. The reinforced improvement to the general intelligence may be of a basis comprising at least one of: confidence level related to causes, confidence level related to effects, confidence level in general, urgency level related to causes, urgency level related to effects, urgency level in general, confidence level of awareness, urgency level of awareness, viability in general, performance in general, knowledge (e.g., of a proposal, etc.), information (e.g., of a proposal, etc.), intelligences in general (e.g., perception, narrow intelligence, higher-order intelligence, etc.), specialization (e.g., of node 1001), reflexivity of processing in general, deliberativeness of processing in general, semantics in general, and combination thereof.

In an embodiment, the general intelligence and the higher-order intelligence (that forms node 1001) may enable the intelligence graph to explore in both directions on demand: a cause direction and an effect direction, activated on demand under the governance of the general intelligence. The intelligence graph may be regarded as a dynamically-directed intelligence graph (DDIG). At least one cause direction is evaluated with abduction in general, and at least one effect direction is evaluated with inference in general. In an embodiment, the intelligence graph comprises: a plurality of first nodes with a plurality of first specializations, a plurality of second nodes that correlate to and compliment node 1001 (the specialist node) in processing the plurality of proposals, and a plurality of third nodes that orchestrate proposal processing in general (e.g., by coordinating among the plurality of second nodes, node 1001, the general intelligence, and the plurality of first nodes).

Processing Ecosystem Graphs with DDIGs

In an embodiment, for an entity in an ecosystem, a graph of the ecosystem (e.g., a graph of all observations in the ecosystem within the sensory capability of the entity) may be intractable in general. A general intelligence of the entity as a dynamically-directed intelligence graph (DDIG) may thin out the graph of the ecosystem (e.g., information from the graph of the ecosystem may be incorporated into the DDIG as abstractions that simplify the graph; information from the graph may be filtered out as unrelated; the graph may be generalized, e.g., by reductionism, reducing resolution in general, and chunking, among others), in real time and in situ (e.g., in the ecosystem, in a scenario of the ecosystem, etc.), resulting in tractable intents, awareness, and agencies to enable autonomy (e.g., autonomous proactiveness) of the entity. In an embodiment, the entity correlates (e.g., constructs, works with, and maintains) the DDIG with the graph of the ecosystem. The correlation may be of a basis comprising at least one of: operations; learning (e.g., experience); novelties of a basis comprising at least one of: rare occurrences, tail-end events, peculiarities, impasses, intractabilities, idiosyncrasies of constituents of the ecosystem, newly acquired expertise, improved expertise, new awareness categories, improved awareness categories, and combination thereof, the entity's inceptions (e.g., in ecosystems); the entity's retirements (e.g., from ecosystems); the entity's operational domains (e.g., that are subjective to the entity) related to the ecosystem; and combination thereof. In general, the DDIG adapts to the ecosystem, and the adaptation is of a basis comprising at least one of: the entity's operational domain, the entity's operation, the entity's learning, and combination thereof.

In an embodiment, a first entity with a first DDIG and a second entity with a second DDIG may be replicas of a basis comprising at least one of: similar general intelligence, weak copies, similar behavior, similar goals in general, similar expertise in general, and combination thereof. A first graph of a first ecosystem differs from a second graph of a second ecosystem. The first entity is introduced into and exclusively operates in the first ecosystem, wherein the first DDIG adapts and improves its operation with respect to the first ecosystem. The first entity's operational domain evolves with respect to the first ecosystem, and thereafter the first entity gains at least one first expertise. The second entity is introduced into and exclusively operates in the second ecosystem, wherein the second DDIG adapts and improves its operation with respect to the second ecosystem. The second entity's operational domain evolves with respect to the second ecosystem, and thereafter the second entity gains at least one second expertise. The improved first DDIG differs from the improved second DDIG, wherein at least one similarity between the first entity and the second entity vanishes. Thereafter, the first entity and the second entity are not replicas.

In an embodiment, the first entity and the second entity collaborate. The collaboration is of a basis comprising at least one of: communication, sharing, inter-entity interaction, information persistence, information retrieval, participation in a swarm, administration by an administrator, mediation by at least one intermediary, and combination thereof. The collaboration enables merging of the first DDIG and the second DDIG to form a third DDIG. A third entity with the third DDIG may operate with a third expertise of a basis comprising at least one of: the first expertise; the second expertise; at least one viability to operate in the first ecosystem; at least one viability to operate in the second ecosystem; at least one performance to operate in the first ecosystem; at least one performance to operate in the second ecosystem; at least one administration comprising at least one of: governing an entity, supervising an entity, overseeing an ecosystem, collaborating with an administrator, and combination thereof, at least one rapid acclimation to an ecosystem; and combination thereof. The third entity's operational domain (e.g., subjective to the third entity) comprises the first entity's operational domain (e.g., subjective to the first entity) and the second entity's operational domain (e.g., subjective to the second entity), and synergistic combinations thereof.

In an embodiment, for an entity in an ecosystem, a general intelligence (e.g., that of a real-world autonomous driving entity at par with that of human drivers) may require a dynamically-directed intelligence graph (DDIG) with intelligence nodes capable of processing information of a basis comprising at least one of wide-spectrum, broad, deep (e.g., recursively deep, high resolution, etc.), diverse, complex, emergent, and combination thereof. For example, the entity may operate a vehicle in the ecosystem with a capability of a basis comprising at least one of: at least at par with humans, to sustain and benefit the ecosystem in general (e.g., as a citizen), to maintain homeostasis, to process novelties (e.g., identify, categorize, learn from, etc., novelties and improve an awareness machine due to the novelties), to overcome complexity, and combination thereof. The DDIG may be derived—subject to the general intelligence of the entity—from a graph of the ecosystem with a path (e.g., edge) structure of a basis comprising at least one of circular, recursive, bidirectional, category theoretic in general, and combination thereof.

In an embodiment, the path structure and the graph of the ecosystem may be constructed ex situ, before the entity's operational inception into the ecosystem, and based on an a priori knowledge from an administrator, subject to construction difficulty of a basis comprising at least one of: enormity of the ecosystem, diversity of the ecosystem, time evolution (e.g., that is ceaselessly continuous) of structures and processes of the ecosystem, dynamically changing sustainability and balance of the ecosystem in general, inability to predict future events in a complex system like the ecosystem, complexity in general, emergence in general, and combination thereof. For the administrator, the path structure of the graph may pose a challenge of a basis comprising at least one of: intractably large path lengths; inability to halt path tracing (e.g., due to recursiveness, enormity, open-endedness, etc.); impractically large resource requirements for processing in general; impractically large time requirements for processing in general; operational difficulty in general; construction difficulty; communication difficulty (e.g., inability to encode for transport, inability to persist, inability to retrieve, etc.); collaboration difficulty (e.g., inability to form a swarm, difficulty with inter-entity coordination, etc.); inability to anticipate emergence, inability to overcome complexity in general (e.g., complexity of formulating a homeostasis of the ecosystem, etc.), etc.; and combination thereof.

In an embodiment, after an in situ real-time operation of the entity in the ecosystem, the general intelligence evolves into an improved DDIG that may enable the entity to expertly operate in the ecosystem. The improved DDIG represents a tractable representation of the ecosystem that is practically viable (e.g., fit for service, feasible in general, etc.). An administrator may retrieve the improved DDIG for a purpose comprising at least one of gaining an expertise in the ecosystem; resolving a difficulty (e.g., optimize a loss, optimize a gain, learn from an insight, learn to resolve an intractability, adapt in general, etc.) related to the ecosystem; creating new entities with the improved DDIG as a template; replicating the entity for an operation in the ecosystem (e.g., as an economy of scale, to gain operational scale, etc.); formulating at least one FPM (functional performance measure) of a basis comprising at least one of the ecosystem, the entity, the improved DDIG, insight, emergence, complexity, operation, learning, and combination thereof, scoping operational domains of entities; and combination thereof.

In an embodiment, an intelligence of an entity in an ecosystem may be represented by a DDIG. For the entity, the DDIG may represent a feature comprising at least one of: intelligences (e.g., a general intelligence), metrics, metrics as representations of intelligences, and combination thereof. In an embodiment, a DDIG represents a metric of an entity, and the evaluation of the metric at an instance of time correlates to a derived property of the DDIG at that instance of time. For example, in general, a derivation of an intent of the entity from the DDIG is also referred to as an evaluation of the intent from the metric of the entity; a derivation of an awareness of the entity from the DDIG is also referred to as an evaluation of the awareness from the metric of the entity; derivation of an expected observation of the entity from the DDIG is also referred to as an evaluation of the expected observation from the metric of the entity; and a derivation of an agency of the entity from the DDIG is also referred to as an evaluation of the agency from the metric the entity.

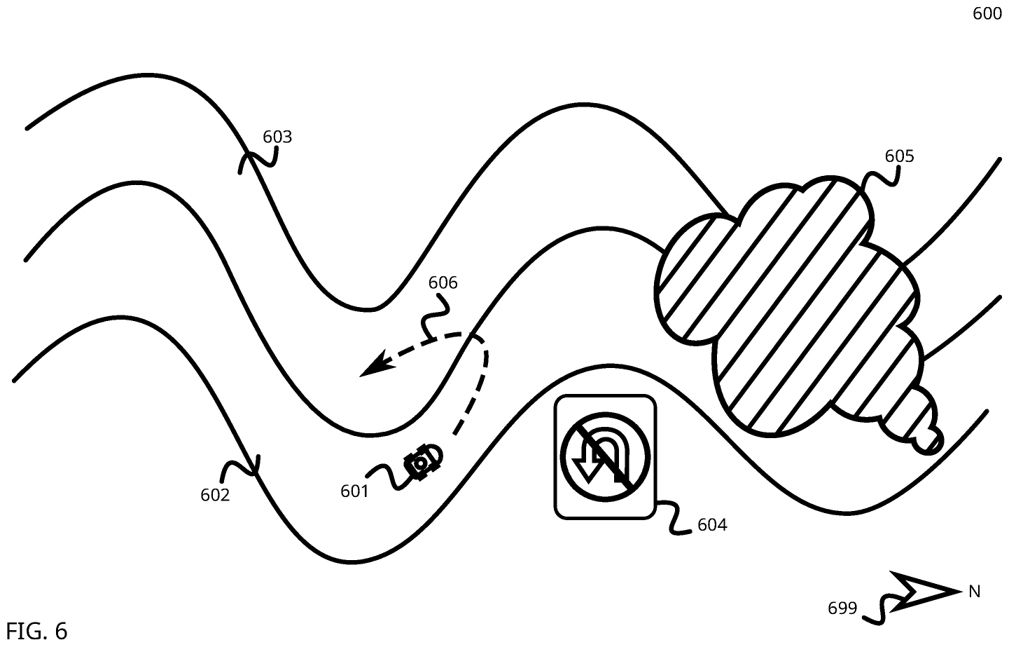

FIG. 6 illustrates system 600 in accordance with an embodiment of the present application. System 600 is an embodiment of autonomy, wherein intent and awareness overcome conflicting goals for autonomous vehicles. In an embodiment, AV 601 navigates northbound lane 602 in an ecosystem to transport passengers to a target destination. Arrow 699 indicates a direction, north. AV 601, as an entity with a general intelligence, benefits from at least one awareness enabling an autonomous operation-driving. The at least one awareness is of a basis comprising at least one of: traffic laws of the ecosystem, surroundings of AV 601 (e.g., other vehicles, pedestrians, the northbound lane 602, the southbound lane 603, “no U-turn” sign 604, etc.), current speed, target destination, ETA of the target destination, and combination thereof. AV 601 operates in accordance with at least one foundation (e.g., AV 601 prioritizes, in general, the safety of humans over other goals). AV 601 operates in accordance with laws and regulations within the ecosystem to support its citizenship within the ecosystem. As an aspect of the citizenship, AV 601 monitors novelties (e.g., unexpected scenarios in general) to safeguard (against, e.g., losses, potential losses, risks, perceptions of risks, etc.) the at least one foundation. The safeguarding of the at least one foundation is an aspect of governance and overseeing in general. Foundations of an entity in an ecosystem, in general, represent certain core directives the entity abides by at the expense of operational objectives comprising tactical goals and certain strategic goals; core directives are of a basis comprising at least one of ethics-based prioritization, social mandates, legal dues, and combination thereof. A core directive may be encoded as overriding rules, hardcoded behaviors, etc., wherein the encoding is of a basis comprising at least one of: inherent; intrinsic; activated externally, e.g., as overriding rules; emergent, e.g., community behavior; and combination thereof.

As AV 601 drives north, it detects (e.g., as a result of the monitoring) a novelty on the road ahead, smoke cloud 605 (e.g., caused by a wildfire), and determines (e.g., evaluates) that continuing on the current path poses an unacceptable threat to its passengers. Due to the at least one foundation, AV 601 prioritizes the novelty and an objective to safely remove its passengers from the range of the threat. AV 601 determines (e.g., evaluates) the only viable route to ensure passenger safety is to take a U-turn as soon as safely possible and proceed in the opposite direction on southbound lane 603 (as, e.g., an anticipated agency). However, the anticipated agency, based on the at least one foundation, conflicts directly with a regulation (no U-turns allowed) as expressed by sign 604. In an embodiment, AV 601 gains a semantic of a basis comprising at least one of: the recognition of the conflict, at least one contradiction therefrom, at least one contraindication, at least one risk, at least one cost-benefit analysis, at least one responsibility (e.g., with respect to citizenship), at least one recognition to accept short-term loss (e.g., violation of the regulation) to maintain citizenship (e.g., to uphold the at least one foundation), and combination thereof. The gaining of the semantic is an aspect of governance and overseeing in general.

After AV 601 determines the road is clear for a U-turn, AV 601 executes the anticipated agency (U-turn 606), violating the regulation; AV 601 prioritizes compliance with the foundation over contraindicated compliance with the regulation. In an embodiment, the AV's (601) activity of a basis comprising at least one of: the monitoring, the detection of the novelty, the determination of the unacceptable threat, the gaining of the semantic, the determination that the anticipated agency provides the only viable route (e.g., there being no other option), and combination thereof is an aspect of governance and overseeing in general. After executing the agency, AV 601 determines that the threat is no longer imminent and that the conflict has concluded. AV 601 resumes following regulations of the ecosystem while taking an alternate path to the destination.

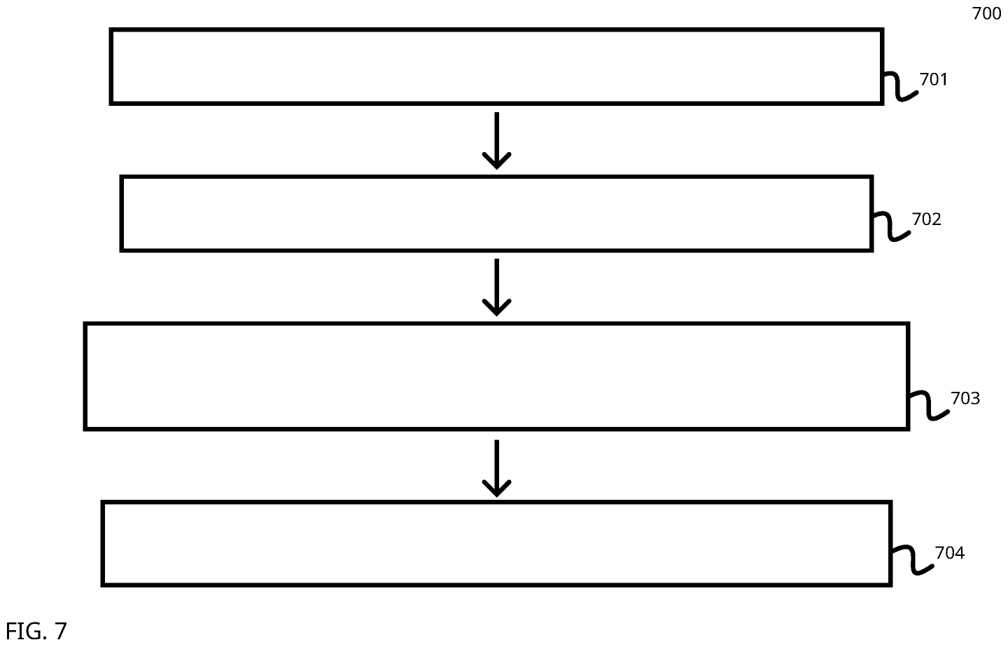

FIG. 7 illustrates a method 700 in accordance with an embodiment of the present application. In certain embodiments, method 700 may correspond to the processes described with reference to FIGS. 1-6 and FIGS. 8-24.
a. At block 701, method 700 includes, with a second intent, acquiring a second observation and postulating at least one second agency.
b. At block 702, method 700 includes, with at least one first awareness, monitoring and identifying at least one second novelty.
c. At block 703, method 700 includes, with at least one second awareness, prioritizing the at least one second novelty and incorporating the prioritized at least one second novelty into the postulated at least one second agency, thereby aligning the postulated at least one second agency with at least one goal.
d. At block 704, method 700 includes, with at least one third awareness, limiting the scope of the second intent to fine-tune the postulated at least one second agency.

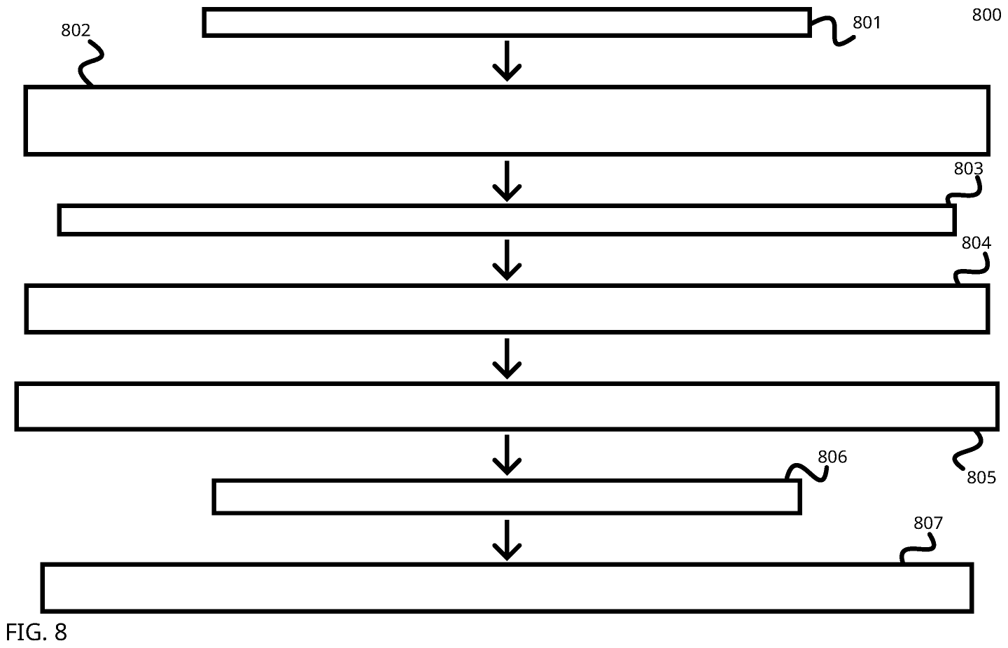

FIG. 8 illustrates a method 800 in accordance with an embodiment of the present application. In certain embodiments, method 800 may correspond to the processes described with reference to FIGS. 1-7 and FIGS. 9-24.
a. At block 801, method 800 includes acquiring at least one second observation at a second time instance.
b. At block 802, method 800 includes comparing the at least one second observation with at least one second expected observation to update a metric as an improvement to the metric, wherein the at least one second expected observation was generated by a first intent at a first time instance that was before the second time instance.
c. At block 803, method 800 includes computing a second intent by evaluating the updated metric with respect to the at least one second observation.
d. At block 804, method 800 includes generating, from the second intent and the at least one second observation, at least one second agency and at least one third expected observation.
e. At block 805, method 800 includes, thereafter, executing the at least one second agency accompanied by a transition to a third time instance that is after the second time instance.
f. At block 806, method 800 includes acquiring at least one third observation at the third time instance.
g. At block 807, method 800 includes comparing the at least one third observation to the at least one third expected observation to update the updated metric as a further improvement to the updated metric.

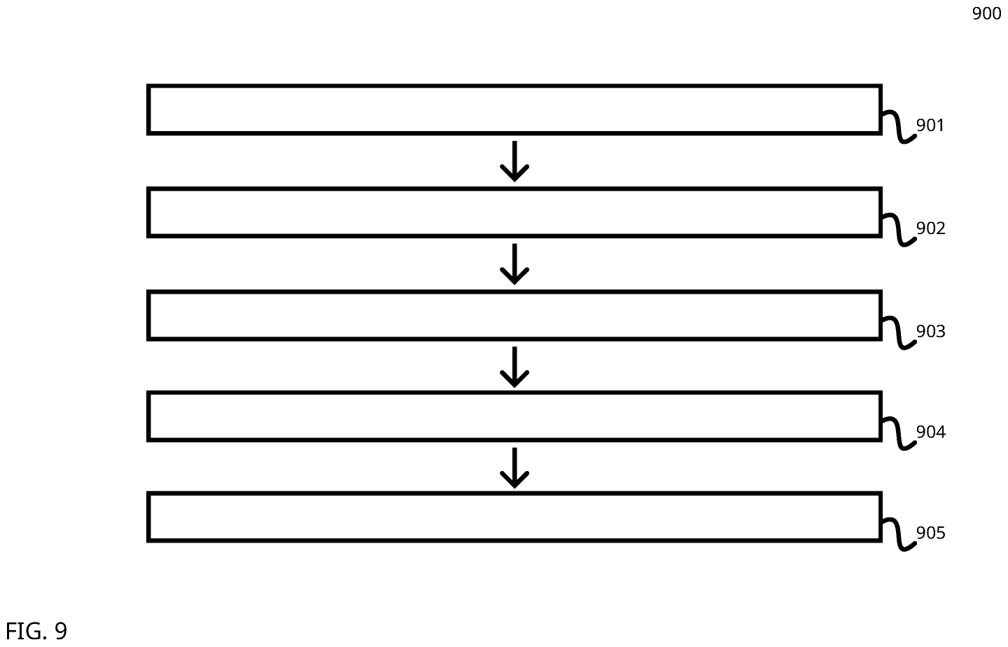

FIG. 9 illustrates a method 900 in accordance with an embodiment of the present application. In certain embodiments, method 900 may correspond to the processes described with reference to FIGS. 1-8 and FIGS. 10-24.
a. At block 901, method 900 includes introducing an entity with a metric into an ecosystem, wherein, at inception, the metric is an intelligence of a basis comprising at least one of: innate, inherent, and combination thereof
b. At block 902, method 900 includes, thereafter, during operation in the ecosystem over a plurality of prior time instances, improving the intelligence of the entity with a plurality of updates to the metric.
c. At block 903, method 900 includes, thereafter, a simultaneity of operation and learning in the ecosystem at the current time instance.
d. At block 904, method 900 includes, thereafter, during operation in the ecosystem over a plurality of next time instances, improving the intelligence of the entity with a plurality of updates to the metric.
e. At block 905, method 900 includes, thereafter, retiring the entity from the ecosystem.

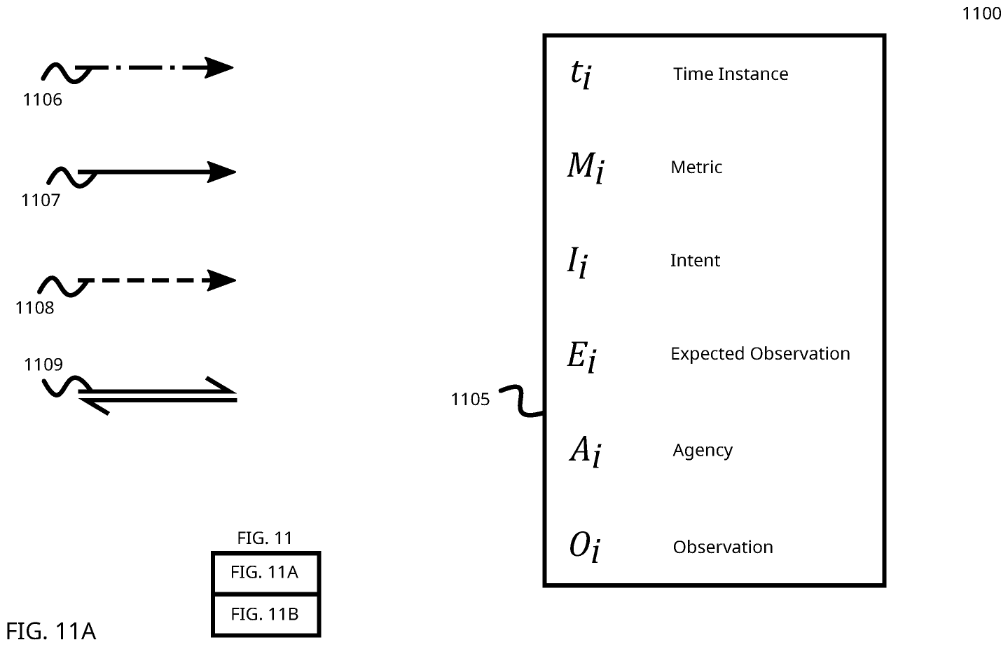

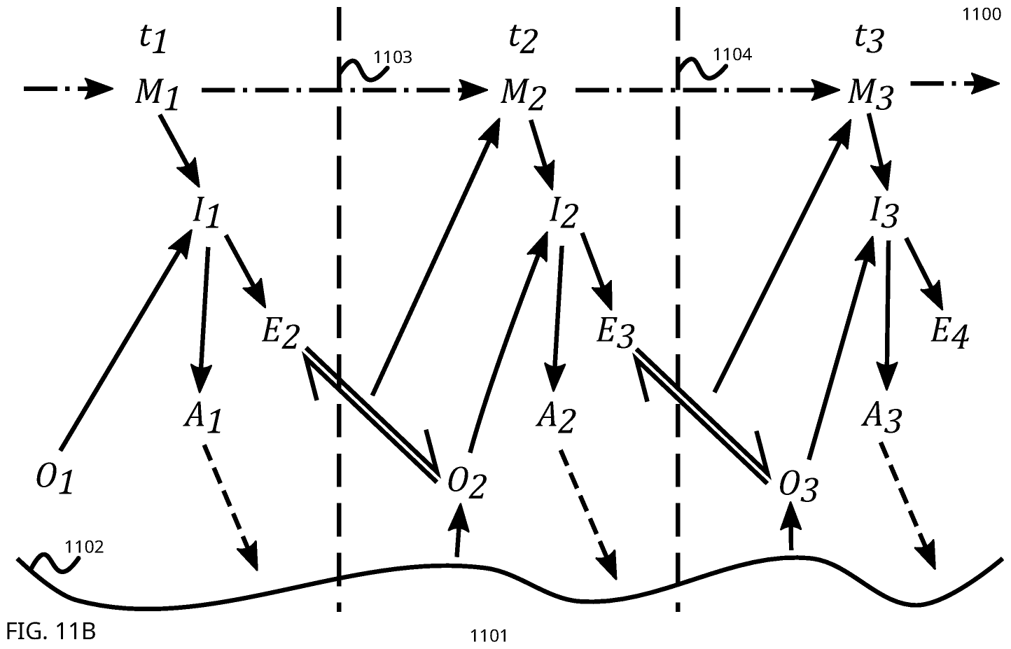

FIG. 11A and FIG. 11B together form a composite (jointly referred to as FIG. 11 as indicated by the composite box FIG. 11 in FIG. 11A) that illustrates system 1100 in accordance with an embodiment of the present application. System 1100 is an embodiment of in situ real-time continuous operation of general intelligence in accordance with an embodiment related to the present application. Components in system 1100 may be implemented on at least one processor, incorporate non-volatile memory, and be distributed across various hardware. System 1100 represents an entity with a general intelligence operating in an ecosystem 1101. Boundary 1102 represents a boundary between the entity and ecosystem 1101. Key 1105 identifies tᵢ as an i^{th} “Time Instance”; Mᵢ as an i^{th} “Metric”; Iᵢ as an i^{th} “Intent”; Eᵢ as an i^{th} “Expected Observation”; Aᵢ as an i^{th} “Agency”; and Oᵢ as an i^{th} “Observation”. In an embodiment, arrow 1106 (to M₁; from M₁ to M₂; from M₂ to M₃; and from M₃) represents an axis of the figure with respect to a progression of time. At a first time instance, tᵢ, a first intent, h₁, is evaluated from a first metric, M₁ (arrow 1107 from M₁ to h₁) and a first observation, O₁ (arrow 1107 from O₁ to I₁). The first intent postulates (arrow 1107 from I₁ to A₁) a first agency, A₁. The first intent also generates (arrow 1107 from I₁ to E₂) a second expected observation, E₂. A transition 1103 from the first time instance, t₁, to a second time instance, t₂, may correlate with an execution (arrow 1108 from A₁ to 1102) of the postulated first agency, A₁, in the ecosystem 1101.

At the second time instance, t₂, the second expected observation, E₂, is compared (comparison 1109 between E₂ and O₂) to a second observation, O₂, acquired (arrow 1107 from 1102 to O₂) from ecosystem 1101. Comparison 1109 between O₂ and E₂, and any resulting deviation between them, are used to update (arrow 1107 from comparison 1109, between O₂ and E₂, to M₂) the first metric, M₁, resulting in a second metric, M₂. M₂ may be an improvement over M₁ in ecosystem 1101. A second intent, I₂, is evaluated from the second metric, M₂ (arrow 1107 from M₂ to I₂) and the second observation, O₂ (arrow 1107 from O₂ to I₂). The second intent postulates (arrow 1107 from I₂ to A₂) a second agency, A₂, and generates (arrow 1107 from I₂ to E₃) a third expected observation, E₃. A transition 1104 from the second time instance, t₂, to a third time instance, t₃, may correlate with an execution (arrow 1108 from A₂ to 1102) of the postulated second agency, A₂, in the ecosystem 1101.

At the third time instance, t₃, the third expected observation, E₃, is compared (comparison 1109 between E₃ and O₃) to a third observation, O₃, acquired (arrow 1107 from 1102 to O₃) from the ecosystem 1101. Comparison 1109 between O₃ and E₃, and any resulting deviation between them, are used to update (arrow 1107 from comparison 1109 between O₃ and E₃, to M₃) the second metric, M₂, resulting in a third metric, M₃. M₃ may be an improvement over M₂ in ecosystem 1101. A third intent, I₃, is evaluated from the third metric, M₃ (arrow 1107 from M₃ to I₃) and the third observation, O₃ (arrow 1107 from O₃ to I₃). The third intent postulates (arrow 1107 from I₃ to A₃) a third agency, A₃, and generates (arrow 1107 from I₃ to E₄) a fourth expected observation, E₄. A transition from the third time instance, t₃, to a next time instance may correlate with an execution (arrow 1108 from A₃ to 1102) of the postulated third agency, A₃, in the ecosystem 1101.

The processes comprising acquiring observations, comparing expected observations and observations, updating metrics, evaluating intents, postulating agencies, executing agencies, and generating expected observations continue from the inception of the entity in the ecosystem 1101 until the retirement of the entity. In an embodiment, the processes may be synchronous (e.g., for a time instance) and continuous with time (e.g., with consecutive time instances), allowing the entity to operate continuously in real time. In an embodiment, the operation of the entity may be in situ; e.g., the entity may operate within ecosystem 1101, generally separated from the ecosystem by boundary 1102. In an embodiment, the operation of the entity in the ecosystem 1101 comprises concurrencies (e.g., simultaneity in general) of at least one of: learning, adapting, novelty processing, exploring, goal setting, task completion, and combination thereof.

In an embodiment, in system 1100, a processor construction is based on an entity's metric (e.g., intelligence metric Mᵢ as an i^{th} metric), among others. The processor construction is of a basis comprising at least one of: adapting in general (e.g., proactive), autonomously updating, proactively learning, aware, autonomously governing (intrinsic governing of, e.g., a simultaneity of operation and learning, amenability, citizenship in general, goals, etc.), and combination thereof. At least one design of the processor is of a basis comprising at least one of: neuromorphic compute, category theoretic compute, quantum compute (of a basis comprising at least one of quantum uncertainty, quantum coherence, quantum superposition, and combination thereof), and combination thereof. The processor comprising metric M evolves with time t (generally at i^{th} time instance, tᵢ, the processor correlates to metric Mᵢ).

In an embodiment, in system 1100, the processes comprising acquiring observations, comparing expected observations and observations, updating metrics, evaluating intents, postulating agencies, executing agencies, and generating expected observations continue from a first inception of the processor (as a part of the entity) in ecosystem 1101 until the corresponding first retirement of the processor from ecosystem 1101. As metric M evolves with time t, so does the processor. The processor and metric M generally represent the entity's ability of a basis comprising at least one of: knowledge, expertise, citizenship (with corresponding, e.g., amenability, inclination, etc.), autonomy, and combination thereof.

Experiences of the metric M (and the processor) comprise observations O and their correlated expected observation E (generally at the i^{th} time instance, tᵢ, observation Oᵢ is observed in the ecosystem and generally compared to the metric's expected observation Eᵢ, which is generated at the (i−1)^{th} time instance, tᵢ₋₁). A quality of comparison between Oᵢ and Eᵢ determines the nature of the learning of the metric (and the processor) and the resulting ability (e.g.; knowledge; expertise; citizenship with corresponding amenability, inclination, etc.; autonomy; etc.) of the metric (and the processor). An acceptable comparison—a better quality match between Oᵢ and Eᵢ-further reinforces a corresponding ability of the processor (e.g.; in neuromorphic architecture: strengthening related synapses, forming new synapse connections, identifying and implementing efficiencies of related signal transmissions, etc.; in category theoretic architecture: strengthening related equivalences, identifying and categorizing related homomorphisms, strengthening related abstractions, etc.; in quantum architecture: tuning quantum coherence in general, tuning related quantum measurements, tuning related qubit abstractions, etc.; etc.). A poor comparison—a worse quality match between Oᵢ and Eᵢ—initiates a higher-order intelligence review (e.g., supervision, exercise of governance, amenability subject to citizenship, etc.) of a related processor ability. The review may result in corrective action of a basis comprising: eliminate or weaken related reinforcements, generate an intent to characterize the poor comparison (e.g., hypothesize, experiment, learn, etc.), proactively seek assistance, acquiesce (e.g., be amenable, compromise to be a citizen, etc.) until successful characterization of the poor comparison, and combination thereof. The corrective action may be correlated to a trigger of a basis comprising at least one of: timeout signal (e.g., from a watchdog timer), missing keepalive signal, loss of heartbeat messages, fail-safe activation (due to, e.g., depletion of provisions below acceptable levels, an activity either too close to or exceeding the limits of an operational domain, identifying a call for help but recognizing at least one inability to render assistance, etc.), setting off a tripwire mechanism (due to, e.g., unidentified phenomenon, malicious action, suspicious configuration, unacceptable uncertainty regarding a default fail-safe, etc.), and combination thereof. In an embodiment, the comparisons may accompany at least one machine learning of a basis comprising at least one of: reinforcement learning, neural network learning, Bayesian network learning, intelligence graph learning, and combination thereof.

The ability of the processor is shaped by the extent, diversity, and quality (e.g., ease and accuracy of observation abstraction) of observations O. The greater the extent, diversity, and quality of at least one first observation, the sounder (more, e.g., accurate, reliable, sensitive, etc.) the ability corresponding to the at least one first observation. A reduction of exposure of the processor to at least one second observation causes a loss of at least one second ability related to the at least one second observation; the reduction of exposure is of a basis comprising at least one of: reduced frequency of occurrence, lack of the at least one second observation (e.g., devoid of their occurrences), inability to observe (e.g., due to lack of sensory capability, lack of observability in general, reduction of observation abstraction quality, forgetting in general, etc.), ignoring the at least one second observation (due to a, e.g., change in goal, citizenship, directive to change priority, etc.), and combination thereof. After the first inception, the processor evolves, due to experiences in the ecosystem, until the first retirement. The evolved processor is altered in its abilities (as compared to the processor at the first inception).

In an embodiment, in system 1100, a first metric is encoded on a first processor and introduced in a first ecosystem. The first metric is subject to a plurality of first observations. At a first time instance t₁, the first metric transforms into a first t₁ metric (e.g., an altered first metric), and correspondingly the first processor transforms into a first t₁ processor. The first t₁ metric is copied (e.g., cloned, duplicated, utilized in transfer learning, etc.) to a second metric on a second processor. The first t₁ metric is further subject to the plurality of first observations. At a second time instance t₂, the first t₁ metric transforms into a first t₂ metric. Correspondingly the first t₁ processor is transformed into a first t₂ processor. Due to increased exposure to the plurality of first observations, the first t₂ metric's one or more ability (e.g., expertise, knowledge, etc.) improves as compared to the second metric. The first t₂ processor is superior (more, e.g., effective, efficient, viable, etc.) to the second processor in the first ecosystem, and the first t₂ metric is superior (with better quality, e.g., expertise, citizenship, autonomous proactiveness, awareness, intent, higher-order intelligence, etc.) to the second metric in the first ecosystem.

Further, a third metric is encoded on a third processor and introduced in a third ecosystem. The third metric is subject to a plurality of third observations of the third ecosystem. At a third time instance t₃, the third metric transforms into a third t₃ metric. Correspondingly, the third processor transforms into a third t₃ processor. The third t₃ processor is superior to its prior version, the third processor in the third ecosystem. The third t₃ metric is superior to its prior version, the third metric in the third ecosystem.

A fourth processor comprising a fourth metric is designed and fabricated by combining (e.g., transforming together, genetically converging together, merging, generatively converging, sampling together, etc.) the first t₂ metric and the third t₃ metric. The fourth processor is introduced in a fourth ecosystem comprising the first ecosystem and the third ecosystem. In the fourth ecosystem, the fourth metric is superior to a newly created (e.g., recently introduced to the ecosystem, having processed no observations, having processed few observations, etc.) fifth metric on a fifth processor. The fourth processor is superior to the fifth processor for operations in the fourth ecosystem.

In an embodiment, for system 1100, a first activity of an entity comprises acquiring observations, comparing expected observations and observations, updating metrics, and generating expected observations (e.g., postulating), and may be regarded as learning of the entity in an ecosystem. A second activity of the entity comprises acquiring observations, evaluating intents, postulating agencies, executing agencies, and generating expected observations, and may be regarded as an operation (e.g., in pursuit of a goal, subject to a purpose, etc.) of the entity in the ecosystem. A third activity of the entity comprises novelty processing comprising at least one of: monitoring, identifying, learning, categorizing, balancing intent and agency (e.g., limiting scopes of intents to generally match an ability comprising an agency, defining and conceiving intents, defining and conceiving agencies to meet the scope of an intent in general, etc.), and combination thereof regarding the novelties. In an embodiment, a simultaneity (e.g., concurrency of two or more processes) of a basis comprising at least one of: the first activity, the second activity, the third activity, and combination thereof contributes to general intelligence of the entity and resiliency (e.g., fault tolerance, sustainability, longevity, etc.) of operation and activity in general, wherein the entity may be regarded as a citizen of the ecosystem at par with humans in the ecosystem. In an embodiment, the entity is an AV with general intelligence, wherein the AV may drive and function, in general, at par with a human driver.

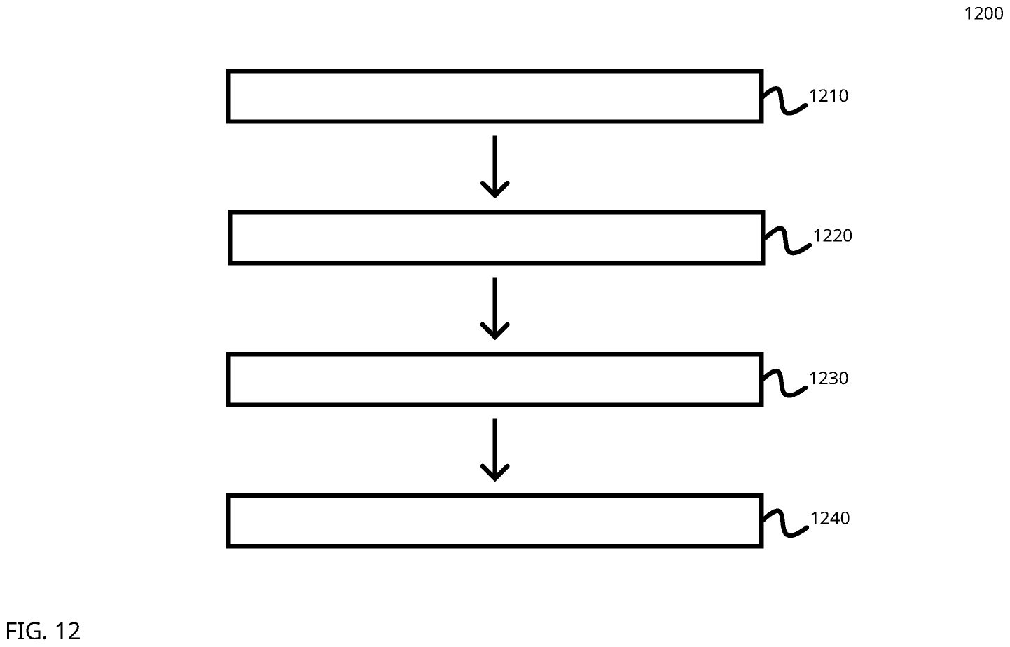

FIG. 12 illustrates a method 1200 in accordance with an embodiment of the present application. In certain embodiments, method 1200 may correspond to the processes described with reference to FIGS. 1-11 and FIGS. 13-24.
a. At block 1210, method 1200 includes receiving at least one first observation regarding at least one operational domain subject to at least one real-world challenge comprising randomness uncertainty and knowledge uncertainty.
b. At block 1220, method 1200 includes processing the received at least one first observation, the processing comprising an exercise of at least one first higher order intelligence, wherein the exercise of the at least one first higher-order intelligence is of a basis comprising intrinsic and autonomously proactive.
c. At block 1230, method 1200 includes postulating, based on the processed at least one first observation, at least one first agency.
d. At block 1240, method 1200 includes executing the postulated at least one first agency, wherein executing the postulated at least one first agency enables at least one first operation in the at least one operational domain.

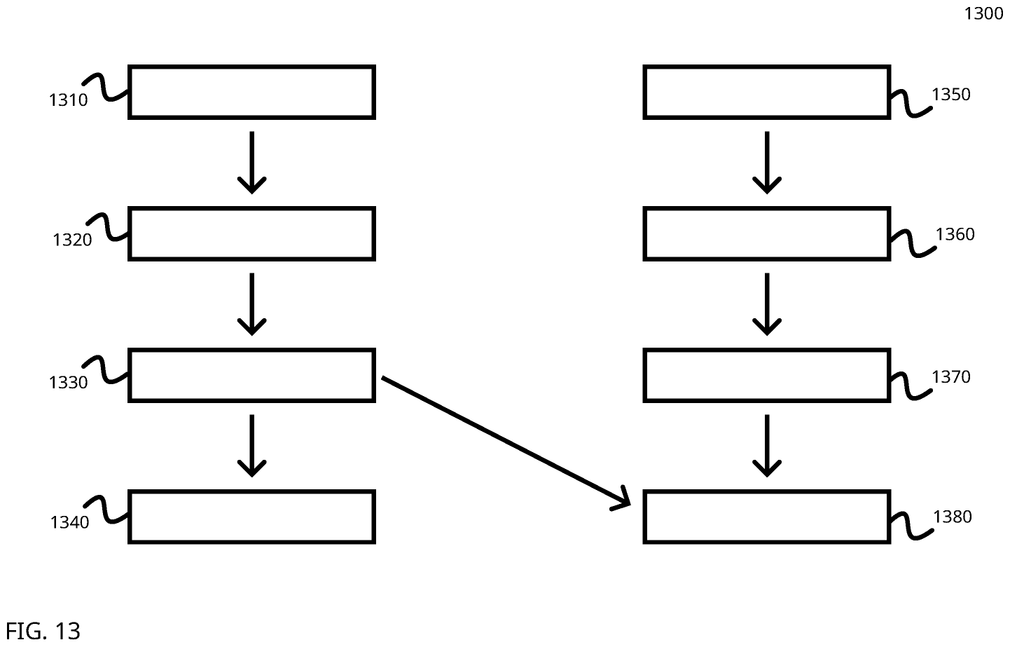

FIG. 13 illustrates a method 1300 in accordance with an embodiment of the present application. In certain embodiments, method 1300 may correspond to the processes described with reference to FIGS. 1-12 and FIGS. 14-24.
a. At block 1310, method 1300 includes receiving at least one first observation.
b. At block 1320, method 1300 includes processing the received at least one first observation.
c. At block 1330, method 1300 includes generating, based on the processed at least one first observation, at least one first intelligence.
d. At block 1340, method 1300 includes verifying, based on the generated at least one first intelligence, at least one first intractability.
e. At block 1350, method 1300 includes receiving at least one second observation.
f. At block 1360, method 1300 includes processing the received at least one second observation.
g. At block 1370, method 1300 includes generating, based on the processed at least one second observation, at least one second intelligence.
h. At block 1380, method 1300 includes gaining, based on at least one third intelligence comprising the at least one first intelligence and the at least one second intelligence, a first insight.

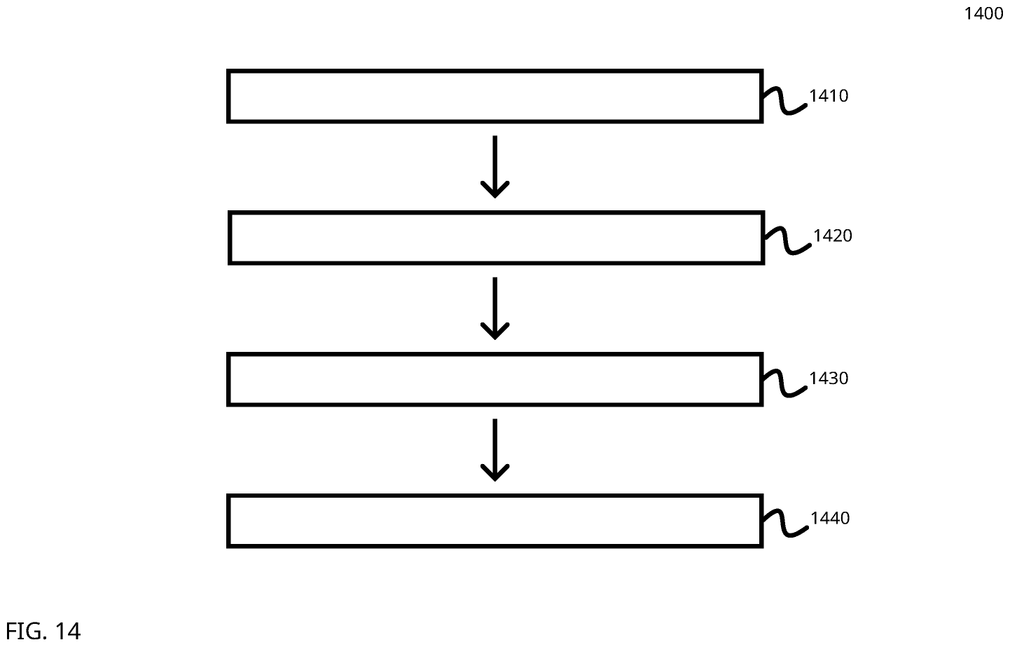

FIG. 14 illustrates a method 1400 in accordance with an embodiment of the present application. In certain embodiments, method 1400 may correspond to the processes described with reference to FIGS. 1-13 and FIGS. 15-24.
a. At block 1410, method 1400 includes monitoring a first domain.
b. At block 1420, method 1400 includes detecting, based on the monitored first domain, at least one first novelty.
c. At block 1430, method 1400 includes processing the detected at least one first novelty, wherein processing the detected at least one first novelty is of a basis comprising intrinsic and autonomously proactive.
d. At block 1440, method 1400 includes learning, based on the processed at least one first novelty, at least one first expertise.

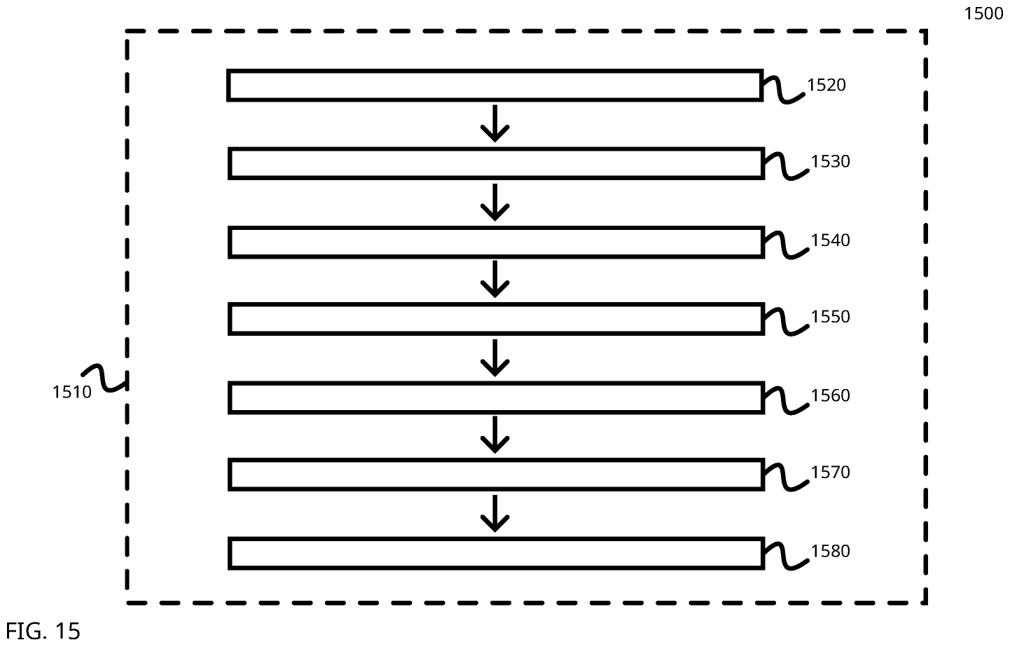

FIG. 15 illustrates a method 1500 in accordance with an embodiment of the present application. In certain embodiments, method 1500 may correspond to the processes described with reference to FIGS. 1-14 and FIGS. 16-24.
a. At block 1510, method 1500 includes exercising at least one first simultaneity of at least one first operation and at least one first learning.
b. At block 1520, method 1500 includes receiving at least one first observation.
c. At block 1530, method 1500 includes processing the received at least one first observation.
d. At block 1540, method 1500 includes postulating, based on the processed at least one first observation, at least one first intelligence constituent comprising at least one first agency and at least one second expected observation.
e. At block 1550, method 1500 includes executing the postulated at least one first agency.
f. At block 1560, method 1500 includes receiving, based on the executed at least one first agency, at least one second observation.
g. At block 1570, method 1500 includes comparing the postulated at least one second expected observation and the at least one second observation.
h. At block 1580, method 1500 includes updating, based on the comparison of the postulated at least one second expected observation and the at least one second observation, at least one intelligence, wherein updating the at least one intelligence and executing the postulated at least one first agency cause the at least one first simultaneity and enable an ability of a basis comprising at least one of: persistence, improvement, gain, fault tolerance, homeostasis, and combination thereof.

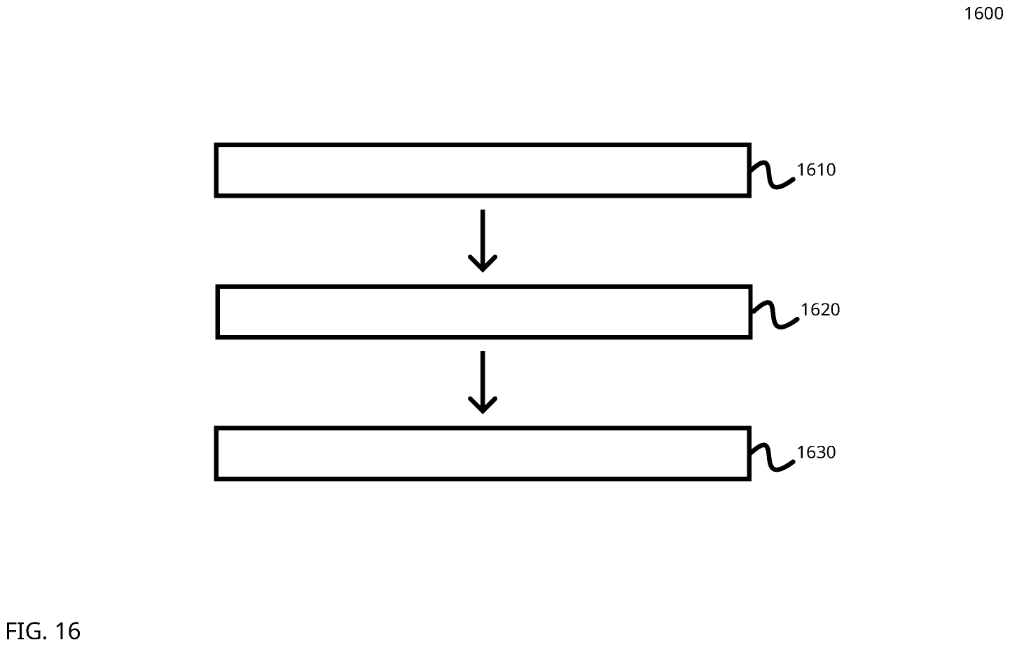

FIG. 16 illustrates a method 1600 in accordance with an embodiment of the present application. In certain embodiments, method 1600 may correspond to the processes described with reference to FIGS. 1-15 and FIGS. 17-24.
a. At block 1610, method 1600 includes abstracting at least one first information structure into at least one second information structure.
b. At block 1620, method 1600 includes comprehending at least one third information structure of a basis comprising at least one constituent of the at least one first information structure and the at least one second information structure.
c. At block 1630, method 1600 includes overcoming, based on the comprehended at least one third information structure, at least one real-world challenge comprising randomness uncertainty and knowledge uncertainty.

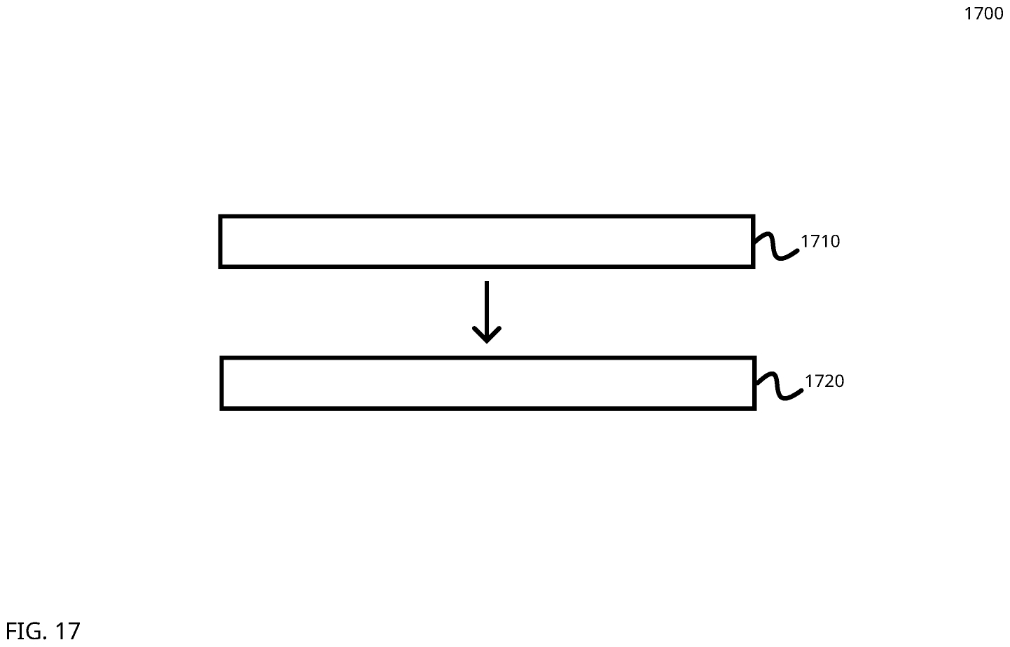

FIG. 17 illustrates a method 1700 in accordance with an embodiment of the present application. In certain embodiments, method 1700 may correspond to the processes described with reference to FIGS. 1-16 and FIGS. 18-24.
a. At block 1710, method 1700 includes exercising at least one general intelligence, wherein exercising the at least one general intelligence is of a basis comprising intrinsic and autonomously proactive.
b. At block 1720, method 1700 includes exercising, based on the exercised at least one general intelligence, at least one autonomy regarding at least one operational domain subject to at least one real-world challenge comprising randomness uncertainty and knowledge uncertainty.

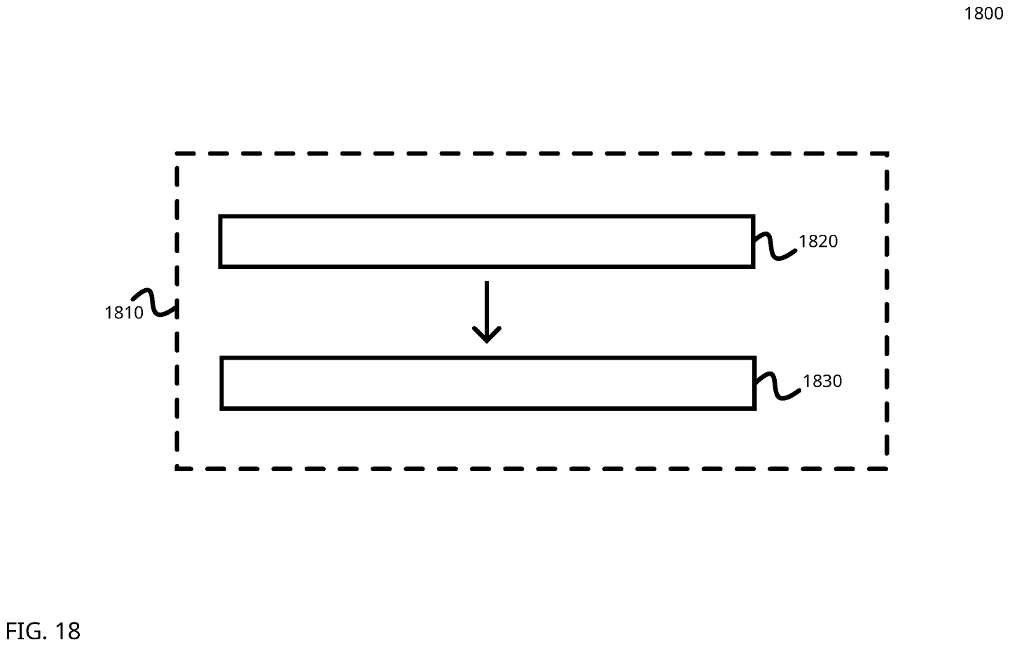

FIG. 18 illustrates a method 1800 in accordance with an embodiment of the present application. In certain embodiments, method 1800 may correspond to the processes described with reference to FIGS. 1-17 and FIGS. 19-24.
a. At block 1810, method 1800 includes exercising at least one first citizenship of one entity.
b. At block 1820, method 1800 includes exercising one intrinsic intelligence of the one entity, wherein the one intrinsic intelligence is of a basis comprising autonomously proactive and wherein exercising the one intrinsic intelligence is further of a basis comprising: adaptation, operation, and learning.
c. At block 1830, method 1800 includes gaining, based on the exercised one intrinsic intelligence, an improvement of a basis comprising the at least one first citizenship.

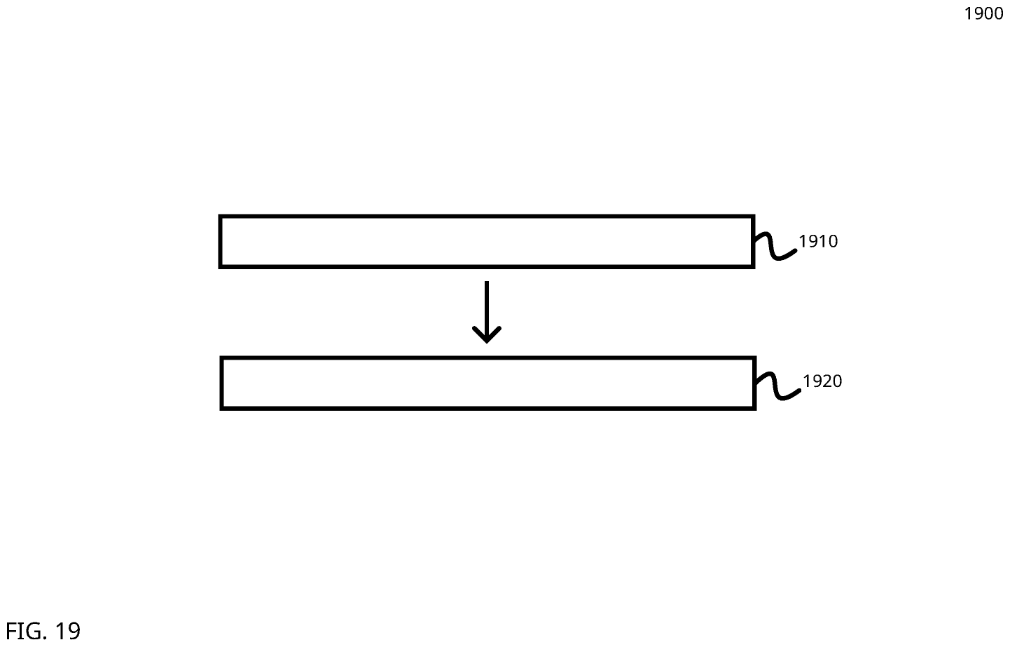

FIG. 19 illustrates a method 1900 in accordance with an embodiment of the present application. In certain embodiments, method 1900 may correspond to the processes described with reference to FIGS. 1-18 and FIGS. 20-24.
a. At block 1910, method 1900 includes executing at least one instruction of a basis comprising at least one equivalence of at least one awareness to at least one category theoretic morphism.
b. At block 1920, method 1900 includes exercising, based on the executed at least one instruction, at least one category theoretic intelligence.

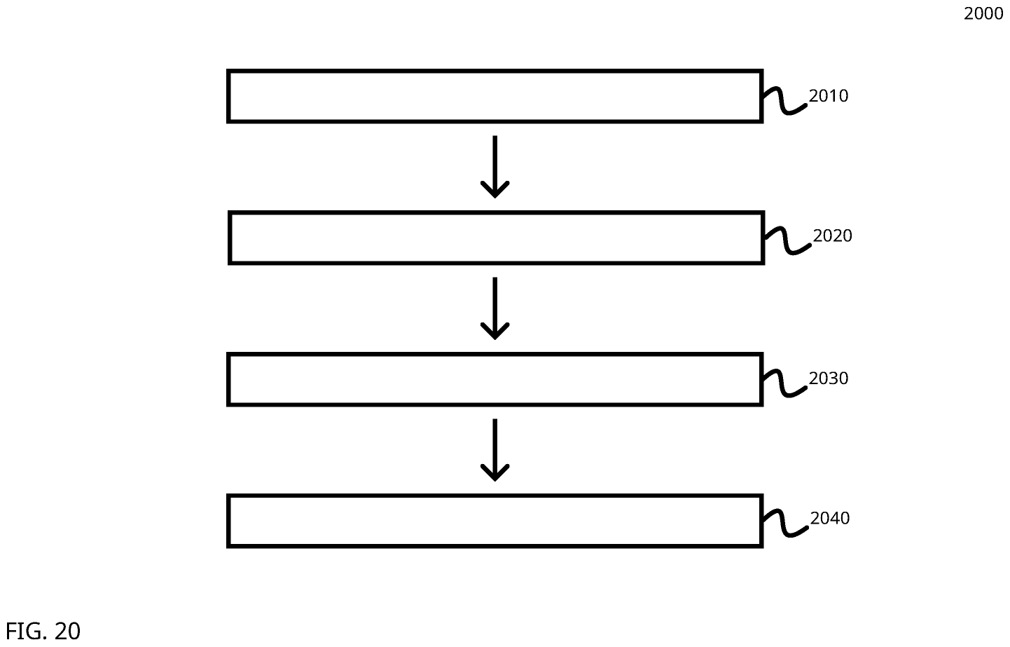

FIG. 20 illustrates a method 2000 in accordance with an embodiment of the present application. In certain embodiments, method 2000 may correspond to the processes described with reference to FIGS. 1-19 and FIGS. 21-24.
a. At block 2010, method 2000 includes receiving at least one first observation.
b. At block 2020, method 2000 includes processing the received at least one first observation.
c. At block 2030, method 2000 includes generating, based on the processed at least one first observation, at least one first ecosystem constituent.
d. At block 2040, method 2000 includes processing at least one FPM (functional performance measure) to: compare the at least one first ecosystem constituent against at least one first administrator's at least one expectation; evaluate, from the at least one FPM and the comparison of the at least one first ecosystem constituent against the at least one first administrator's at least one expectation, at least one first metric; and provide the evaluated at least one first metric to at least one first entity.

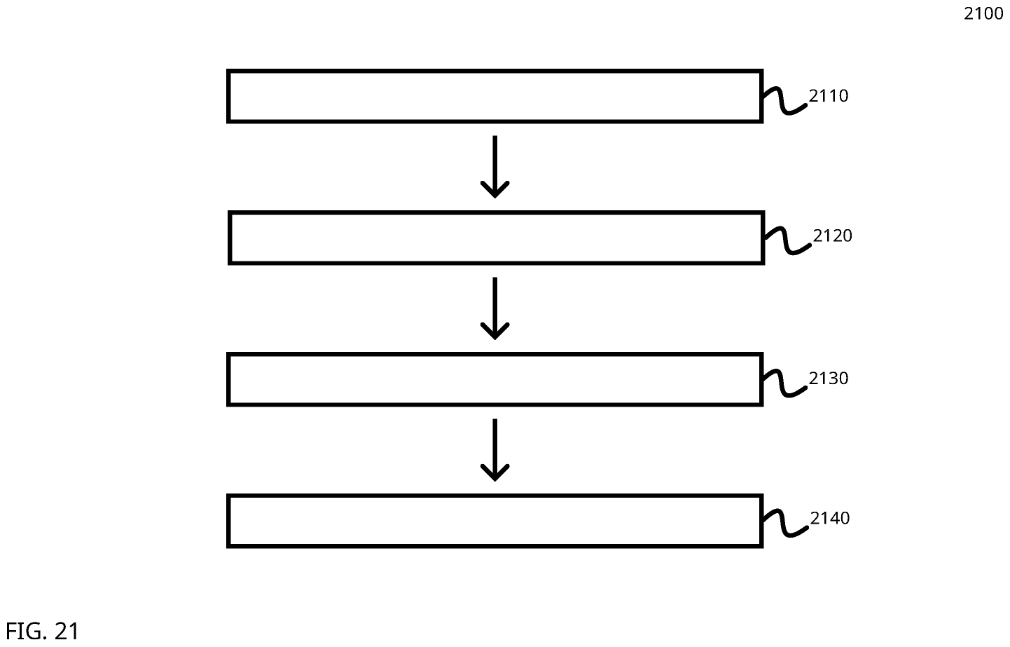

FIG. 21 illustrates a method 2100 in accordance with an embodiment of the present application. In certain embodiments, method 2100 may correspond to the processes described with reference to FIGS. 1-20 and FIGS. 22-24.
a. At block 2110, method 2100 includes receiving at least one observation.
b. At block 2120, method 2100 includes processing the received at least one observation.
c. At block 2130, method 2100 includes detecting, based on the processed at least one observation, at least one corruption of a basis comprising forgetting.
d. At block 2140, method 2100 includes identifying, based on the detected at least one corruption, at least one corrupted intelligence constituent.

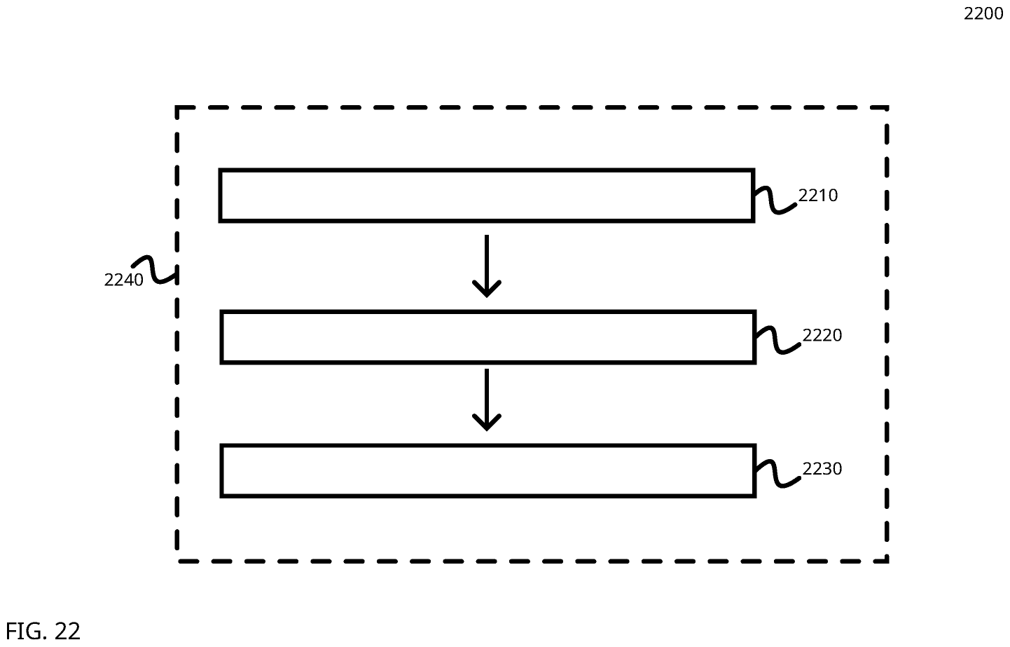

FIG. 22 illustrates a method 2200 in accordance with an embodiment of the present application. In certain embodiments, method 2200 may correspond to the processes described with reference to FIGS. 1-21 and FIGS. 23-24.
a. At block 2210, method 2200 includes exercising at least one autonomy.
b. At block 2220, method 2200 includes overcoming, based on the exercised at least one autonomy, at least one complexity.
c. At block 2230, method 2200 includes verifying at least one viability of overcoming the at least one complexity.
d. At block 2240, method 2200 includes operating in at least one operational domain subject to at least one real-world challenge comprising randomness uncertainty and knowledge uncertainty.

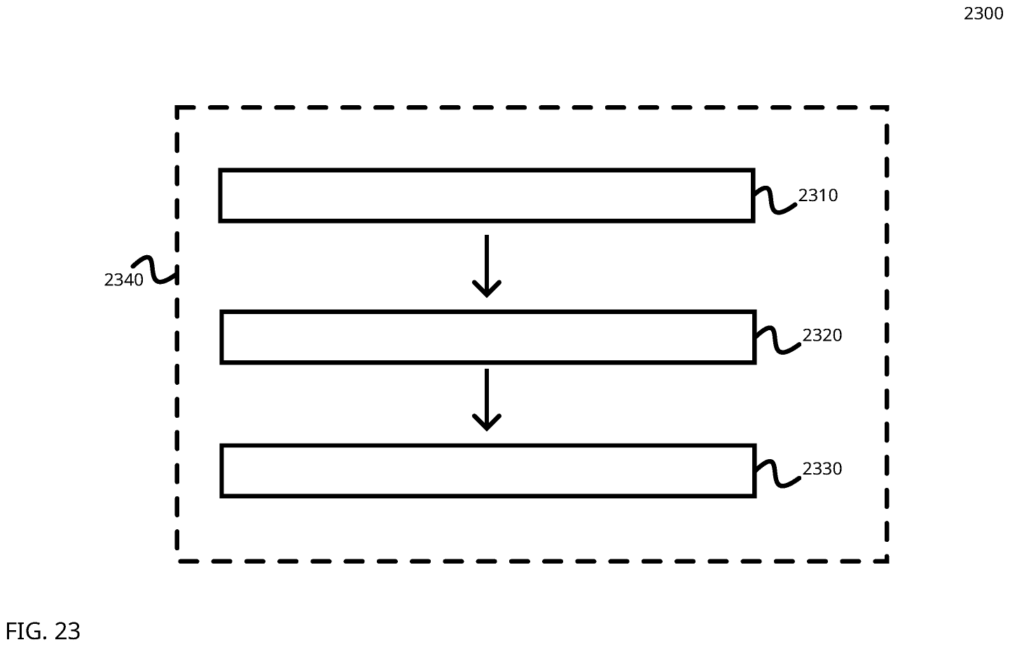

FIG. 23 illustrates a method 2300 in accordance with an embodiment of the present application. In certain embodiments, method 2300 may correspond to the processes described with reference to FIGS. 1-22 and FIG. 24.
a. At block 2310, method 2300 includes exercising at least one autonomy.
b. At block 2320, method 2300 includes detecting, based on the exercised at least one autonomy, at least one emergence.
c. At block 2330, method 2300 includes verifying at least one viability of the detected at least one emergence.
d. At block 2340, method 2300 includes operating in at least one operational domain subject to at least one real-world challenge comprising randomness uncertainty and knowledge uncertainty.

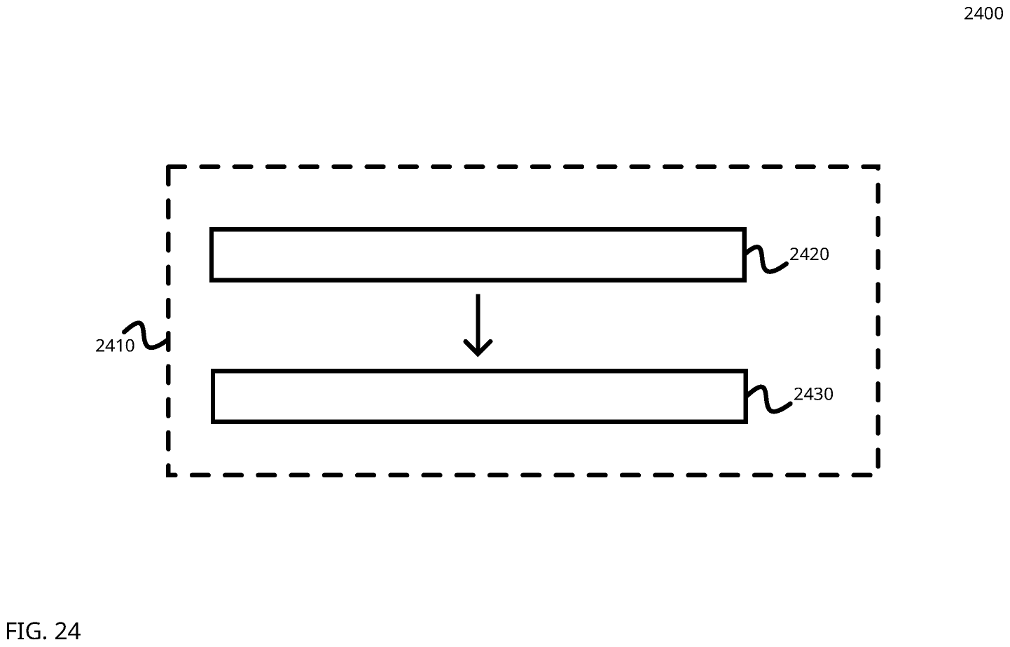

FIG. 24 illustrates a method 2400 in accordance with an embodiment of the present application. In certain embodiments, method 2400 may correspond to the processes described with reference to FIGS. 1-23.
a. At block 2410, method 2400 includes persisting at least one first attention of one entity;
b. At block 2420, method 2400 includes exercising one intrinsic intelligence of the one entity,
   wherein the one intrinsic intelligence is of a basis comprising autonomously proactive
   and wherein exercising the one intrinsic intelligence is of a basis comprising:
      at least one equilibrium of a plurality of intelligence constituents;
      and adaptation of a basis comprising agency, observation, and intelligence processing;
c. At block 2430, method 2400 includes gaining, based on the exercised one intrinsic intelligence, an improvement of a basis comprising the at least one first attention and persisting the at least one first attention.

### Recursive Ecosystems and Entities as Ecosystems

In an embodiment, a general intelligence in an ecosystem may be a synergistic property of the ecosystem's two or more constituents of a basis comprising at least one of: entity, swarm (with, e.g., an ability of a basis comprising at least one of: sensing, perception, lower-order intelligence, higher-order intelligence, awareness, intent, constituents of an intent, agency in general, goal, and combination thereof), swarming, artifact, system, tool, accessory, device, hierarchy in general, and combination thereof. The synergistic property is of a basis comprising at least one of: distributed, centralized, hierarchical, opportunistic, accidental (e.g., adhoc), intentional, unintentional, symbiotic, cooperative, competitive, adversarial, reciprocal, nonreciprocal, complementary, non-complementary, complex, emergent, and combination thereof.

In an embodiment, at least one interaction (e.g., synergy, operation, functioning, etc.) of at least two constituents of a first ecosystem contributes to a general intelligence as an emergent property of the first ecosystem. The first ecosystem may be, e.g., a mammal, an automaton, an autonomous vehicle, etc., wherein the general intelligence may emerge due to a synergistic interplay of constituents of the first ecosystem. In an embodiment, the first ecosystem (e.g., a vehicle) is a constituent entity of a second ecosystem (larger than the first ecosystem, e.g., a fleet of vehicles; a system of vehicles, infrastructures, and command-and-control; etc.). In an embodiment, at least one constituent of the first ecosystem may be regarded as a consequential constituent of the second ecosystem. For example, a dead mammal's body may represent a consequential artifact of a second ecosystem. A live mammal's body with the live mammal's intelligence—jointly representing a first entity in the second ecosystem—may be a consequential entity of the second ecosystem. Further, the second ecosystem may be a constituent of at least one fourth ecosystem, and at least one third ecosystem may be at least one constituent of the first ecosystem. A network (e.g., a chain) of dependence among the at least one third ecosystem, the first ecosystem, the second ecosystem, and the at least one fourth ecosystem is generally referred to as recursive ecosystem dependence and recursive ecosystems in general. The network is an example and representation of recursion of ecosystems in general.

In an embodiment, two or more ecosystems in a first recursive dependence of ecosystems represent two or more entities that are recursively dependent—a second recursive dependence of entities. The first recursive dependence of ecosystems (first recursive ecosystems) may also be represented by the second recursive dependence of entities (second recursive entities). The second recursive dependence of entities may be represented by a third recursive dependence of intelligence (third recursive intelligences) of, e.g., the two or more entities.

In an embodiment, an AV with a general intelligence may be considered a first recursive ecosystem comprising a plurality of second ecosystems—a guidance system, a system of sensor arrays, a steering control system, a communication system, etc. Furthermore, the AV itself may be a constituent entity of a third recursive ecosystem (e.g., a fleet). In an embodiment, the communication system—apart from being a member of the plurality of second ecosystems—is a member of a regional communications network—a fourth recursive ecosystem. A network of the first recursive ecosystem, the third recursive ecosystem, the plurality of second ecosystems, and the fourth recursive ecosystem represents a recursive network of ecosystems (also referred to as “network of ecosystems” in general) that may be related to a recursive network of entities (also referred to as “network of entities” in general) and may form a recursive network of intelligences (also referred to as “network of intelligences” in general). Networks (e.g., networks of ecosystems, networks of entities, and networks of intelligences) may form due to relationships of a basis comprising at least one of: distributed, centralized, hierarchical, opportunistic, accidental (e.g., ad hoc), intentional, unintentional, symbiotic, cooperative, competitive, adversarial, reciprocal, nonreciprocal, complementary, non-complementary, complex, emergent, and combination thereof.

In an embodiment, in an ecosystem comprising a first recursive intelligence of a swarm of a plurality of first entities (e.g., as swarm of birds as a collection of individual bird's intelligence) and a second recursive intelligence of a herd of a plurality of second entities (e.g., as a herd of wildebeest as a collection of individual wildebeests' intelligence), the swarm and the herd may in unison respond to a scenario (representing, e.g., a threat), wherein a third intelligence of the ecosystem is an emergent property that is dependent on the first recursive intelligence of the swarm and the second recursive intelligence of the herd. The third intelligence of the ecosystem may be a synergistic (e.g., the whole is better than accumulation of the parts) improvement (e.g., for the swarm and the heard) over a combination of the first recursive intelligence of the swarm and the second intelligence of the herd. The third intelligence of the ecosystem may further cause emergence of a synergistic property of the ecosystem. The synergistic property comprises at least one of: a stable state of the ecosystem (e.g., the ecosystem may respond to and compensate for changes to maintain the state), evolution of the state, evolution in general, homeostasis in general, recursive agency, synergistic composition of two or more agencies, collaboration, collaborative trust, trust in general, and combination thereof.

In certain embodiments, the term “entity” generally refers to a living being or an intelligent agent (e.g., intelligent machines, embodied intelligence, embodied AI, embodied higher-order intelligence of a basis comprising at least one of citizenship, homeostasis, maintaining homeostasis, and combination thereof, embodying may be virtual, physical, distributed, etc.), with or without one or more external device that may enhance an ability of the living being or the intelligence agent (e.g., the ability may be to communicate, to generally interact, etc.). In certain embodiments, at least one entity may represent at least one observer in general. In certain embodiments, an entity may represent an autonomous system, e.g., AI, swarm, swarm AI, part biological and part artificial, modified (augmented, altered, improved, etc.) biological, etc. In certain embodiments, an administrator may be of a basis comprising at least one of: entity, system, device, ecosystem, intelligence in general, and combination thereof. In an embodiment, in a recursive dependence of a plurality of intelligences, at least one of the plurality of intelligences may be an administrator of the recursive dependence. For example, for a first ecosystem recursively dependent on a second ecosystem, wherein the second ecosystem is larger than the first ecosystem and wherein the first ecosystem may be regarded as an entity in the second ecosystem, the first ecosystem (e.g., as an entity) may be an administrator of the first ecosystem and the second ecosystem.

In an embodiment, an autonomous vehicle (AV) may operate at varying degrees of autonomy. As an example of full autonomy, the AV accomplishes a plurality of driving tasks in most circumstances, generally at par with a human driver. An administrator does not need real-time oversight and continuous control of operations of the AV, e.g., an occupant may be a passenger of the AV and may not be involved in driving. In an embodiment, an AV may refer to a system for transportation of a basis comprising at least one of: land-based, aquatic, aerial, upper atmospheric, space-based, and combination thereof.

In certain embodiments, intelligence refers generally to a term of a basis comprising at least one of: process, product, phenomenon, metric, system, method, application (e.g., that is conceived, experimented with, developed, reduced to practice in general, etc., regarding, e.g., an autonomous vehicle, an intelligent infrastructure with at least one autonomy, an autonomous intelligent grid, an autonomous robot, an autonomously proactive entity in general, intelligent social agents, banking and finance, healthcare, etc.), abstraction (e.g., social abstraction), and combination thereof. Generally, the basis of the term is understood from at least one context of the term unless otherwise specified.

In certain embodiments, intelligence constituent (e.g., “perception”, “awareness”, “intent”, “autonomous proactiveness”, “lower-order intelligence”, “narrow intelligence”, “higher-order intelligence”, and “intelligence”) refers generally to a term of a basis comprising at least one of: process, product, phenomenon, metric, system, method, application (e.g., that is conceived, experimented with, developed, reduced to practice in general, etc., regarding, e.g., an autonomous vehicle, an intelligent infrastructure with at least one autonomy, an autonomous intelligent grid, an autonomous robot, an autonomously proactive entity in general, intelligent social agents, banking and finance, healthcare, etc.), abstraction (e.g., social abstraction), and combination thereof. Generally, the basis of the term is understood from at least one context of the term unless otherwise specified.

In certain embodiments, artificial intelligence and contexts thereof refer to machine intelligence; within an artificial intelligence context, a machine constituent of intelligence refers generally to a constituent of artificial intelligence. For example, for a machine intelligence (e.g., AI), machine awareness, machine intent, machine perception, machine lower-order intelligence, machine higher-order intelligence, and machine general intelligence refer generally to awareness, intent, perception, lower-order intelligence, higher-order intelligence, and general intelligence, respectively, regarding the machine intelligence.

In certain embodiments, a constituent of intelligence is of a basis comprising at least one of: perception (e.g., by sensing, observing, etc.), awareness, intent, lower-order intelligence, higher-order intelligence, and combination thereof. In general, constituents of intelligence interact and are interrelated. At least one first constituent of at least one first intelligence may be transformed (e.g., altered, reinterpreted, realigned, reformulated, etc.) into at least one second constituent of at least one second intelligence. Similar to intelligence, intelligence constituent refers generally to a term of a basis comprising at least one of: metric, system, method, application (e.g., that is conceived, reduced to practice, etc.), and combination thereof.

In certain embodiments, an emergence of at least one homeostasis is of a basis comprising synergistic, epiphenomenal, irreplicable, and combination thereof, wherein at least one homeostasis may correlate to at least one attention. In certain embodiments, at least one inclination (e.g., predisposition, predilection, tendency in general, etc.) is an intelligence feature of a basis comprising at least one of emergent, epiphenomenal, irreplicable, and combination thereof. In an embodiment, attention and inclination (for, e.g., citizenship, governance, foundations, etc.) are simulated (e.g., as algorithms, by encoding, etc.) for a domain that is known apriori and generally well understood; however, upon introduction to a real-world ecosystem (subject to, e.g., uncertainties, novelties, intractabilities, etc.), the simulated attention and inclination may be rendered ineffective, counterproductive, and contraindicated (for, e.g., citizenship, governance, foundations, etc.) due to a lack of a basis comprising at least one of: awareness, intent, abstraction, general knowledge, common sense, and combination thereof.

In an embodiment, at least one inclination (and at least one attention) of an automated cleaning robot may be simulated to: monitor for a distribution of unknown particles on a floor (e.g., dirt), postulate at least one agency to collect and dispose the particles (e.g., to make a plan to clean the dirt), and execute the at least one agency (e.g., to clean the dirt). A person lays out a partially assembled puzzle with a distribution of unassembled puzzle pieces around it (an intentional arrangement), leaving the intentional arrangement unattended overnight. The robot follows through on the simulation (e.g., for monitoring, postulating, and executing) to collect and dispose the unassembled puzzle pieces (e.g., interpreting them as a random distribution of particles on the floor). The robot is devoid of citizenship and lacks governance despite the simulated at least one inclination (and the simulated at least one attention), generally due to a lack of a basis comprising at least one of: awareness, intent, abstraction, general knowledge, common sense, and combination thereof. The simulated at least one inclination and the simulated at least one attention are contraindicated for operations in real-world ecosystems.

In an embodiment, a narrow AI is ascribed a predetermined set of abstractions and their rules (e.g., simulated and generally predetermined inclination and attention) by its creator. The narrow AI generally lacks an ability to deviate from the abstractions or their rules. The narrow AI may reactively fail when subject to an unanticipated (e.g., not anticipated by the creator) scenario. A higher-order intelligence may at least recognize (e.g., due to autonomous proactiveness based on an awareness) the lack of available abstraction for an unanticipated scenario, deliberate an inability to operate in the scenario, enact a fail-safe (e.g., withdraw safely), preserve homeostasis, and exercise citizenship. The narrow AI forces an available abstraction (e.g., based on the creator's rules) irrespective of the damage that may be caused by exercising the available abstraction in the unanticipated scenario.

Generally, entities observing a narrow AI (e.g., other entities operating alongside the narrow AI) may perceive the activities of the narrow AI as reactive (with, e.g., reactive control), reflexive (e.g., merely responding to immediate stimuli), and shallow (e.g., without prudent considerations for its actions). On the other hand, entities observing a first entity with higher-order intelligence (e.g., other entities operating alongside the first entity) may perceive the activities of the first entity as deliberate (e.g., with deliberative control), operating on deliberative time scales, and generally prudent.

In an embodiment, citizenship is an inclination towards and an attention to a homeostasis for a purpose of a basis comprising at least one of: preserving homeostasis, attaining homeostasis, defending homeostasis, and combination thereof. In an embodiment, governance is, in general, overseeing a plurality of causes and effects (in, e.g., ecosystems, behaviors, intentions, plans, goals, interactions in general, social objectives, etc.) of a basis comprising at least one of: activity, agency, observation, postulations, executions, operation in general, learning in general, and combination thereof with attention to and inclination towards citizenship of a basis comprising at least one of: homeostasis, equilibriums, ecosystems, social (regarding, e.g., social abstraction), communities, foundations (e.g., of a basis comprising at least one of imperatives, directives, mandates, and combination thereof), welfare in general, and combination thereof.

In an embodiment, for an entity, at least one attention (e.g., focus) may be a composite of a plurality of constituents of intelligence. In general, an attention of a first entity may be of a basis comprising at least one of: higher-order intelligence, subjective features of the first entity, awareness of the attention by the first entity, and combination thereof. This attention of the first entity is subjective to the first entity, e.g., at least one second entity generally lacks an awareness of the attention, at least one third entity may gain a sense of the attention by inference (e.g., as a weak awareness, by hypothesizing, by weak inference, by limited verification, based on a prior, etc.), at least one fourth entity may gain a sense of the attention by communication with the first entity, and combination thereof, among others. In certain embodiments, a first awareness (of a first entity) of an attention of the first entity may be the only indication of the attention. Communicating and conveying the first awareness (e.g., by the first entity) may be the only way to justify the existence of the attention and a second entity gaining a second awareness (e.g., a strong awareness) of the attention.

In certain embodiments, information (e.g., observation, prediction, explanation, etc.), and agency (e.g., sensory input/output, action input/output, etc.) may be regarded as input to and output of at least one intelligence (e.g., input/output of a metric, etc.). In general, expertise (e.g., skill) may be an ability (e.g., generally a proficiency) of a basis comprising at least one of knowledge, agency, insight, adaptation, and combination thereof.

In an embodiment, for a first intelligence in general, general AI, artificial general intelligence, cognitive AI, strong AI, wholistic AI, holistic AI, and related types of AI may be regarded as variations of an AI term of a basis comprising at least one of: convention (e.g., a comfort level of a beneficiary, user, etc.), fitness for service, fitness in general, extent of capability, ability in general, and combination thereof. In an embodiment, the first intelligence is regarded as a general intelligence. In certain embodiments, a general intelligence may refer to an intelligence of a basis comprising at least one of: at least one higher-order intelligence; an emergent intelligence; an intelligence of an entity as a whole, generally equivalent to a human intelligence; and combination thereof.

In certain embodiments, the term “metric” generally refers to a structure (e.g., of information) composed for processing information (e.g., exercising information structures). The structure and the composition thereof may be of a basis comprising at least one of: mathematical (e.g., algebraic, category theoretic, inferential, etc.), algorithmic (e.g., type theoretic, logical in general, etc.), information theoretic in general, measuring in general (e.g., a system for measuring, a method for measuring, etc.), and combination thereof. The structure and the composition thereof may evaluate input and incident information into a quantitative construct of a basis comprising at least one of: intelligence; intelligence constituents (e.g., awareness, intent, agency, lower-order intelligence, higher-order intelligence, etc.); measure (e.g., evaluation of a measure, validation of a criteria, etc.); comparison in general; and combination thereof. In an embodiment, a metric of an entity, by exercising information structures, may perform an activity (e.g., operate, learn, etc.) of a basis comprising at least one of: intelligence; intelligence constituents in general; higher-order abilities (e.g., citizenship, abilities regarding homeostasis, social abilities, explaining, communicating, amenability, attention, inclination, autonomous proactiveness, homeostasis, etc.); realizing (e.g., making, gaining, attaining efficiencies, etc.) improvements; expertise; skills; abilities in general; simultaneity in general (e.g., attaining simultaneity of operation and learning); abstracting (e.g., changing perspectives, recasting setups, etc.); overseeing in general; governance; supervision; and combination thereof.

In certain embodiments, in general, a higher-order feature—a first n^{th} order feature—may be of a basis comprising at least one of: a reference to a second n^{th} order feature; a reference to a first abstraction of at least one third (n−1)^{th} order feature; a reference to at least one second abstraction of a plurality of fourth i^{th} order features, wherein i<n; and combinations thereof. The inequality i<n is indicated by a sequence of integers up to n—e.g., 0, 1, 2, . . . , (i−1), i, (i+1), . . . , (n−2), (n−1), n—wherein i formulates (e.g., generally references) an order of an i^{th} order feature (e.g., generally derived from an i^{th} level abstraction of generally an (i−1)^{th} order feature). In an embodiment, a feature (e.g., the first n^{th} order feature, the second n^{th} order feature, the at least one third (n−1)^{th} order feature, the plurality of fourth i^{th} order features, and the higher-order feature) generally refers to: metric, intelligence, intelligence constituents (e.g., awareness, intent, etc.), observation, agency, citizenship, amenability, attention, inclination, goal in general, autonomous proactiveness in general, embodied motivation (e.g., as a higher-order abstraction of a basis comprising at least one of: autonomous proactiveness, goals, intents, awareness, citizenship, homeostasis in general, and combination thereof), homeostasis in general, ecosystem in general, domain in general, operation in general, scenario in general, event in general, or combination thereof, among others. Abstractions (e.g., the first abstraction, the at least one second abstraction, the i^{th} level abstraction, etc.) are of a basis comprising at least one of: simplification, generalization, category theory (e.g., of a basis comprising at least one of homology, cohomology, type theory, higher categories in general, representation theory, and combination thereof), convention (based on, e.g., consensus, social acceptance, viability related to a social abstraction, etc.), recasting to change perspective, and combination thereof.

In an embodiment, a higher-order metric is generally a metric of metrics (e.g., generally a single metric representing a plurality of lower-order metrics). In an embodiment, a higher-order metric (for, e.g., higher-order intelligence; general intelligence; cognition in general; categories, e.g., higher categories in general; complex systems and methods; emergent systems and methods; etc.) comprises:
a. an input-output abstraction comprising at least one map of input to output (accounting for, e.g., dimensionality, unknowns, confounders and hidden variables in general, etc.);
b. a computation abstraction comprising at least one specification of transformations from input to output (e.g., algorithms; structural transformations in, e.g., representation theory, category theory, homology, cohomology, etc.; considerations overriding the algorithms in exercising, e.g., conventions, social acceptability, idiosyncrasies, etc.; etc.); and
c. an implementation abstraction comprising at least one specification for implementations (e.g., of a basis comprising at least one of: putting to real-world use, reducing to practice in general, hardware, wetware, and combination thereof).

An input-output adversity (e.g., an intractability regarding the input-output abstraction, an impasse related to observation, etc.), a computation adversity (e.g., an intractability regarding the computation abstraction, a difficulty related to computation, etc.), and an implementation adversity (e.g., an intractability regarding the implementation abstraction, a challenge in reducing to practice, obstacles to real-world use in general, etc.) may formulate constituents of an adversity regarding the higher-order metric.

In an embodiment, an intelligence (e.g., higher-order intelligence), a metric in general, an entity, and an ecosystem may be subject to at least one adversity of a basis comprising at least one of: environmental (e.g., natural disturbances, species extinction, etc.), shortages and wastages (e.g., of resources, talents, etc.), societal (e.g., social disturbance, etc.), business (e.g., processes related to supply chain, distribution, procurement, fulfillment, etc.), attacks (e.g., wars, demonstrations, cyber-attacks, attacks on goodwill and reputation, etc.), general wear and tear (e.g., due to entropy, erosion, etc.), uncertainty in general, accidents (e.g., due to faults, coincidences, errors, etc.), corruption in general (of type, e.g., misconfiguration or introduction of bugs; intentional; unintentional; consequent to accidents, wear and tear, or errors, etc.; etc.), unintended or unexpected undesirable consequences (e.g., misconfiguration, bugs, forgetting of AI, forgetting of neural networks in general, etc.), and combination thereof. The one or more adversity may be due to a change (e.g., anticipated, unanticipated, avoidable, unavoidable, etc.) of a basis comprising at least one of: infrastructure (e.g., related to autonomous driving and its support structure such as electric grid, supply and refueling, utility provisioning, etc.), transportation (e.g., road conditions, autonomous driving, public transportation, etc.), societal (e.g., way of life, civic constructs, institutions, etc.), behavioral (e.g., individual habits, crowd dynamics, sentiment, cognitive decision making and reasoning in general, etc.; other examples are behaviors related to autonomous driving, new technologies, new ideas, etc.), markets (e.g., financial, housing, wholesale and retail, etc.), by adversarial actions (e.g., of game—theoretical players; of hackers; of opponents, etc., wherein the actions may be known or unknown, intentional or unintentional, etc.), and combination thereof. In an embodiment, forgetting of a metric (related to, e.g., AI, neural networks, etc.) is an undesirability of a basis comprising at least one of: corruptions, unintended results, unexpected consequences, bugs or misconfiguration in general, and combination thereof.

In certain embodiments, the term “high-severity” generally refers to a consequence of a high degree that may require a high-grade attention of a basis comprising at least one of: need for urgent response (comprising at least one of mitigation, containment, symptom relief, triage, intervention in general, help in general, and combination thereof); need for prioritization (of, e.g., care, help, resource allocation, etc.); imminent threat of catastrophe; possibility of loss (of type comprising at least one of irreversible, unacceptable, and combination thereof); missed opportunity (related to, e.g., arbitrage, coincidence, etc.), and combination thereof. In certain embodiments, the term “low-severity” generally refers to a consequence of low degree that may require a low- to moderate-grade attention of a basis comprising at least one of: continued observation, precautionary measures, anticipatory preparation, vigilance (e.g., to identify possible onset of, diagnose potential extent of, avoid loss or ensure gain due to high-severity, etc.), and combination thereof.

In an embodiment, an adversity is temporary for at least one higher-order intelligence (e.g., an entity in general, a higher-order metric, etc.). The temporary adversity is regarding at least one substantial restriction regarding resources and authorizations for the at least one higher-order intelligence, and the at least one substantial restriction is substantially temporary. In an embodiment, a creator of a metric (e.g., an entity, a higher-order intelligence, etc.) may constrain the metric with a temporary adversity to facilitate its use in a real-world scenario. The temporary adversity is of a basis comprising at least one of: compute, power, ability to sufficiently cool (e.g., a computing apparatus), resources in general, jurisdictional approval in general, approval in general (e.g., of stakeholders, of testers and validators, etc.), and combination thereof. Generally, a restriction is of a basis comprising at least one of: resources, authorizations, time (e.g., time as a resource related to compute, operation, learning, communication, activity in general, etc.), knowledge, abilities, intelligences, information structures in general, and combination thereof.

In an embodiment, an adversity is temporary for at least one higher-order intelligence (e.g., an entity in general, a higher-order metric, etc.). The temporary adversity is regarding at least one substantial restriction regarding information of a basis comprising at least one of: information structures in general, intelligences in general, metrics, and combination thereof for the at least one higher-order intelligence, and the at least one substantial restriction is substantially temporary.

In an embodiment, for an entity encountering a scenario, an activity (e.g., comprising at least one of operation, learning, and combination thereof) is restricted due to lack of an information structure—a temporary adversity. The entity is aware of: the existence of the information structure (e.g., a possibility, a weak awareness comprising a reference of the information structure, etc.), the lack of the information structure (e.g., though the entity has a reference to it, the information structure and an exercise of the information structure is currently inaccessible), and an enablement of the activity that would be made possible by acquiring and exercising the information structure. The temporary adversity is of a basis comprising at least one of: metrics, intelligence constituents, exercise in general, observations, agencies, attentions, homeostasis, citizenships, operations in general, learning in general, simultaneity in general (e.g., of operation and learning), and combination thereof.

In an embodiment, an impasse (e.g., based on an intractability) does not constitute a temporary adversity for an entity. An entity expects to resolve and generally is aware of a plan to overcome a temporary adversity but for a restriction. Due to the expectation of resolution and the plan, the temporary adversity may not be an intractability nor an impasse.

In an embodiment, a higher-order intelligence may be a reference to at least one abstraction of a basis comprising at least one of: narrow intelligence, awareness, intent, perception, and combination thereof. A goal (e.g., as structured by a higher-order intelligence) may be at least one abstraction of a basis comprising at least one of: a plurality of intents, a plurality of awareness, and combination thereof; a homeostasis (e.g., as enabled by at least one intelligence) may be at least one abstraction of a basis comprising at least one of: a plurality of equilibria (comprising, e.g., equilibria enabled by the at least one intelligence), a plurality of goals, a plurality of awareness, foundations in general, and combination thereof, and a citizenship may be at least one abstraction of a basis comprising at least one of: a plurality of goals, a plurality of homeostasis, a plurality of awareness, a plurality of intents, foundations in general, and combination thereof, wherein the foundations are of a basis comprising at least one of imperative (of type, e.g., legal), directive, mandate, and combination thereof.

In an embodiment, generally human intelligence features of a basis comprising at least one of: creativity, intuition, empathy, social intelligence, and combination thereof may be regarded as higher-order abstractions regarding autonomous proactiveness, generally supplemented with awareness, intent, homeostasis, and citizenship, among others. In an embodiment, for an AI entity to seamlessly function in a real-world human ecosystem (e.g., in a human team at par with other team members, as a substitute for an existing member of a human team, etc.) the AI entity may need awareness and intelligence in general (e.g., related to homeostasis, citizenship, amenability, inclination, foundations in general, etc.) of the human intelligence features.

In certain embodiments, supervising generally refers to an activity (e.g., comprising at least one of operation, learning, and combination thereof) of a basis comprising at least one of: controlling, constraining, guiding, allocating resources, allocating tasks, testing (e.g., scheduling tests, verifying results, etc.), verification, validation, and combination thereof. In certain embodiments, at least one supervision is of an activity of a basis comprising at least one of: intent, awareness, abstraction, citizenship, processing in general, agency (and execution thereof), exploration (e.g., directed exploration), observation, comparison (of, e.g., an expected observation with an observation, observations, intelligences, constituents of intelligences, goals, objectives, rewards, etc.), expectation (of, e.g., observations, intelligences, constituents of intelligence, goals, objectives, rewards, and combination thereof), and combination thereof. In certain embodiments, supervising is an aspect of overseeing by at least one higher-order intelligence; e.g., supervising may be regarded as a tactical (e.g., localized, with bounded scope, etc.) approach for overseeing (e.g., to influence) in general.

In an embodiment, artificial intelligence (AI) (e.g., AI operation, AI learning, and AI use in general) is of a basis comprising at least one of: linear regression, support vector machines, graphical models (comprising at least one of Markov networks, Markov chains, Bayesian networks, and combination thereof), inference in general (e.g., probabilistic inference, deductive inference, Bayesian inference, model inference, causal modeling and causal inference, abductive inference, inductive inference, etc.), time series based, artificial neural networks, spiking neural networks, neuromorphic techniques, reinforcement learning, machine learning in general, clustering, category theory, quantum computing, abstractions, representations in general, and combination thereof. In an embodiment, AI systems may further comprise at least one of: expert systems, rules engines, inference engines, semantic reasoners, other systems capable of processing higher-order representations as well as higher-order logic, and combination thereof.

It is noted that the functional blocks and modules in FIGS. 1-24 may comprise at least one of: processors, electronics devices, hardware devices, electronics components, logical circuits, memories, software codes, firmware codes, and combination thereof.

It is noted that marks and identifiers used in black-and-white FIGS. 1-24 may be represented in different colors; the marks and identifiers may comprise at least one of: symbols, keys or legends, text notations, hatching and shading, a floor-plan, or the like. Figures that are embodiments of user interfaces, user interactions, and user communication in general—e.g., displays of a smartphone, an augmented-reality device, or other device—may be representations of colored displays. There may be other ways to display the same user information comprising at least one of: different languages, symbols, notations, conventions, representations, and combination thereof. In an embodiment, the user information may be governed by the rules and regulations of the concerned jurisdiction.

In certain embodiments, the phrase “comprising at least one of” (and similarly, the phrases “comprise at least one of” and “comprises at least one of”) for a first list is referred broadly to mean:
a. a second list equivalent to “at least one of a list comprising the first list” (e.g., at least one instance of at least one element of a list that comprises the elements of the first list) generally inclusive of combinations and
b. “comprising a list of at least one of the first list” (e.g., a list comprising at least one instance of at least one element from the first list) generally inclusive of combinations.
   For example, a first list of letters is “A, B, and C” and a second list of letters equivalent to “comprising at least one of” the first list (e.g., “ . . . comprising at least one of: A, B, C, and combination thereof”)—may include one or more of: one or more A, one or more B, one or more C, one or more D, one or more Z, and one or more of all combinations of A, B, C, D, and Z. Generally, “comprising at least one of” a first list (e.g., “ . . . comprising at least one of: A, B, C, and combination thereof”) indicates inclusion of an aspect of the first list (the first list's, e.g., elements, instances thereof, parts thereof, etc.).

In an embodiment, “a plurality of” may be regarding a generally mathematical representation comprising at least one of: ensemble (e.g., statistical ensemble; ensemble in frequentist probability analysis; ensemble in Bayesian model averaging; ensemble in Bayes classifiers; ensemble in learning algorithms comprising bagging, boosting, stacking, bucket of models, and model averaging; etc.), prior (e.g., as it relates to Bayes theorem, as it relates to inference, a prior probability distribution, etc.), posterior (e.g., as it relates to Bayes theorem, as it relates to inference, a posterior probability distribution, etc.), distribution (e.g., for probability distributions, for uncertainty estimation, for likelihood analysis, etc.), graph (e.g., networks, node-edge structures, maps, etc.), complex grouping (e.g., swarm; swarming; dynamic collective; complex presentations of a basis comprising at least one of: self-reference, circular-reference, ergodic-reference, and combination thereof), peer-to-peer collective (e.g., peer-to-peer network, peer-to-peer communication, peer-to-peer propagation, lattice arrangements in general, etc.), collective in general, and combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed (e.g., by executing instructions) with one or more processing unit-comprising at least one of: central processing unit (CPU), graphics processing unit (GPU), digital signal processor (DSP), quantum circuit, neuromorphic circuit, category theoretic processor, custom designed and fabricated application specific integrated circuit (ASIC), field programmable gate array (FPGA), vision processing unit (VPU), tensor processing unit (TPU), and combination thereof—and other computer components utilized in mobile and/or stationary devices. An AI (e.g., ANN) may have access to non-volatile memory for storing, logging, troubleshooting, instruction executing, and the like. Input and output capabilities of an AI (e.g., ANN) may be supplemented by related input-output channels and devices. Instructions for an AI (e.g., ANN) to initialize, learn, validate, and/or infer may be delivered through one or more input channels. The execution of the commands may occur over the one or more processing units in coordination with RAM (random access memory) and storage to generate and deliver output over one or more output channels.

1. A system comprising:
at least one processor configured to:
execute at least one instruction of a basis comprising at least one equivalence of at least one awareness to at least one category theoretic morphism;
and exercise, based on the executed at least one instruction, at least one category theoretic intelligence.

2. The system of claim 1, wherein the at least one processor is further configured to execute at least one equivalence of a basis comprising: equivalence of at least one higher-order awareness to at least one category theoretic higher-order morphism.

3. The system of claim 1, wherein the at least one processor is further configured to execute at least one equivalence of a basis comprising: equivalence of at least one higher-order intelligence to at least one higher-order category.

4. The system of claim 1, wherein the at least one processor is further configured to execute at least one equivalence of a basis comprising: equivalence of at least one intelligence abstraction to at least one category theoretic abstraction.

5. The system of claim 1, wherein the at least one processor is further configured to execute at least one instruction of a basis comprising at least one category theoretic algebra.

6. The system of claim 1, wherein the at least one processor is of a basis comprising at least one of: category theory, topos, category theoretic algebra, homotopy type theory, and combination thereof.

7. A system comprising:
at least one processor configured to:
abstract at least one first information structure into at least one second information structure;
comprehend at least one third information structure of a basis comprising at least one constituent of the at least one first information structure and the at least one second information structure; and
overcome, based on the comprehended at least one third information structure, at least one real-world challenge comprising randomness uncertainty and knowledge uncertainty;
and the at least one processor configured to execute at least one instruction of a basis comprising artificial intelligence.

8. The system of claim 7, wherein at least one step comprising at least one of:
abstracting the at least one first information structure, comprehending the at least one third information structure, overcoming the at least one real-world challenge, and combination thereof is of a basis comprising category theory.

9. The system of claim 7, wherein at least one step comprising at least one of:
abstracting the at least one first information structure, comprehending the at least one third information structure, overcoming the at least one real-world challenge, and combination thereof is of a basis comprising intrinsic and autonomously proactive.

10. The system of claim 7, wherein the at least one processor is of a basis comprising at least one of: neuromorphic compute, category theoretic compute, quantum compute, and combination thereof.

11. The system of claim 7, wherein the at least one processor is further configured to
indicate against extrinsically supervising at least one step comprising at least one of: abstracting the at least one first information structure, comprehending the at least one third information structure, overcoming the at least one real-world challenge, and combination thereof.

12. The system of claim 7, wherein the at least one processor is further configured to overcome, based on the comprehended at least one third information structure, at least one complexity.

13. The system of claim 7, wherein the at least one processor is further configured to
exercise the comprehended at least one third information structure; and
verify, based on the exercised at least one third information structure, at least one viability of a basis comprising at least one of: comprehension, semantics, autonomous proactiveness, and combination thereof.

14. The system of claim 7, wherein the at least one processor is further configured to execute at least one equivalence of a basis comprising: equivalence of at least one abstraction of the at least one first information structure to at least one category theoretic abstraction.
